(19) United States
(12) Patent Application Publication
(10) Pub. No.: US 2005/0221241 A1
(43) Pub. Date: Oct. 6, 2005

(54) Photothermographic material and image forming method

(75) Inventor: Hajime Nakagawa, Kanagawa (JP)

Correspondence Address: TAIYO CORPORATION, 401 HOLLAND LANE, #407, ALEXANDRIA, VA, 22314, US

(73) Assignee: FUJI PHOTO FILM CO., LTD.

(21) Appl. No.: 11/084,772

(22) Filed: Mar. 21, 2005

(30) Foreign Application Priority Data
Mar. 26, 2004 (JP) 2004-93592

(51) Int. Cl. G03C 1/00

(52) U.S. Cl. 430/619

(57) ABSTRACT

A photothermographic material having an image forming layer provided on at least one side of support, the image forming layer comprising a photosensitive silver halide, a non-photosensitive organic silver salt, a reducing agent and a binder, wherein: 50% or more of grains of the photosensitive silver halide in a projected area have an aspect ratio of from 2 to 100; and the binder comprises an aqueous dispersion of a hydrophobic polymer, and an image forming method thereof.

### CROSS-REFERENCE TO RELATED APPLICATIONS

This application claims priority under 35USC 119 from Japanese Patent Application No. 2004-93592, the disclosure of which is incorporated herein by reference.

### BACKGROUND OF THE PRESENT INVENTION

1. Field of the Present Invention

The present invention relates to a photothermographic material and an image forming method.

2. Description of the Related Art

In recent years, reduction in an amount of a waste processing solution has been strongly desired in the field of medical diagnosis from the standpoints of environmental protection and space saving. Therefore, technology relating to a photosensitive thermally developable photographic material, for use in the medical diagnosis and graphic arts, which is capable of being efficiently exposed by a laser image setter or a laser imager and can form a clear black image having high resolution and sharpness, is required. Such a photosensitive thermally developable photographic material can provide users with a simple and non-polluting thermal development processing system that eliminates the use of solution-type processing chemicals.

While similar requirements also exist in the field of general image forming materials, images for medical diagnosis strongly require high image quality with ecellent sharpness and granularity, since fine representation is required, and are further chracterized in that images of a black-blue tone are preferred from the standpoint of easy diagnosis. At present, various types of hard copy systems utilizing a pigment or a dye, such as an ink jet printer and an electronic photographic system, have been distributed as ordinary image forming systems. However, none of these hard copy systems are satisfactory as an output system for an image for use in medical diagnosis.

On the other hand, thermally developable image forming systems utilizing a non-photosensitive organic silver salt are described in many documents. A photothermographic material (hereinafter, referred to also as “sensitive material”) generally comprises an image forming layer in which a catalytically active amount of a photocatalyst (for example, a photosensitive silver halide), a reducing agent, a reducible silver salt (for example, a non-photosensitive organic silver salt) and, optionally, a color toner for controlling a color tone of silver are dispersed in a binder matrix. When the photothermographic material is heated at a high temperature (for example, 80° C. or more) after being exposed imagewise, a black silver image is produced by an oxidation-reduction reaction between the photosensitive silver halide or the reducible silver salt (functioning as an oxidizing agent) and the reducing agent. The oxidation-reduction reaction is accelerated by a catalytic action of a latent image of the photosensitive silver halide generated by such exposure. As a result, a black silver image is formed in an exposed area of the material. Fuji Medical Dry Imager FM-DP L has been sold as an image forming system for medical diagnosis utilizing such a photothermographic material.

Since various types of components as described above are contained in the photothermographic material and all of them remain therein after development, there problems with regard to storage stability of the sensitive material both before and after development. Further, since the sensitive material is developed by being heated at 80° C. or more, it is put in a condition in which it is apt to be denatured or deformed. It is conceivable that an unanticipated pressure may be applied to the sensitive material at the time of transport or storage and, particularly, when a pressure is applied to put on the sensitive material at the time of thermal development, the sensitive material is apt to generate fogging due to the pressure. Particularly, a sensitive material having high sensitivity is apt to sensitively react to an external factor and, accordingly, apt to generate fogging.

In order to solve these problems, various types of methods have been studied and continue to provide promising results. For example, for image storage stability after image formation, a photosensitive silver halide is replaced with one having a high silver iodide content as described in Japanese Patent Application Laid-Open (JP-A) No. 8-297345 and Japanese Patent No. 2785129, and, for image storage stability before and after image formation, for example, generation of fogging is suppressed by adding a polyhalogen compound as described in JP-A No. 2001-312027, a content of silver behenate in a non-photosensitive organic silver salt is increased as described in JP-A No. 2002-196446 or the like.

Since an image forming layer is a portion that directly forms an image, it is extremely important to study components in the image forming layer as a method for improving storage stability. However, since these components exist in a mixed state therein, there is a tendency that, when storage stability is enhanced, sensitivity is reduced, and that, when the generation of fogging is suppressed, image density is reduced. It is extremely difficult to simultaneously attain two contradictory properties in each case, that is, storage stability and a high sensitization, and suppression of fogging and good image density. Further, depending on the type or the amount of an additive to be added, there is a risk of deteriorating an adhesion property, whereby peeling-off may occur. In order to improve the adhesion property, a surface treatment or an application of an undercoat is performed as described in JP-A No. 11-84574. As described above, a photothermographic material is prepared in a well-balanced manner to maximize the advantages of each component, and accordingly, it is difficult to improve storage stability by merely changing or adding one component.

Particularly, when the photothermographic material is processed in a processing apparatus at a high temperature while being subjected to pressure, the generation of fogging therein is increased. The mechanism of fogging at a high temperature while being subjected to pressure has not yet been determined. In a sensitive material for use in medical diagnosis, the generation of fogging may cause a false diagnosis. Accordingly, the establishment of a measure for suppressing the generation of fogging at the time of pressure application is a problem that needs to be solved.

As described above, a photothermographic material involves problems due to completely different conditions from these of a photosensitive material which is developed using a developing liquid.

### SUMMARY OF THE PRESENT INVENTION

Therefore, an object of the present invention is to provide a photothermographic material which is excellent in sensitivity, adhesion property and pressure resistance and an image forming method thereof. The object of the present invention is attained by a photothermographic material as described below.

A first aspect of the present invention is to provide a photothermographic material having an image forming layer provided on at least one side of support, the image forming layer comprising a photosensitive silver halide, a non-photosensitive organic silver salt, a reducing agent and a binder, wherein: 50% or more of grains of the photosensitive silver halide in a projected area have an aspect ratio of from 2 to 100; and the binder comprises an aqueous dispersion of a hydrophobic polymer.

A second aspect of the present invention is to provide an image forming method of an image forming method for a photothermographic material having an exposing step and a thermal developing step, the comprising
(1) obtaining an assembly for image forming by placing the photothermographic material as set forth in claim 1 between a pair of X-ray sensitizing screens;
(2) setting a subject between the assembly for image forming and an X-ray source;
(3) irradiating an the subject with X ray having an energy level in the range of 25 kVp to 125 kVp on the subject;
(4) removing the photothermographic material from the assembly; and
(5) heating the removed photothermographic material at a temperature in the range of 90° C. to 180° C.

### DETAILED DESCRIPTION OF THE PRESENT INVENTION

A silver image is mainly formed as a photosensitive silver halide latent image. At this time, as the most direct measure for enhancing sensitivity, a photosensitive silver halide having high sensitivity may be used. The present inventors have conducted intensive studies on the photosensitive silver halide and, as a result, found that, in the case of a tabular silver halide grain having an aspect ratio of from 2 to 100, sensitivity is remarkably enhanced. Based on this finding, an extremely important technique has been established such that designing of a double-side sensitive material having image forming layers on both faces becomes possible.

However, since a tabular grain was utilized, generation of fogging due to the sensitive material being subjected to pressure at the time of thermal development was increased and, accordingly, further improvement was desired before the sensitive material was put to practical use. Then, the present inventors reviewed the composition of the whole sensitive material and, as a result, found that a frequency of the generation of fogging by pressure varies depending on the combination of a shape of the photosensitive silver halide and a binder. The binder becomes a matrix in the image forming layer and exists around the photosensitive silver halide. By surrounding the tabular grain with an aqueous dispersion of a hydrophobic polymer, a photothremographic material in which the generation of fogging by pressure is extremely small is prepared. It is considered that this is caused by a phenomenon in which the hydrophobic polymer serves as a cushion for the tabular silver halide grain, whereby the pressure is alleviated.

Gelatin is often used as a binder. However, when gelation is hardened, it becomes stiff and is therefore inferior to the hydrophobic polymer in elasticity. For this reason, a combination of the tabular grain of the photosensitive silver halide and gelatin has not attained a substantial improvement with respect to fogging caused by pressure.

In the photothermographic material having such a composition as described above, an unexpected effect of favorable adhesion has been obtained.

This present invention is a photothermographic material having an image forming layer provided on at least one side of support, the image forming layer comprising a photosensitive silver halide, a non-photosensitive organic silver salt, a reducing agent and a binder, wherein: 50% or more of grains of the photosensitive silver halide in a projected area have an aspect ratio of from 2 to 100; and the binder comprises an aqueous dispersion of a hydrophobic polymer.

1. Layer Constitution

The photothermographic material according to the present invention comprises at least one layer of the image forming layer. Other layer constitutions are not particularly limited and, besides the image forming layer, the photothermographic material ordinarily comprises non-photosensitive layers as classified as follows:
(a) a surface protective layer to be provided on the image forming layer (on the side far from the support);
(b) an intermediate layer to be provided between any two of a plurality of image forming layers or between the image forming layer and the surface protective layer;
(c) an undercoat layer to be provided between the image forming layer and the support; and
(d) a back layer to be provided on the side opposite to the image forming layer.

These layers may be provided each independently or in a combination of two layers or more thereof.

Further, a layer acting as an optical filter can be provided and, on this occasion, it is provided as the layer described in (a) or (b) of the non-photosensitive layer. An anti-halation layer is provided as the layer described in (c) or (d) in the photosensitive material.

The photothermographic material according to the present invention may be of a single-side type which contains the image forming layer on only one side of the support or a double-side type which contains the image forming layer on both sides of the support. In the case of the double-side type, in the image forming layer on at least one face, 50% or more of the photosensitive silver halide grains in terms of the projected area has an aspect ratio of from 2 to 100 and the binder may contain the aqueous dispersion of the hydrophobic polymer.

A constitution of a multi-color photosensitive thermally developable photographic material may comprise a combination of at least two layers of different colors or may comprise one layer containing all colors therein as described in U.S. Pat. No. 4,708,928. In the case of the multi-color photosensitive thermally developable photographic material, emulsion layers are ordinarily maintained in a separate manner from one another by using a functional or non-functional barrier layer between any two of the photosensitive layers as described in U.S. Pat. No. 4,460,681.

The photothermographic material according to the present invention can be used for any applications of a laser exposure, an X-ray exposure and the like. In the case of the photosensitive material for the X-ray exposure for the application of the medical diagnosis, an X-ray intensifying screen is used. The photosensitive material for the X-ray exposure can be classified into (1) a single-side type photothermographic material and (2) a double-side type photothermographic material as described below.

(1) Single-Side Type Photothermographic Material

A single-side type photothermographic material can be used as an X-ray photosensitive material for mammography. It is important that the single-side type photothermographic material to be used for this object is designed such that contrast of the image to be obtained falls in an appropriate range. For favorable constitutional factors as the X-ray photosensitive material for mammography, descriptions as described in JP-A Nos. 5-45807, 10-62881, 10-54900 and 11-109564 can serve as useful references.

In the case of the single-side type, it is preferable that a back layer is provided on a face (hereinafter, referred to back face) opposite to the side having the image forming layer from the support.

(2) Double-Side Type Photothermographic Material

The double-side type photothermographic material is favorably used in the image forming method for recording an X-ray image by using the X-ray intensifying screen.

Hereinafter, constitutional components of each layer will be described in detail.

2. Constitutional Component of Image Forming Layer

(Description of Binder)

The present invention is characterized in that a binder in the image forming layer containing a hydrophobic polymer. The hydrophobic polymer is defined as a polymer in which an equilibrium moisture content at 25° C. 60% RH is 2.0% by mass or less. The term “equilibrium moisture content at 25° C. 60% RH” as used herein can be expressed by using a weight W1 of a polymer in an equilibrium with moisture conditioning under the atmosphere at 25° C. 60% RH and a weight W0 of the polymer in the absolute dried state, as shown in the following equation:

The equilibrium moisture content at 25° C. 60% RH={(W1−W0)/W0}×100 (% by mass).

Regarding a definition and a measurement method of the moisture content, for example, Testing Methods of Polymer Materials, Polymer Engineering Course 14, compiled by the Society of Polymer Science of Japan, Chijin Shokan Co., Ltd. can serve as a useful reference.

An equilibrium moisture content of the binder polymer according to the present invention at 25° C. 60% RH is preferably 2% by mass or less, more preferably in the range of 0.01% by mass to 1.5% by mass and, still more preferably, in the range of 0.02% by mass to 1% by mass.

Examples of such hydrophobic polymers include acrylic polymers, poly(ester)s, rubbers (for example, SBR resins), poly(urethane)s, poly(vinyl chloride)s, poly(vinyl acetate)s, poly(vinylidene chloride)s and poly(olefin)s. These polymers may be a straight-chain polymer, a branched-chain polymer, a cross-linked polymer, a so-called homopolymer in which monomers of a single type have been polymerized, or a copolymer in which monomers of two or more types have been polymerized. In the case of the copolymer, it may be either a random copolymer or a block copolymer.

A content of the hydrophobic polymer in an entire binder in the image forming layer is preferably in the range of 30% by mass to 70% by mass, more preferably in the range of 35% by mass to 65% by mass and, still more preferably, in the range of 50% by mass to 60% by mass.

A glass transition temperature (hereinafter, referred to also as “Tg”) of the binder capable of being used in a layer containing a non-photosensitive organic silver salt (i.e. image forming layer) is preferably in the range of −20° C. to 60° C., more preferably in the range of 0° C. to 40° C. and, still more preferably, in the range of 5° C. to 30° C.

A glass transition temperature of the hydrophobic polymer is in the range of −20° C. to 60° C., more preferably in the range of 0° C. to 40° C. and, still more preferably, in the range of 5° C. to 30° C.

Further, herein, the Tg is calculated with the following equation:
1/Tg=Σ(Xi/Tgi)

In this case, it is assumed that the polymer is formed by copolymerization of n monomer components of from i=1 to i=n. Xi is a weight ratio (ΣXi=1) of the i-th monomer and Tgi is a glass transition temperature (at an absolute temperature) of a homopolymer of the i-th monomer, provided that Σ is a sum of from i=1 to i=n. Further, for the value (Tgi) of glass transition temperature of the homopolymer made from each monomer, values described in J. Brandrup and E. H. Immergut, Polymer Handbook, 3rd Edition, Wiley-Interscience (1989) have been adopted.

Binders may be used in combinations of two or more types according to necessity. They can be used with two or more types of hydrophobic polymers and, further, with a hydrophilic polymer. When two or more types of polymers having different Tg values from one another are used in blending, it is preferable that a weight average Tg resides in the ranges described above.

A molecular weight of the hydrophobic polymer is, in terms of the number average molecular weight (Mn), preferably in the range of 5,000 to 1,000,000 and, more preferably, in the range of 10,000 to 200,000. When the polymer having an excessively small molecular weight is used, dynamic strength of the image forming layer becomes insufficient. When the polymer having an excessively large molecular weight is used, a film-forming property is deteriorated; therefore, none of these cases is preferable. Further, a cross-linkable polymer latex is particularly favorably used. A molecular weight of the cross-linkable polymer is preferable to be such that a molecular weight of a component thereof capable of being dissolved in a solvent (for example, THF) is in the aforementioned ranges.

Among hydrophobic polymers, a polymer which has been copolymerized with a monomer as represented by formula (M) is preferable:
CH₂═CR⁰¹—CR⁰²═CH₂ Formula (M);

wherein R⁰¹ and R⁰² each independently represent a group or an atom selected from among a hydrogen atom, an alkyl group having from 1 to 6 carbon atoms, a halogen atom and a cyano group.

The alkyl group of each of R⁰¹ and R⁰² is preferably an alkyl group having from 1 to 4 carbon atoms and more preferably an alkyl group having 1 or 2 carbon atoms. The halogen atom is preferably fluorine atom, chlorine atom or bromine atom and more preferably chlorine atom.

As R⁰¹ and R⁰², it is particularly preferable that one is hydrogen atom and the other is methyl group or chlorine atom, or both of R⁰¹ and R⁰² are hydrogen atoms (i.e. butadiene).

Specific examples of such monomers as represented by formula (M) include 1,3-butadiene, 2-ethyl-1,3-butadiene, 2-n-propyl-1,3butadiene, 2,3-dimethyl-1,3-butadiene, 2-methyl-1,3butadiene, 2-chloro-1,3-butadiene, 1-bromo-1,3-butadiene, 2-fluoro-1,3-butadiene, 2,3-dichloro-1,3-butadiene and 2-cyano-1,3-butadiene.

According to the present invention, other monomers capable of being copolymerized with the monomer represented by formula (M) are not particularly limited and any monomers can favorably be used so long as they are capable of being copolymerized by an ordinary radical polymerization method or ion polymerization method. Examples of the monomers include a copolymer with styrene (for example, random copolymer, block copolymer), a copolymer of styrene and butadiene (for example, random copolymer, butadiene-isoprene-styrene block copolymer, styrene-butadiene-isoprene-styrene block copolymer), an ethylene-propylene copolymer, a copolymer with acrylonitrile, a copolymer with isobutylene, a copolymer with an acrylic acid ester (examples of such acrylic acid esters include ethyl acrylate, butyl acrylate) and a copolymer of the acrylic acid ester and acrylonitrile (for the acrylic acid ester, same esters as described above can be used). Among these copolymers, the copolymer with styrene is most preferably used.

A copolymerization ratio of the monomer represented by formula (M) and any one of other monomers is not particularly limited and copolymerization is performed with the monomer represented by formula (M) in an amount preferably in the range of 10% by mass to 70% by mass, more preferably in the range of 15% by mass to 65% by mass and, still more preferably, in the range of 20% by mass to 60% by mass.

As the polymer to be copolymerized with the monomer represented by formula (M), a styrenebutadiene copolymer or a styrene-isoprene copolymer is particularly preferable. A mass ratio of a styrene monomer unit and a butadiene monomer unit in the styrenebutadiene copolymer is preferably from 40:60 to 95:5.

Further, the hydrophobic polymer according to the present invention contains acrylic acid or methacrylic acid in an amount preferably in the range of 1% by mass to 6% by mass and, more preferably, in the range of 2% by mass to 5% by mass based on the sum of styrene and butadiene. The polymer latex according to the present invention preferably contains acrylic acid. A preferable range of the molecular weight thereof is same as described above.

The binder may be formed in a film state from an aqueous solution, an organic solvent solution or an emulsion. However, according to the present invention, the image forming layer is preferably formed in a film state by a coating solution in which 30% by mass or more of solvent is water and, then, drying the thus-applied coating solution. According to the present invention, when the image forming layer is formed by the coating solution in which 30% by mass or more of the solvent is water and, then, drying the thus-applied coating solution, and further, when the binder in the image forming layer is soluble or dispersible in an aqueous-based solvent (water solvent), and, particularly, it comprises a latex of a polymer in which an equilibrium moisture content at 25° C. 60% RH is 2% by mass or less, a performance thereof is enhanced. A most preferable embodiment thereof is that prepared such that ionic conductance becomes 2.5 mS/cm or less and, for a method for such preparation, mentioned is method of performing a purification treatment by using a film having a separation function after the polymer is synthesized.

The aqueous-based solvent in which the aforementioned polymer is soluble or dispersible refers to water or a mixture in which 70% by mass or less of a water-miscible organic solvent is mixed in water. Examples of such water-miscible organic solvents include alcohols such as methyl alcohol, ethyl alcohol and propyl alcohol; Cellosolves such as methyl Collosolve, ethyl Cellosolve and butyl Cellosolve; ethyl acetate; and dimethyl formamide.

According to the present invention, polymers dispersible in the aqueous-based solvent are particularly preferable. For an example of a dispersed state thereof, any one of a latex in which fine grains of a hydrophobic polymer insoluble to water are dispersed, a dispersion in which polymer molecules are dispersed in a molecular state or in micelle form after being subjected to a micelle formation and the like is preferable. Among other things, grains subjected to a latex dispersion is more preferable. An average grain diameter of the dispersed grains is in the range of 1 nm to 50,000 nm, preferably in the range of 5 nm to 1,000 nm, more preferably in the range of 10 nm to 500 and, still more preferably, in the range of 50 nm to 200 nm. A grain diameter distribution of the dispersed grains is not particularly limited and the dispersed grains having a wide grain diameter distribution or those having a grain diameter distribution of a mono-dispersion are permissible. From the standpoint of controlling physical properties of the coating solution, it is a favorable method of usage that two or more types of dispersed grains having the grain diameter distribution of mono-dispersion may be mixed with each other and, then, used.

Specific examples of latices of hydrophobic polymers include, besides the latex of the polymer which has been copolymerized with the monomer as represented by formula (M), latices described below. These articles are each expressed in terms of a starting monomer; a numerical value in each parenthesis is indicated in terms of “% by mass”; and a molecular weight means a number average molecular weight. In the case in which a multi-functional monomer is used, the concept of the molecular weight can not be applied, since a cross-linked structure is formed. Accordingly, such case as described above is marked as “cross-linking” to omit description of molecular weight. Tg denotes a glass transition temperature.
P-1; a latex (MW: 37,000; Tg: 61° C.) of MMA (70)-EA (27)-MAA (3)
P-2; a latex (MW: 40,000; Tg: 59° C.) of MMA (70)-2EHA (20)-St (5)-AA (5)
P-3; a latex (cross-linking; Tg: 5° C.) of St (62)-Bu (35)-MAA (3)
P-4; a latex (cross-linking; Tg: −17° C.) of St (50)-Bu (47)-MAA (3)
P-5; a latex (cross-linking; Tg: 17° C.) of St (68)-Bu (29)-AA (3)
P-6; a latex (cross-linking; Tg: 24° C.) of St (71)-Bu (26)-AA (3)
P-7; a latex (cross-linking) of St (70)-Bu (27)-IA (3)
P-8; a latex (cross-linking; Tg: 29° C.) of St (75)-Bu (24)-AA (1)
P-9; a latex (cross-linking) of St (60)-Bu (35)-DVB (3)-MAA (2)
P-10; a latex (cross-linking) of St (70)-Bu (25)-DVB (2)-AA (3)
P-11; a latex (MW: 80,000) of VC (50)-MMA (20)-EA (20)-AN (5)-AA (5)
P-12; a latex (MW: 67,000) of VDC (85)-MMA (5)-EA (5)-MAA (5)
P-13; a latex (MW: 12,000) of Et (90)-MAA (10)
P-14; a latex (MW 130,000; Tg: 43° C.) of St (70)-2EHA (27)-AA (3)
P-15; a latex (MW: 33,000; Tg: 47° C.) of MMA (63)-EA (35)-AA (2)
P-16; a latex (cross-linking; Tg: 23° C.) of St (70.5)-Bu (26.5)-AA (3)
P-17; a latex (cross-linking; Tg: 20.5° C.) of St (69.5)-Bu (27.5)-AA (3)
P-18; a latex (cross-linking; Tg: 17° C.) of St (60.4)-isoprene (36.6)-AA (3)
P-19; a latex (cross-linking; Tg: 27° C.) of St (67)-isoprene (28)-Bu (2)-AA (3)

Abbreviations in the above structures denote respective monomers as follows: MMA: methyl metacrylate, EA: ethyl acrylate, MAA methacylic acid, 2EHA: 2-ethylhexyl acrylate, St: styrene, Bu: butadiene, AA: acrylic acid, DVB: divinyl benzene, VC: vinyl chloride, AN: acrylonitrile, VDC: vinylidene chloride, Et: ethylene; and IA: itaconic acid.

As the hydrophobic polymers which are commercially available, such polymers as described below can be utilized.

Examples of acrylic polymers include Cevian A-4635, 4718 and 4601 (trade names; manufactured by Daicel Chemical Industries, Ltd.) and Nipol Lx811, 814, 821, 820 and 857 (trade names; manufactured by Zeon Corp.). Examples of poly(ester)s include FINETEX ES650, 611, 675 and 850 (trade names; manufactured by Dainippon Ink & Chemicals Inc.) and WD-size and WMS (trade names; manufactured by Eastman Chemical Company). Examples of poly (urethane)s include HYDRAN AP10, 20, 30 and 40 (trade names; manufactured by Dainippon Ink & Chemicals Inc.).

Examples of rubbers include LACSTAR 7310K, 3307B, 4700H and 7132C (trade names; manufactured by Dainippon Ink & Chemicals Inc.) and Nipol Lx416, 410, 438C and 2507 (trade names; manufactured by Zeon Corp.). Examples of poly(vinyl chloride)s include G351 and G576 (trade names; manufactured by Zeon Corp.).

Examples of poly(vinylidene chloride)s include L502 and L513 (trade names; manufactured by Asahi Chemical Industry Co., Ltd.).

Examples of poly (olefin)s include Chemipearl S120 and SA100 (trade names; manufactured by Mitsui Petrochemical Industries, Ltd.).

As preferable latices of styrene-butadiene copolymers to be used in the present invention, the aforementioned P-3 to P-10, P-16, P-17, commercially available LACSTAR-3307B, 7132C, Nipol Lx416 and the like can be mentioned.

As lattices of styrene-isoprene copolymers, the aforementioned P-18, P-19 and the like can be mentioned.

### SYNTHESIS EXAMPLE 1

### Synthesis of Illustrative Compound P-5

287 g of distilled water, 7.73 g of surface active agent (trade name: PIONIN A-43-S (solid content: 48.5% by mass); manufactured by Takemoto Oil & Fat Co., Ltd.), 14.06 ml of 1 mol/L NaOH, 0.15 g of tetra sodium ethylene diamine tetraacetate, 255 g of styrene, 11.25 g of acrylic acid, and 3.0 g of tert-dodecylmercaptan were loaded in a reaction vessel of a gas monomer reaction apparatus (Model: TAS-2J TYPE; manufactured by Taiatsu Techno Corporation) and, after the vessel was hermetically sealed, stirred at a stirring rate of 200 rpm. The vessel was vacuumized by a vacuum pump and, after being purged with nitrogen gas several times, fed with 108.75 g of 1,3-butadiene with pressure and, then, a temperature inside the vessel was raised to 60° C. Thereafter, a solution in which 1.875 g of ammonium persulfate was dissolved in 50 ml of water was loaded in the vessel and stirred for 5 hours as it was. A temperature of the resultant content was further raised to 90° C. and, then, stirred for 3 hours. After a reaction is completed, the inside temperature of the vessel was lowered to room temperature and a pH value of the content was adjusted to be 8.4 by performing an addition treatment on the content by using 1 mol/L NaOH and NH₄OH such that a relation of Na⁺ ion:NH₄⁺ ion=1:5.3 (in molar ratio) was established. Then, the content was filtrated with a filter made of polypropylene having a pore diameter of 1.0 μm to remove foreign matters such as dust and, then, stored and, accordingly, 774.7 g of an illustrative compound P-5 was obtained. When a concentration of a halogen ion was measured by using ion chromatography, a chloride ion concentration was 3 ppm. When a concentration of a chelating agent was measured by high-speed liquid chromatography, the result was 145 ppm.

Properties of thus-obtained latex were as follows: an average grain diameter was 90 nm; Tg=17° C.; solid content was 44% by mass; equilibrium moisture content at 25° C. 60% RH was 0.6% by mass; and ionic conductance was 4.80 mS/cm (for ionic conductance, latex starting solution (44% by mass) was measured at 25° C. by using a diagometer (trade name: CM-30S; manufactured by Toa Denpa Kogyo Co., Ltd.)).

### SYNTHESIS EXAMPLE 2

### Synthesis of Illustrative Compound P-18

1500 g of distilled water was loaded in a polymerization vessel of a gas monomer reaction apparatus (Model: TAS-2J TYPE; manufactured by Taiatsu Techno Corporation) and heated for 3 hours at 90° C., to thereby form a passive film on each of a surface of stainless-steel of the polymerization vessel and a member of a stirring device made of stainless-steel. Into the thus-treated vessel, 582.28 g of distilled water which has been subjected to nitrogen gas bubbling for one hour, 9.49 g of surface active agent (trade name: PIONIN A-43-S; manufactured by Takemoto Oil & Fat Co., Ltd.), 19.56 g of 1 mol/L NaOH, 0.20 g of tetra sodium ethylene diamine tetraacetate, 314.99 g of styrene, 190.87 g of isoprene, 10.43 g of acrylic acid, and 2.09 g of tert-dodecylmercaptan were loaded and, after the vessel was hermetically sealed, stirred at a stirring rate of 225 rpm and, then, a temperature inside the vessel was raised to 60° C. Thereafter, a solution in which 2.61 g of ammonium persulfate was dissolved in 40 ml of water was loaded in the vessel and stirred for 6 hours as it was. A polymerization conversion rate at this point was found to be 90% by a solid content measurement. Subsequently, a solution in which 5.22 g of acrylic acid was dissolved in 46.98 g of water was added to the vessel and, then, 10 g of water was added to the vessel and, further, a solution in which 1.30 g of ammonium persulfate was dissolved in 50.7 ml of water was added to the vessel. After these additions were performed, a temperature of the resultant content was further raised to 90° C. and, then, stirred for 3 hours. After a reaction is completed, the inside temperature of the vessel was lowered to room temperature and a pH value of the content was adjusted to be 8.2 by performing an addition treatment on the content by using 1 mol/L NaOH and NH₄OH such that a relation of Na⁺ ion:NH₄⁺ ion=1:5.3 (in molar ratio) was established. Then, the content was filtrated with a filter made of polypropylene having a pore diameter of 1.0 μm to remove foreign matters such as dust and, then, stored and, accordingly, 1248 g of an illustrative compound P-18 (solid content: 40.3% by mass; grain diameter: 113 nm) was obtained.

Such hydrophobic polymers may be used each independently or in blending of two or more types thereof as required. Further, other polymers may simultaneously be used with such hydrophobic polymers.

Polymers which can simultaneously be used with the hydrophobic polymers may be hydrophilic. Examples of such hydrophilic polymers as can simultaneously be used include gelatin, polyvinyl alcohol, methyl cellulose, hydroxypropyl cellulose and carboxymethyl cellulose. An amount of any one of these hydrophilic polymers to be added is, based on an entire binder in the image forming layer, preferably 10% by mass or less and, more preferably, 5% by mass or less.

In order to control a minimum film-forming temperature of an aqueous dispersion of the hydrophobic polymer, a film formation aid may be added. The film formation aid is also referred to as a temporary plasticizer and is an organic compound (ordinarily, organic solvent) to lower the minimum film-forming temperature of polymer latex. Examples thereof are described in the aforementioned Soichi Muroi, “Chemistry of Synthesized Latex”, Kobunshi Kankokai (Polymer Publishing) (1970). Examples of preferable film formation aids include the following compounds, but the compounds which can be used in the present invention are not limited thereto:
Z-1: benzyl alcohol;
Z-2: 2,2,2,4-trimethyl pentane diol-1,3-monoisobutylate;
Z-3: 2-dimethyl aminoethanol; and
Z-4: diethylene glycol.

It is preferable that the non-photosensitive organic silver salt-containing layer (namely, image forming layer) according to the present invention is formed by using a polymer latex. As an amount of the binder in the image forming layer, a weight ratio of entire binder/non-photosensitive organic silver salt is preferably in the range of 1/10 to 10/1, more preferably in the range of 1/3 to 5/1 and, still more preferably, in the range of 1/1 to 3/1.

Further, the non-photosensitive organic silver salt-containing layer like this ordinarily acts as a photosensitive layer (image forming layer) in which a photosensitive silver halide is contained as a photosensitive silver salt. In such a case, a weight ratio of entire binder/photosensitive silver halide is preferably in the range of 5 to 400 and, more preferably, in the range of 10 to 200.

An amount of the entire binder in the image forming layer according to the present invention is preferably in the range of 0.2 g/m² to 30 g/m², more preferably in the range of 1 g/m² to 15 g/m² and, still more preferably, in the range of 2 g/m² to 12 g/m². To the image forming layer according to the present invention, a cross-linking agent for executing cross-linking, a surface active agent for improving a coating property or the like may be added.

(Preferable Solvent of Coating Solution)

According to the present invention, a solvent (for the purpose of simplicity, a solvent and a dispersing medium are unanimously expressed as solvent) of a coating solution for the image forming layer of the photosensitive material is preferably an aqueous-based solvent containing 30% by mass or more of water. As a component exclusive of water, a water-miscible organic solvent such as methyl alcohol, ethyl alcohol, isopropyl alcohol, methyl Cellosolve, ethyl Cellosolve, dimethyl formamide, ethyl acetate or the like may optionally be used. A water content of the solvent of the coating solution is preferably 50% by mass or more and, more preferably, 70% by mass or more. Examples of preferable solvent compositions include, exclusive of water, water/methyl alcohol=90/10, water/methyl alcohol=70/30, water/methyl alcohol/dimethyl formamide=80/15/5, water/methyl alcohol/ethyl Cellosolve=85/10/5 and water/methyl alcohol/isopropyl alcohol=85/10/5 (numerical values are indicated in terms of “% by mass”).

(Description of Photosensitive Silver Halide)

1) Grain Form

The photosensitive silver halide to be used in the present invention is a tabular grain which has an aspect ratio of 2 or more in 50% or more of a projected area. An upper limit of the aspect ratio thereof is not set so long as it can be produced; however, ordinarily, it is a tabular grain having an aspect ratio of 100 or less. The aspect ratio is preferably in the range of 8 to 50 and, more preferably, in the range of 10 to 30. The aspect ratio of less than 2 causes deterioration of sensitivity and an increase of haze; accordingly, this case is not preferable. The aspect ratio of more than 100 remarkably deteriorates pressure resistance and, the photosensitive silver halide grain can not be put in a practical use.

The aspect ratio of the photosensitive silver halide grain can be measured from an electron micrograph taken along with a latex ball as a reference by a shadow-applied carbon replica method. A value obtained by dividing a deemed diameter of a circle having an area equivalent to a projected area by thickness is defined as the aspect ratio.

Thickness of the photosensitive silver halide grain is preferably 0.3 μm or less in 50% or more of the projected area. Although a lower limit of the thickness is not set so long as it can be produced, the thickness is more preferably 0.2 μm or less and, still more preferably, 0.1 μm or less. When the thickness is 0.3 μm or more, an increase of the haze occurs; accordingly, this case is not preferable. The thickness can be measured from an electron micrograph taken along with a latex ball as a reference by a shadow-applied carbon replica method.

As far as the grain size of the photosensitive silver halide is concerned, a grain size which is large enough for high sensitivity can be selected. An average sphere-equivalent diameter of the photosensitive silver halide is preferably in the range of 0.3 μm to 5.0 μm and, more preferably, in the range of 0.4 μm to 3.0 μm. The term “grain size” as used herein is referred to mean a diameter (circle-equivalent diameter) of a circular image so converted as to have a same area as that of a projected area (in the case of a tabular grain, projected area of a main face) of the photosensitive silver halide grain.

The photosensitive silver halide having a round corner can also be preferably used. There is no particular restriction on a face index (Miller index) of an outer surface of the photosensitive silver halide grain, however, a proportion of {100} face, which is high in spectral sensitization efficiency when a spectral sensitizing dye is adsorbed thereon, is preferably high. The proportion is preferably 50% or more, more preferably 65% or more and, still more preferably, 80% or more. The proportion of Miller index {100} face can be determined by using a method, as described in T. Tani, J. Imaging Sci., 29, 165 (1985), which utilizes adsorption dependency of {111} face and {100} face when a sensitizing dye is adsorbed.

The photosensitive silver halide having a high silver iodide content to be favorably used in a double-side sensitive material can take a complicated form, however, so long as the aspect ratio falls within the range of 2 to 100, no particular restriction is posed thereon and examples of preferable forms thereof include a joint grain as described in R. L. Jenkins et al., The Journal of Photographic Science, Vol. 28, p. 164, FIG. 1 (1980).

2) Halogen Composition

A halogen composition is not particularly limited and silver chloride, silver chlorobromide, silver bromide, silver iodobromide, silver iodochlorobromide or silver iodide can be used. Among them, silver bromide, silver iodobromide and silver iodide are preferable. Distribution of the halogen composition within a grain may be uniform, changed stepwise, or changed continuously. Further, a photosensitive silver halide grain having a core/shell structure can also favorably be used. Double to quintuple structure type core/shell particles can be preferably used, and double to quadruple structure type core/shell particles can be more preferably used. Still further, a technique which allows silver bromide or silver iodide to be locally present on a surface of a silver chloride grain, a silver bromide grain or a silver chlorobromide grain is also favorably be used.

Further, in the photothermographic material (double-side sensitive material) in which the image forming layers are provided on both faces, photosensitive silver halide having a high silver iodide content is preferable. The silver iodide content in the photosensitive silver halide in the double-side sensitive material is preferably in the range of 40% by mol to 100% by mol, more preferably in the range of 70% by mol to 100% by mol, still more preferably, in the range of 80% by mol to 100% by mol and, particularly preferably, in the range of 90% by mol to 100% by mol from the standpoint of the image storability based on light irradiation after the developing treatment.

3) Grain Forming Method

A method for forming the photosensitive silver halide is well known in the art, for example, methods as described in Research Disclosure No. 17029 (June, 1978) and U.S. Pat. No. 3,700,458 can be used and, specifically, a method in which firstly a photosensitive silver halide is prepared by adding a silver-supplying compound and a halogen-supplying compound to gelatin or at least one of other polymer solutions and, then, the thus-prepared photosensitive silver halide is added with a non-photosensitive organic silver salt is used. Further, a method as described in paragraphs 0217 to 0224 of JP-A No. 11-119374, or methods as described in JP-A Nos. 11-352627 and 2000-347335 are preferably used.

As far as a method for forming a tabular photosensitive silver halide having a high aspect ratio is concerned, there is a description about silver bromide in Cugnac and Chatoeau, Evolution of the Morphology of Silver Bromide Crystals During Physical Ripening, Science et Industries Photographiques, Vol. 33(1962), pp. 121 to 125, in regard to silver iodobromide, a method as described in Ashton, Kodacolor VR-1000-A Review, British Journal of Photography, Vol. 129, No. 6382, (November, 1982) can favorably be used, and, in regard to silver iodide, methods as described in the aforementioned JP-A Nos. 59-119350 and 59-119344 can favorably be used.

4) Heavy Metal

The photosensitive silver halide grain according to the present invention can contain a metal belonging to groups 3 to 13 in the periodic table (displaying groups 1 to 18) or a complex thereof. The metal or a center metal of the metal complex belonging to groups 8 to 10 of the periodic table is preferably rhodium, ruthenium, or iridium. One type of such metal complexes may be used or, otherwise, 2 or more types of complexes of same or different metals may simultaneously be used. A content thereof is preferably in the range, based on 1 mol of silver, of from 1×10⁻⁹ mol to 1×10⁻³ mol. Such heavy metals and metal complexes and, also, addition methods thereof are described in JP-A No. 7-225449, paragraphs 0018 to 0024 of JP-A No. 11-65021, and paragraphs 0227 to 0240 of JP-A No. 11-119374.

In the present invention, a silver halide particle in which a hexacyano metal complex is present on the outermost surface of the particle is preferred. The hexacyano metal complex includes, for example, [Fe(CN)₆]⁴⁻, [Fe(CN)₆]³⁻, [Ru(CN)₆]⁴⁻, [Os(CN)₆]⁴⁻, [Co(CN)₆]³⁻, [Rh(CN)₆]³⁻, [Ir(CN)₆]³⁻, [Cr(CN)₆]³⁻, and [Re(CN)₆]³⁻. In the present invention, hexacyano Fe complex is preferred.

Although a counter cation of the hexacyano metal complex is not important because the hexacyano metal complex exists in ionic form in an aqueous solution, it is preferable to use an alkaline metal ion such as a sodium ion, a potassium ion, a rubidium ion, a cesium ion or a lithium ion, an ammonium ion, or an alkyl ammonium ion (for example, a tetramethyl ammonium ion, a tetraethyl ammonium ion, a tetrapropyl ammonium ion or a tetra (n-butyl) ammonium ion), which are each individually easily compatible with water and appropriate for a precipitation operation of a photosensitive silver halide emulsion.

The hexacyano metal complex can be added while being mixed with water, as well as a mixed solvent of water and an appropriate organic solvent miscible with water (for example, alcohols, ethers, glycols, ketones, esters and amides) or gelatin.

The addition amount of the hexacyano metal complex is, preferably, 1×10⁻⁵ mol or more and 1×10⁻² mol or less and, more preferably, 1×10⁻⁴ mol or more and 1×10⁻³ or less based on one mol of silver.

The hexacyano metal complex is caused to be present on the outermost surface of a silver halide particle by adding the hexacyano metal complex directly after completion of addition of an aqueous solution of silver nitrate used for particle formation, before completion of charging step prior to a chemical sensitization step of conducting chalcogen sensitization such as sulfur sensitization, selenium sensitization and tellurium sensitization or noble metal sensitization such as gold sensitization, during water washing step, during dispersion step or before chemical sensitization step. In order not to grow the fine silver halide particle, the hexacyano metal complex is added preferably soon after the particle formation and it is preferably added before completion of the charging step.

Further, an addition of the hexacyano metal complex may be started after 96% by mass of an entire amount of silver nitrate to be added for the grain formation is added, preferably started after 98% by mass thereof is added, and particularly preferably started after 99% by mass thereof is added.

When any of these hexacyano metal complexes is added during a period of time between after an addition of the aqueous silver nitrate solution is performed and immediately before grain formation is completed, the hexacyano metal complex can be adsorbed on the outermost surface of the photosensitive silver halide grain and most of such hexacyano metal complexes each form an insoluble salt with a silver ion on a grain surface. Since a silver salt of hexacyanoiron (II) is a more insoluble salt than AgI, it can prevent redissolving to be caused by fine grains, as a result, it has become possible to manufacture a photosensitive silver halide fine grain having a small grain size.

Further metal atoms that can be contained in the silver halide particle used in the present invention (for example, [Fe(CN)₆]⁴⁻), a desalting method and a chemical sensitization method of a silver halide emulsion are described in JP-A No.11-84574, column Nos. 0046 to 0050, JP-A No.11-65021, column Nos. 0025 to 0031, and JP-A No.11-119374, column Nos. 0242 to 0250.

5) Gelatin

Various types of gelatin can be used as gelatin to be contained in the photosensitive silver halide emulsion according to the present invention. It is necessary that the photosensitive silver halide emulsion maintains a favorable dispersion state in a coating solution for the image forming layer and, accordingly, it is preferable to use gelatin having a molecular weight in the range of 10,000 to 1,000,000. Further, it is also preferable that a substituent of gelatin is subjected to a phthalating treatment. These types of gelatin may be used at the time of grain formation or at the time of dispersion after a desalting treatment is performed, however, they are preferably used at the time of the grain formation.

6) Sensitizing Dye

As sensitizing dyes applicable to the present invention, a sensitizing dye capable of performing spectral sensitization on the photosensitive silver halide grain in a desired wavelength region when adsorbed on the photosensitive silver halide grain and having spectral sensitivity appropriate to spectral characteristics of an exposure light source can advantageously be selected. The sensitizing dyes and addition methods thereof are described: in paragraphs 0103 to 0109 of JP-A No. 11-65021; as compounds represented by formula (II) in JP-A No. 10-186572; as dyes represented by formula (I) in JP-A No. 11-119374; in paragraph 0106 of JP-A No. 11-119374; in U.S. Pat. No. 5,510,236; as dyes mentioned in Example 5 in U.S. Pat. No. 3,871,887; in JP-A No. 2-96131; as dyes disclosed in JP-A No. 59-48753; in pp. 19 (line 38) to 20 (line 35) of EP-A No. 0803764; in JP-A Nos. 2001-272747, 2001-290238 and 2002-23306; and the like. These sensitizing dyes may be used either alone or in combination of two or more types. Timing of addition of the sensitizing dye in the photosensitive silver halide emulsion is preferably in the period of from after the desalting treatment to before coating and, more preferably, in the period of from after desalting to termination of chemical ripening.

An amount of the sensitizing dye according to the present invention to be added is, though desirably varying depending on sensitivity or fogging performance, preferably in the range of 1×10⁻⁶ mol to 1 mol and, more preferably, in the range of 1×10⁻⁴ mol to 1×10⁻¹ mol, based on 1 mol of the photosensitive silver halide in the image forming layer.

According to the present invention, in order to enhance spectral sensitization efficiency, a supersensitizer can be used. As such supersensitizers according to the present invention, there are compounds as described in, for example, EP-A No. 587,338, U.S. Pat. Nos. 3,877,943 and 4,873,184, JP-A Nos. 5-341432, 11-109547 and 10-111543.

7) Chemical Sensitization

It is preferable that the photosensitive silver halide grain according to the present invention is subjected to chemical sensitization by a sulfur sensitization method, a selenium sensitization method or a tellurium sensitization method. As compounds preferably used in the sulfur sensitization method, the selenium sensitization method or the tellurium sensitization method, known compounds, for example, such compounds as described in JP-A No. 7-128768 can be used. Particularly, according to the present invention, the tellurium sensitization is preferable, and compounds described in the references cited in paragraph 0030 of JP-A No. 11 -65021 and compounds represented by formulas (II), (III) and (IV) of JP-A No. 5-313284 are more preferable.

It is preferable that the photosensitive silver halide grain according to the present invention is subjected to the chemical sensitization simultaneously with the aforementioned chalcogen sensitization or individually by the gold sensitization method. It is preferable that a gold sensitizing agent has an oxidation number of gold of either 1 or 3. A gold compound which is ordinarily used is preferable as the gold sensitizing agent. Specific examples of preferable gold sensitizing agents include chloroauric acid, bromoauric acid, potassium chloroaurate, potassium bromoaurate, auric trichloride, potassium auric thiocyanate, potassium iodoaurate, tetracyanoauric acid, ammonium aurothiocyanate and pyridyl trichloro gold. Further, the gold sensitizing agents described in U.S. Pat. No. 5,858,637 and JP-A No. 2002-278016 are also favorably used.

According to the present invention, the chemical sensitization is capable of being performed at any time so long as it is performed during a time period of from after grain formation to before coating. The timing of performing the chemical sensitization can be, after desalting, in any one case selected from among (1) before spectral sensitization, (2) simultaneously with spectral sensitization, (3) after spectral sensitization and (4) immediately before coating.

An amount of the sulfur, selenium or tellurium sensitizing agent to be used in the present invention varies depending on the photosensitive silver halide grain to be used, a chemical ripening condition and the like, but is approximately in the range of 1×10⁻⁸ mol to 1×10⁻² mol and, preferably, in the range of 1×10⁻⁷ mol to 1×10⁻³ mol, per mol of the photosensitive silver halide.

An amount of the gold sensitizing agent to be added is, though varying depending on various types of conditions, in the range of approximately from 1×10⁻⁷ mol to 1×10⁻³ mol and, more preferably, in the range of 1×10⁻⁶ mol to 1×10⁻⁴ mol, per mol of the photosensitive silver halide.

Conditions of the chemical sensitization according to the present invention are not particularly limited, however, when they are described in terms of approximate numbers, a pH is from 5 to 8, a pAg is from 6 to 11 and a temperature is from 40° C. to 95° C.

The photosensitive silver halide emulsion to be used in the present invention may be added with a thiosulfonic acid compound by a method described in EP-A No. 293,917.

It is preferable that the photosensitive silver halide grain according to the present invention is used simultaneously with a reduction sensitizing agent. As specific compounds as such reduction sensitizing agents, ascorbic acid and aminoiminomethane sulfinic acid are preferable, and, for other compounds, stannous chloride, a hydrazine derivative, a borane compound, a silane compound and a polyamine compound can preferably be used. The reduction sensitizing agent may be added at any stage of a photosensitive emulsion production step, that is, from a step of crystal growth to a preparation step immediately before coating. Further, it is preferable that the reduction sensitization is performed by ripening the grain while keeping the emulsion at pH 7 or more, or at pAg 8.3 or less. It is also preferable that the reduction sensitization is performed by introducing a single addition portion of a silver ion during the formation of the grain.

8) Compound in Which a One-Electron Oxidant Formed by One-Electron Oxidation Can Release One Electron or More Electrons

The photothermographic material in the present invention preferably contains a compound in which a one-electron oxidant formed by one-electron oxidation can release one electron or more electrons. The compound is used alone or together with the various chemical sensitizers described above and can increase sensitivity of the silver halide.

The compound in which a one-electron oxidant formed by one-electron oxidation can release one electron or more electrons contained in the photosensitive material of the present invention is a compound selected from the following types 1 and 2.

Type 1 and Type 2 compounds contained in the photothermographic material of the present invention are to be described.

Type 1

A compound in which a one-electron oxidant formed by one-electron oxidation can further release one or more electrons accompanying successive bonding cleavage reaction.

Type 2

A compound in which a one-electron oxidant formed by one-electron oxidation can further release one or more electrons after successive bonding forming reaction.

At first the type 1 compound is described.

The type 1 compound in which a one-electron oxidant formed by one-electron oxidation can further release one electron accompanying successive bonding cleavage reaction can include those compounds which are referred to as “1-photon 2-electron sensitizing agent” or “deprotonating electron donating sensitizing agent” described in patent literatures such as JP-A No. 9-211769 (specific examples: compounds PMT-1 to S-37 described in Table E and Table F in pages 28-32), JP-A Nos. 9-211774, and 11-95355 (specific examples: compounds INV 1 to 36), JP-W No. 2001-500996 (specific examples, compounds 1 to 74, 80 to 87, and 92 to 122), U.S. Pat. Nos. 5747235 and 5747236, EP No. 786692 A1 (specific examples: compounds INV 1 to 35), EP-A No. 893732 A1, U.S. Pat. Nos. 6,054,260 and 5,994,051. Further, preferred ranges for the compounds are identical with the preferred ranges described in the cited patent specifications.

The type 1 compound in which a one-electron oxidant formed by one-electron oxidation can further release one electron or more electrons accompanying successive bonding cleavage reaction can include those compounds represented by formula (1) (identical with formula (1) described in JP-A No. 2003-114487), formula (2) (identical with formula (2) described in JP-A No. 2003-114487), formula (3) (identical with formula (1) described in JP-A No. 2003-114488), formula (4) (identical with formula (2) described in JP-A No. 2003-114488), formula (5) (identical with formula (3) described in JP-A No. 2003-114488), formula (6) (identical with formula (1) described in JP-A No. 2003-75950), formula (7) (identical with formula (2) described in JP-A No. 2003-75950), formula (8) (identical with formula (1) described in JP-A No. 2004-239943, which has not been published at the time of the present application), and formula (9) (identical with formula (3) described in JP-A No. 2004-245929, which has not been published at the time of the present application) among the compounds capable of causing reaction represented by the chemical reaction formula (1) (identical with chemical reaction formula (1) described in JP-A No. 2004-245929, which has not been published at the time of the present application). Further, preferred ranges for the compounds are identical with the preferred ranges described in the cited patent specifications. The disclosure of the above-described patent documents are incorporated by reference herein.

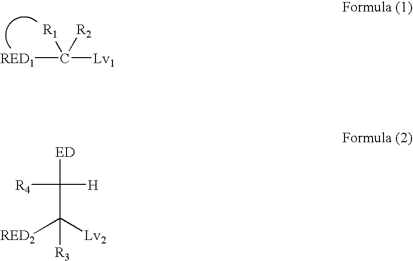

In formulae (1) and (2), RED₁ and RED₂ each independently represent a reducing group. R₁ represents a group of non-metal atoms capable of forming, together with the carbon atom (C) and RED₁, a cyclic structure corresponding to a tetrahydro form or a hexahydro form of a 5-membered or 6-membered aromatic ring (including aromatic heterocyclic ring), R₂, R₃ and R₄ each independently represent hydrogen atom or a substituent, Lv₁ and Lv₂ each independently represent a leaving group, and ED represents an electron donating group.

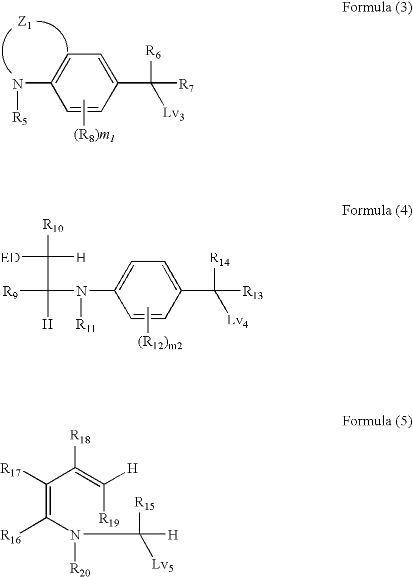

In formulae (3), (4) and (5), Z₁ represents a group of atoms capable of forming a 6-membered ring together with a nitrogen atom and two carbon atoms of the benzene ring, R₅, R₆, R₇, R₉, R₁₀, R₁₁, R₁₃, R₁₄, R₁₅, R₁₆, R₁₇, R₁₈ and R₁₉ each independently represent hydrogen atom or a substituent, R₂₀ represents hydrogen atom or a substituent, in which R₁₆ and R₁₇ are joined to each other to form an aromatic ring or aromatic heterocyclic ring in a case where R₂₀ represents a group other than the aryl group, R₈ and R₁₂ each independently represent a substituent capable of substituting the benzene ring, m1 represents an integer of 0 to 3, m2 represents an integer of 0 to 4 and Lv₃, Lv₄ and Lv₅ each independently represent a leaving group.

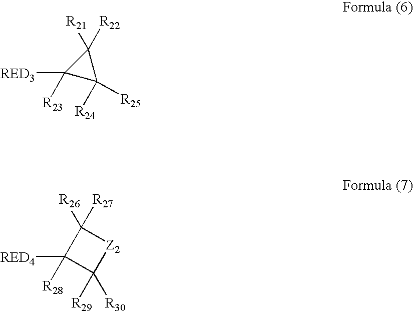

In formulae (6) and (7), RED₃ and RED₄ each independently represent a reducing group, R₂₁ to R₃₀ each independently represent hydrogen atom or a substituent, Z₂ represents —CR₁₁₁R₁₁₂—, —NR₁₁₃—, or O—, R₁₁₁ and R₁₁₂ each independently represent hydrogen atom or a substituent, and R₁₁₃ represents hydrogen atom, alkyl group, aryl group or heterocyclic group.

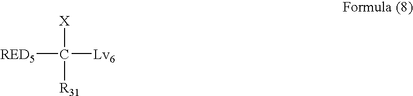

In formula (8), RED₅ is a reducing group, which represents an aryl amino group or heterocyclic amino group, R₃₁ represents hydrogen atom or a substituent, X represents an alkoxy group and aryloxy group, heterocyclicoxy group, alkylthio group, arylthio group, heterocyclicthio group, alkylamino group, arylamino group, or heterocyclic amino group. Lv₆ is a leaving group which represents a carboxyl group or a salt thereof, or hydrogen atom.

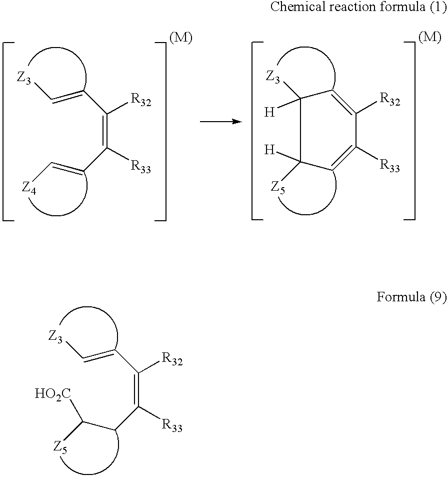

The compound represented by formula (9) is a compound causing bonding forming reaction represented by the chemical reaction formula (1) by further oxidation after 2-electron oxidation accompanying decarbonation. In the chemical reaction formula (1), R₃₂ and R₃₃ each independently represent hydrogen atom or a substituent, Z₃ represents a group forming a 5-membered or 6-membered heterocyclic ring together with C═C, Z₄ represents a group forming a 5-membered or 6-membered aryl group or heterocyclic group together with C═C, M represents a radial, radical cation or cation. In formula (9), R₃₂ and R₃₃, Z₃ have the same meanings as those for the chemical reaction formula (1), Z₅ represents a group forming a 5-membered or 6-membered cycloaliphatic hydrocarbon group or heterocyclic group together with C—C.

Then the type 2 compound is to be described.

The type 2 compound in which one-electron oxidant formed by one-electron oxidation can further release one electron or more electrons accompanying successive bonding forming reaction can include those compounds represented by formula (10) (identical with formula (1) described in JP-A No. 2003-140287), and those compounds capable of causing reaction represented by the chemical reaction formula (1) (identical with chemical reaction formula (1) described in JP-A No. 2004-245929, which has not been published at the time of the present application) represented by formula (11) (identical with formula (2) described in JP-A No. 2004-245929, which has not been published at the time of the present application). Preferred ranges for the compounds are identical with preferred ranges described in the cited patent specifications.
RED₆-Q-Y Formula (10);

In formula (10), RED₆ represents a reducing group subjected to one-electron oxidation, Y represents a reaction group including a carbon-carbon double bond site, carbon-carbon triple bond site, aromatic group site, or a non-aromatic heterocyclic site formed by condensation of benzo ring capable of reacting with one-electron oxidant formed by one-electron oxidation of RED₆ and forming a new bond, and Q represents a connection group connecting RED₆ and Y.

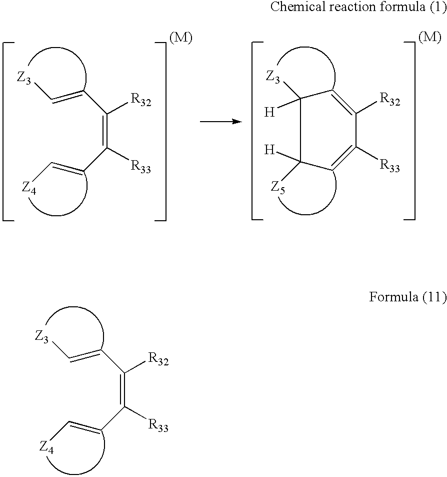

The compound represented by formula (11) is a compound causing the bonding forming reaction represented by the chemical reaction formula (1) upon oxidation. In the chemical reaction formula (1), R₃₂ and R₃₃ each independently represent hydrogen atom or a substituent, Z₃ represents a group forming, together with C═C, a 5-membered or 6-membered heterocyclic group, Z₄ represents a group forming a 5-membered or 6-membered aryl group or hetercyclic group together with C═C, Z₅ represents a group forming a 5-membered or 6-membered cycloaliphatic hydrocarbon group or heterocyclic group together with C—C, and M represents a radical, radical cation or cation. In formula (11), R₃₂, R₃₃, Z₃, Z₄ have the same meanings as those in the chemical reaction (1).

Among the type 1 and type 2 compounds, preferred are “compound having an adsorptive group to silver halide in the molecule” or “compound having a partial structure of a spectral sensitizing dye in the molecule”. A typical absorptive group to the silver halide is a group described in the specification of JP-A No. 2003-156823, page 16, right column, line 1 to page 17, right column, line 12. The partial structure for the spectral sensitizing dye is a structure described in the above-mentioned specification, page 17, right column, line 34 to page 18, left column, line 6.

Among the type 1 and type 2 compounds, more preferred are “compound having at least one adsorptive group to silver halide in the molecule” and, further preferably, “compound having two or more absorptive groups to silver halide in the identical group”. In a case where two or more absorptive groups are present in a single molecule, the absorptive groups may be identical or different with each other.

Preferred adsorptive groups can include a mercapto-substituted nitrogen-containing heterocyclic group (for example, 2-mercaptothiadiazole group, 3-mercapto-1,2,4-triazole group, 5-mercaptotetrazole group, 2-mercapto-1,3,4-oxathiazole group, 2-mercaptobenzoxazole group, 2-mercaptobenzthiazole group, 1,5-dimethyl-1,2,4-triazolium-3-thiorate group, etc.), or a nitrogen-containing hetero-ring group having —NH— group capable of forming imino silver (>NAg) as a partial structure of the heterocyclic (for example, benzotriazole group, benzimadazole group, indazole group, etc.). Particularly preferred are 5-mercaptotetrazole group, 3-mercapto-1,2,4-triazole group, and benzotriazole group and, most preferred are 3-mercapto-1,2,4-triazole group and 5-mercaptotetrazole group.

Absporptive group having two or more mercapto groups in the molecule as the partial structure are also particularly preferred. The mercapto group (—SH), in a case where it is tautomerically isomerizable, may form a thion group. Preferred examples of adsorptive groups having two or more mercapto groups as the partial structure (for example, dimercapto substituted nitrogen-containing heterocyclic group) can include a 2,4-dimercaptopyrimidine group, 2,4-dimercaptotriazine group, and 3,5-dimercapto-1,2,4-triazole group.

A quaternary salt structure of nitrogen or phosphorus can also be used preferably as the absorptive group. The quaternary salt structure of nitrogen can include, specifically, an ammonio group (trialkyl ammonio group, dialkylaryl (or heteroaryl) ammonio group, alkyldiaryl (or heteroaryl) ammonio group) or a group containing a nitrogen-containing heterocyclic group containing a quatenarized nitrogen atom. The quaternary salt structure of phosphorus can include a phosphonio group (trialkyl phosphonio group, dialkylaryl or heteroaryl) phosphonio group, alkyldiaryl (or heteroaryl) phosphonio group, triaryl (or heteroaryl) phosphonio group. More preferably, a quaternary salt structure of nitrogen is used and, further preferably, a 5-membered or 6-membered nitrogen containing aromatic heterocyclic group containing quaternarized nitrogen atom is used. Particularly preferably, a pyridinio group, quinolinio group or isoquinolinio group is used. The nitrogen-containing heterocyclic group containing the quaternarized nitrogen atom may have an optional substituent.

Examples for the counter anion of the quaternary salt can include, for example, halogen ion, carboxylate ion, sulfonate ion, sulfate ion, perchlorate ion, carbonate ion, nitrate ion, BF₄⁻ PF₆⁻ and Ph₄B. In a case where there exists a group having negative charges such as on a carboxylate group in the molecule, it may form an intramolecular salt therewith. As the counter anion not present in the molecule, chlorine ion, bromine ion or methane sulfonate ion is particularly preferred.

The preferred structure of the compound represented by the types 1 and 2 having the quaternary salt structure of nitrogen or phosphorus as the adsorptive group is represented by formula (X).
(P-Q₁-)ᵢ-R(-Q₂-S)ⱼ Formula (X);

In formula (X), P and R each independently represent a quaternary salt structure of nitrogen or phosphorus which is not a partial structure of the sensitizing dye, Q₁ and Q₂ each independently represent a connection group, specifically, a single bond, alkylene group, arylene group heterocyclic group, —O—, —S—, —NR_{N}—, —C(═O)—, —SO₂—, —SO—, —P(═O)— each alone or in combination of such groups in which R_{N} represents hydrogen atom, alkyl group, aryl group, or heterocyclic group, S represents a residue formed by removing one atom from the compound represented by type (1) or (2), i and j each independently represent an integer of 1 or greater and are selected within a range of i+j of from 2 to 6. Preferably, i is 1 to 3 and j is 1 to 2 and, more preferably, i is 1 or 2 and j is 1 and, most preferably, i is 1 and j is 1. In the compound represented by formula (X), the total number of carbon atoms thereof is preferably within a range from 10 to 100 and, more preferably, 10 to 70 and, further preferably, 11 to 60 and, particularly preferably, 12 to 50.

Specific examples for the compounds represented by type 1 and type 2 are set forth below but the present invention is not restricted to them.

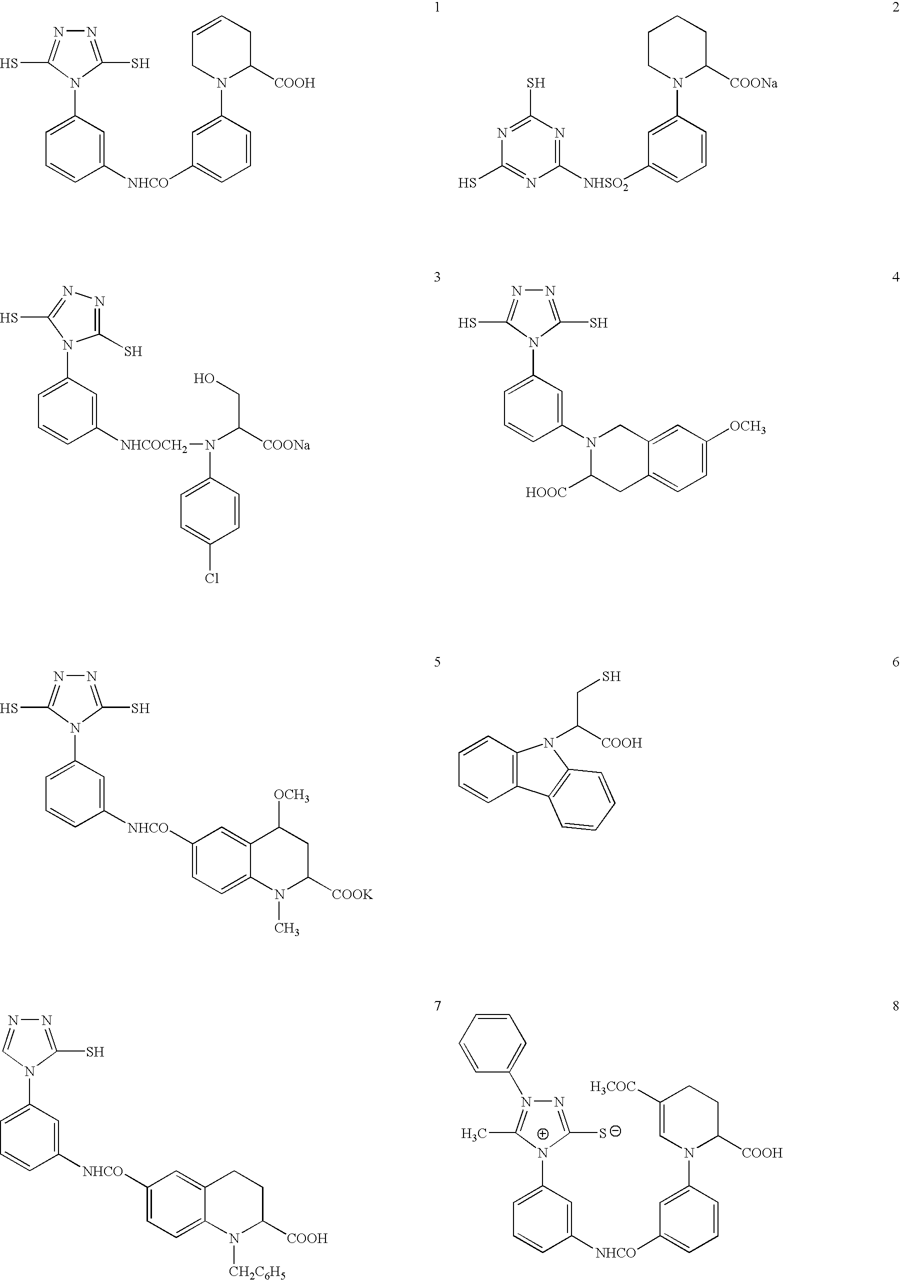

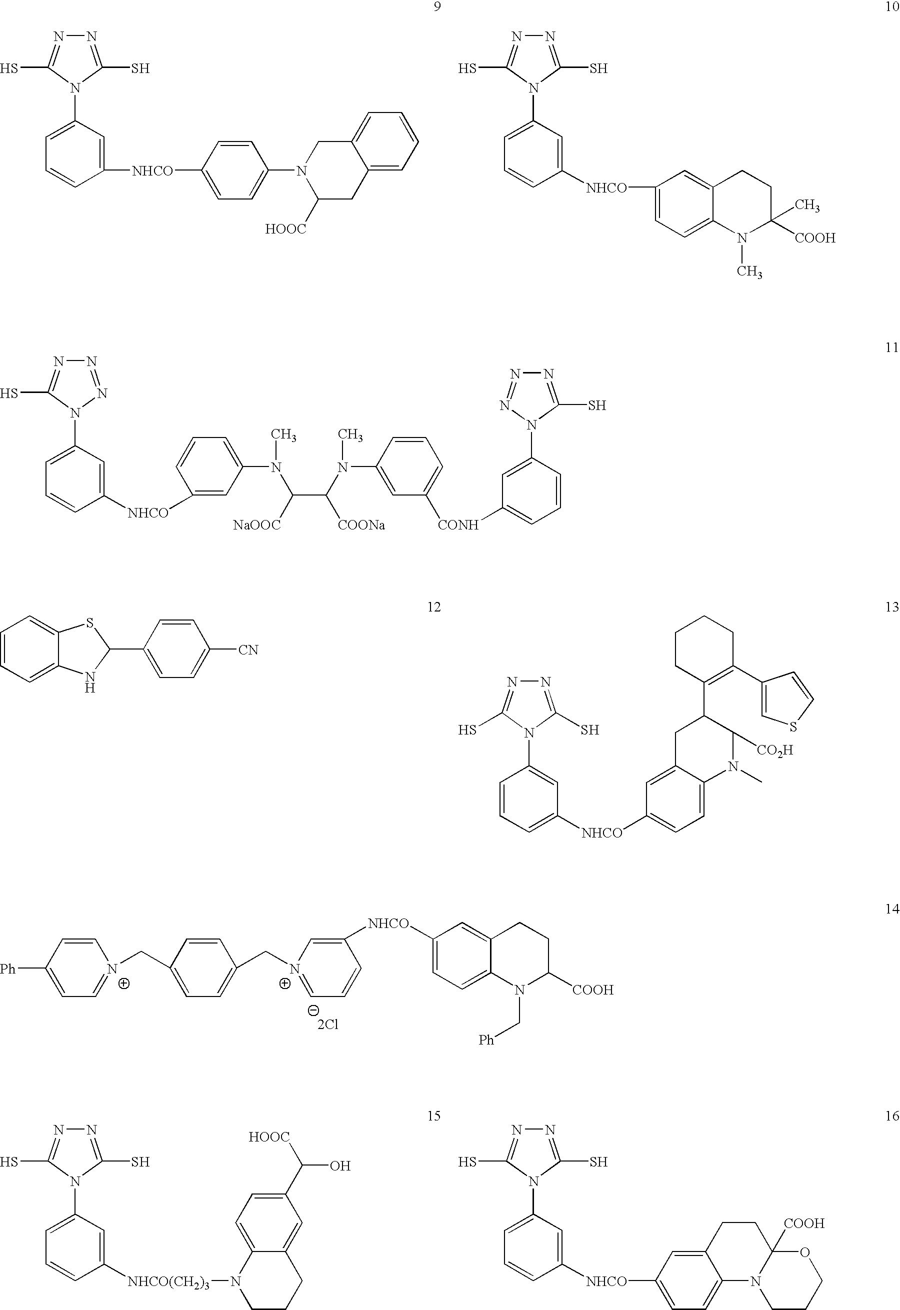

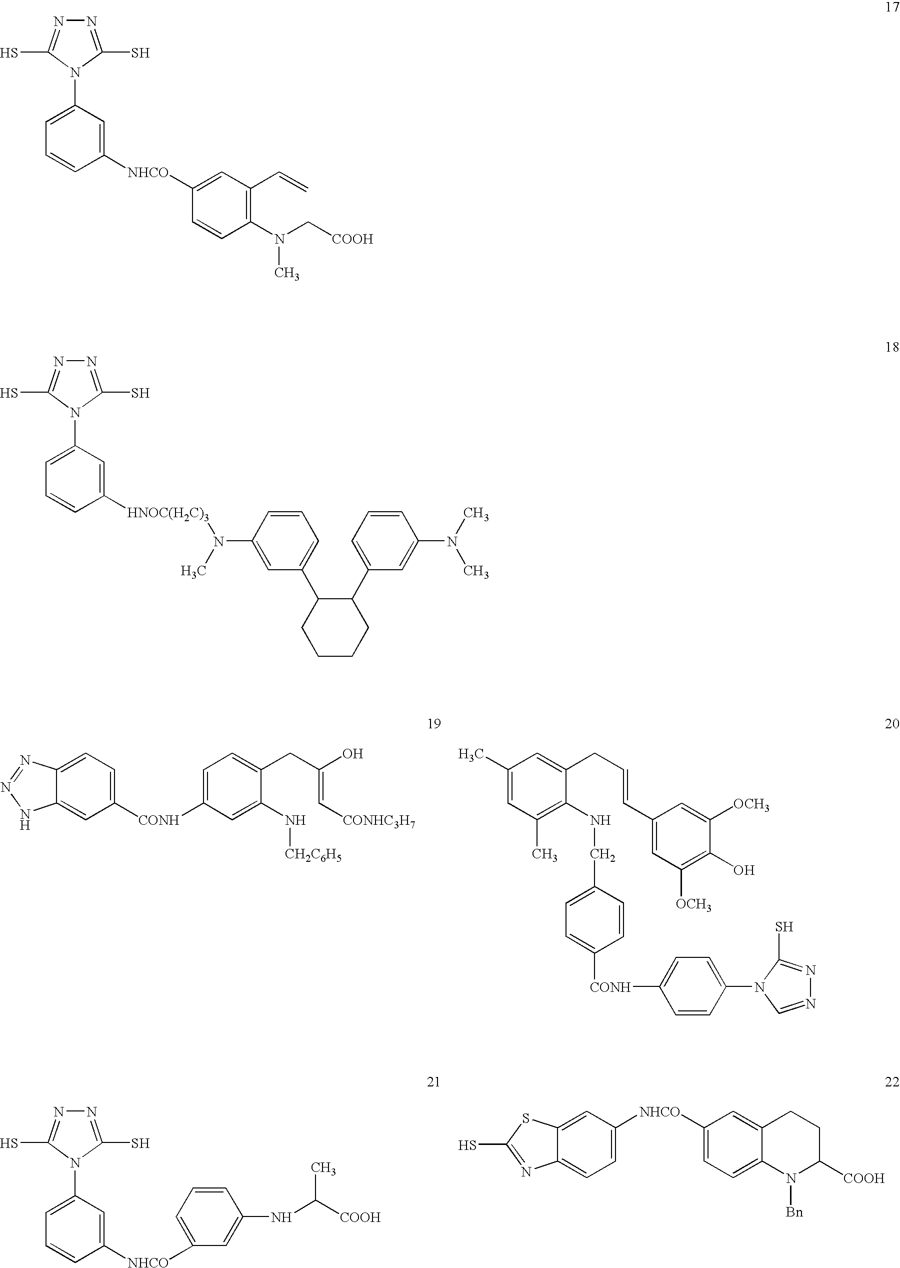

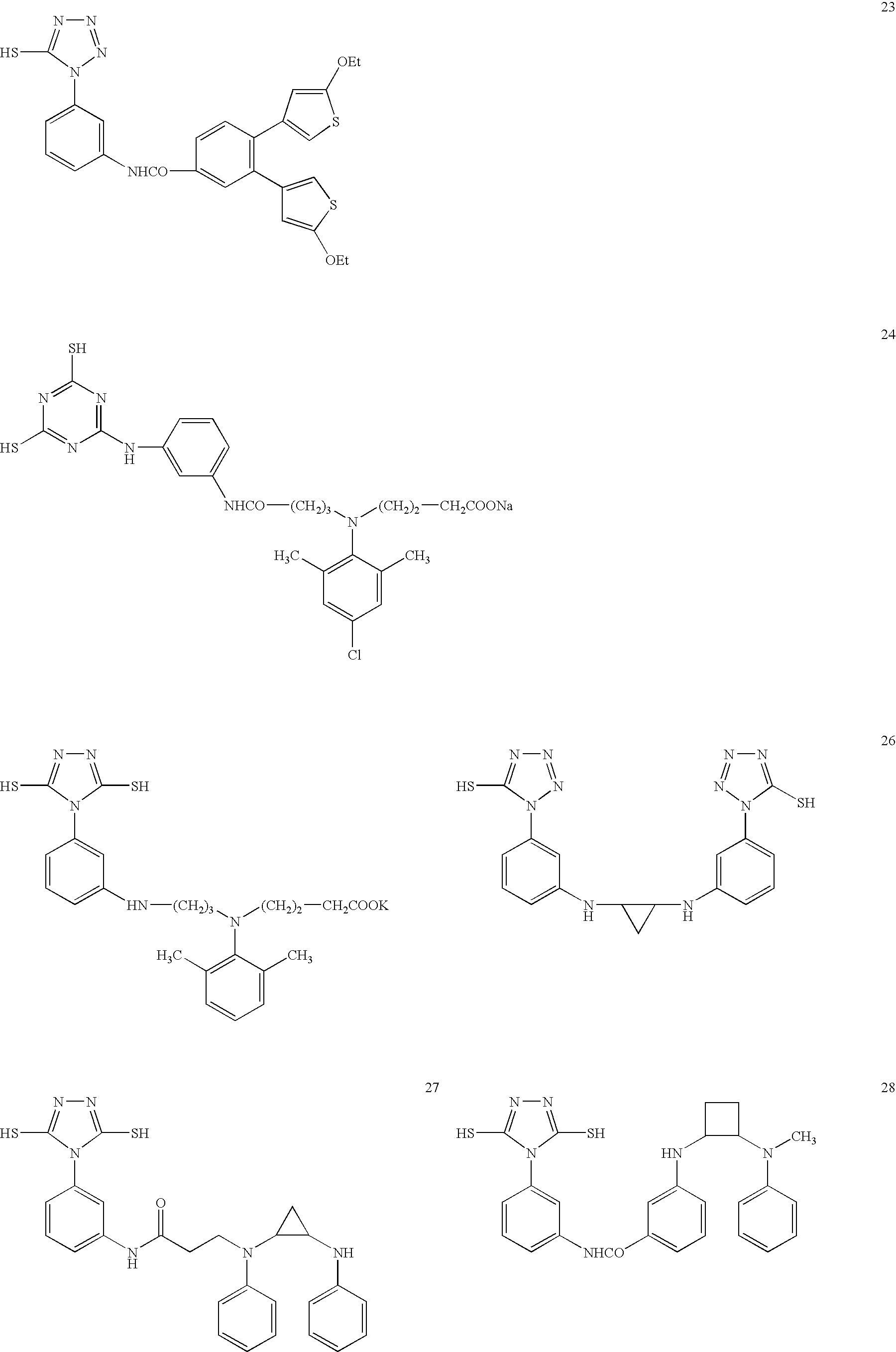

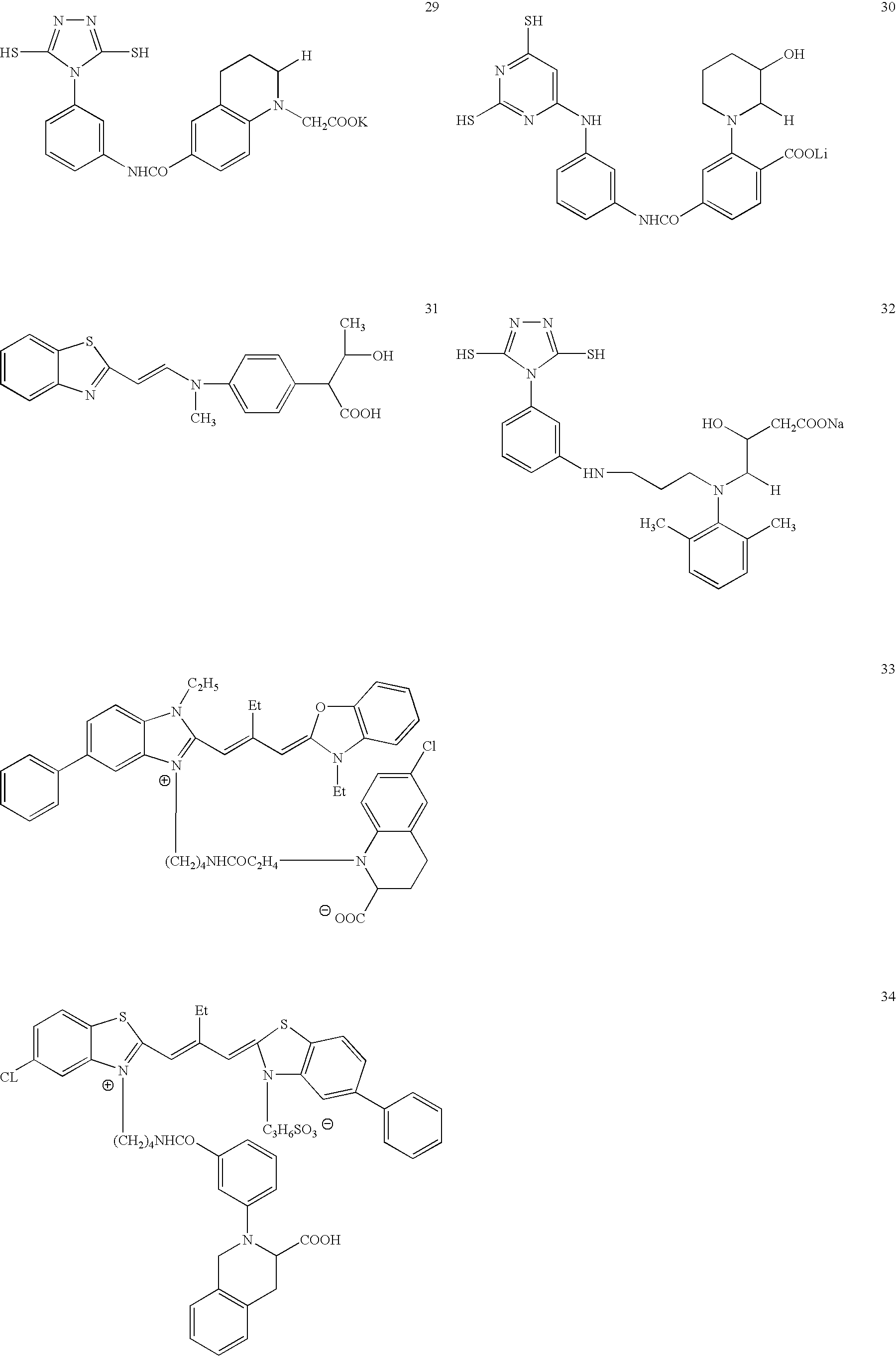

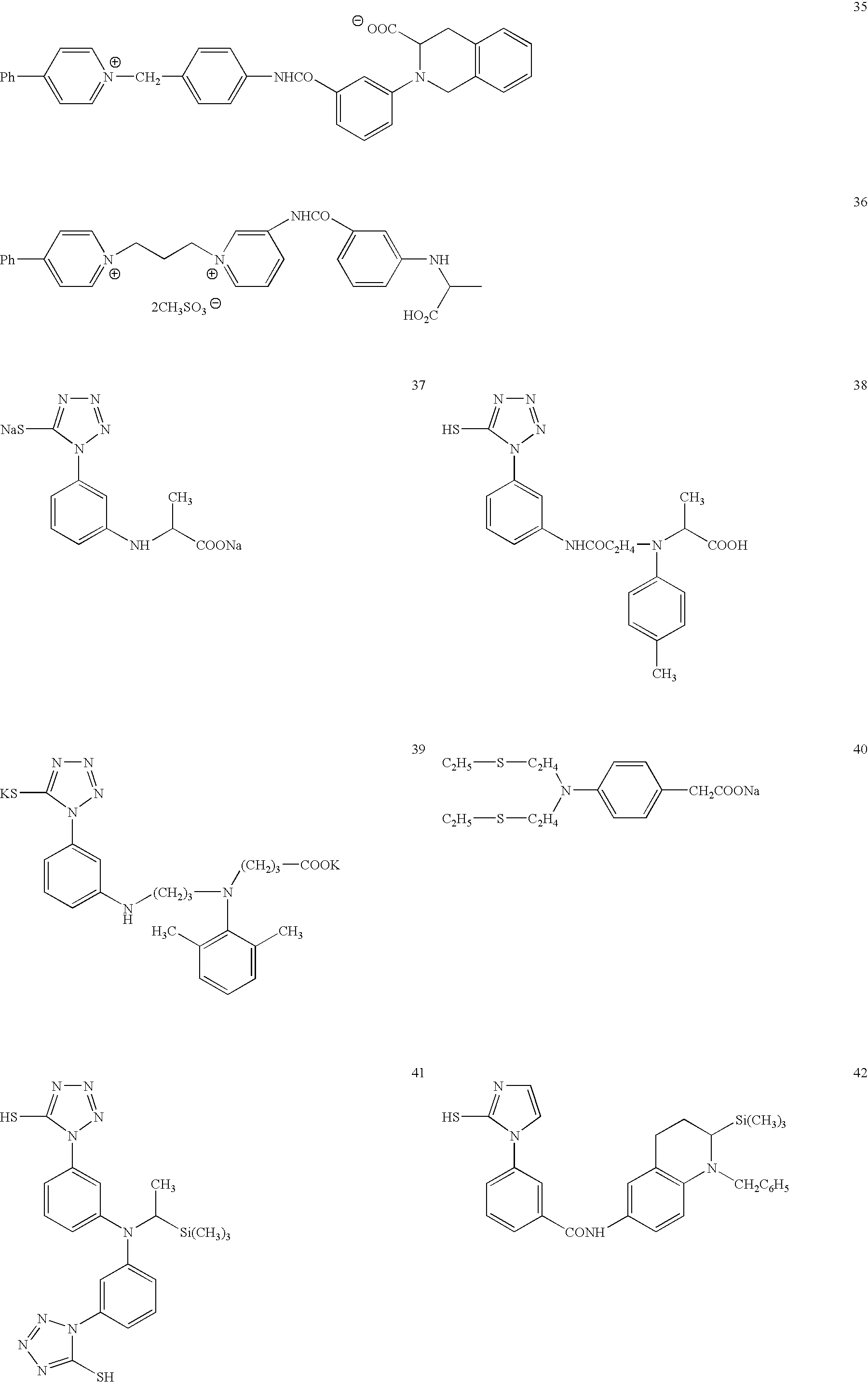

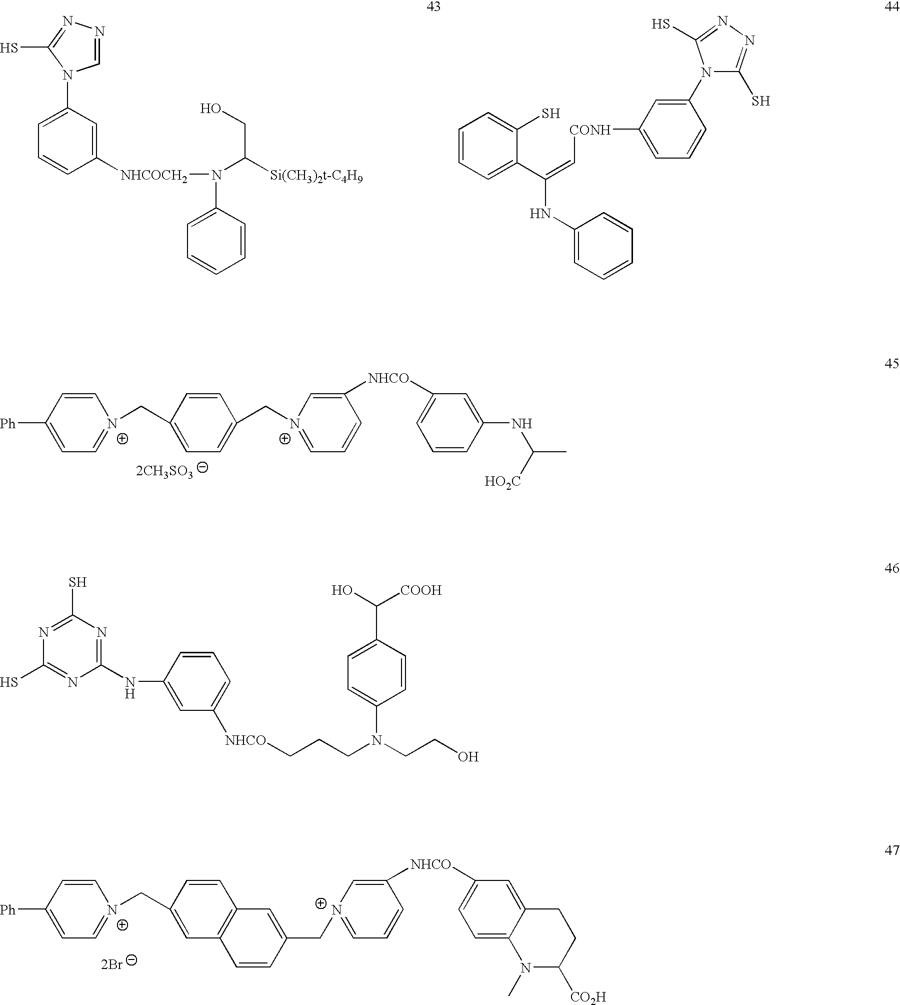

The compound of type 1 or type 2 in the present invention may be used at any step during preparation of the emulsion or in the production steps for the photothermographic material. For example, the compound may be used upon formation of particles, during desalting step, during chemical sensitization and before coating. Further, the compound can be added divisionally for plural times during the steps and added, preferably, from the completion of formation of the particles before the desalting step, during chemical sensitization (just before starting to just after completion of chemical sensitization), and before coating and, more preferably, during the chemical sensitization and before coating.

The compounds of type 1 and type 2 in the present invention are preferably added being dissolved in a water or a water soluble solvent such as methanol or ethanol or a mixed solvent of them. In a case of dissolving in water, a compound the solubility of which is improved by controlling the pH higher or lower may be added by dissolution while controlling the pH to a higher or lower level.

The compound of type 1 or type 2 in the present invention is preferably used in an emulsion layer (imege forming layer) but it may be added to a protective layer or an intermediate layer as well as to the emulsion layer, and then diffused upon coating. The addition timing of the compound may be either before or after the applying of the sensitizing dye and is incorporated respectively in a silver halide emulsion layer, preferably, at a ratio of 1×10⁻⁹ mol or more and 5×10⁻² mol or less and, more preferably, 1×10⁻⁴ mol or more and to 2×10⁻³ mol per one mol of the silver halide.

9) Adsorptive Redox Compound Having Adsorptive Group and Reducing Group

In the present invention, an adsorptive redox compound having the adsorptive group to the silver halide and the reducing group in the molecule is preferably contained. The adsorptive redox compound is preferably a compound represented by the following formula (i).
A-(W)ₙ—B Formula (I);

In formula (I), A represents a group that can be adsorbed to a silver halide (hereinafter referred as an adsorptive group), W represents a bivalent connection group, n represents 0 or 1 and B represents a reducing group.

The adsorptive group represented by A in formula (I) is a group directly adsorbing to the silver halide or a group promoting adsorption to the silver halide and it can include, specifically, a mercapto group (or a salt thereof), thion group (—C(═S)—), a heterocyclic group containing at least one atom selected from nitrogen atom, sulfur atom, selenium atom and tellurium atom, sulfide group, disulfide group, cationic group or ethynyl group.

The mercapto group (or a salt thereof) as the adsorptive group means the mercapto group (or a salt thereof) itself, as well as represents, more preferably, a heterocyclic group, aryl group or alkyl group substituted with at least one mercapto group (or the salt thereof). The heterocyclic group is at least a 5-membered to 7-membered single or condensed aromatic or non-aromatic heterocyclic group including, for example, imidazole ring group, thiazole ring group, oxazole ring group, benzimidazole ring group, benzothiazole ring group, benzoxazole ring group, triazole ring group, thiadiazole ring group, oxadiazole ring group, tetrazole ring group, purine ring group, pyridine ring group, quinoline ring group, isoquinoline ring group, pyrimidine ring group, and triazine ring group. Further, it may also be a heterocyclic group containing a quaternarized nitrogen atom, in which the substituting mercapto group may be dissociated to form a meso ion. When the mercapto group forms a salt, the counter ion can include, for example, a cation of an alkali metal, alkaline earth metal or heavy metal (Li⁺, Na⁺, K⁺, Mg²⁺, Ag⁺, Zn²⁺), ammonium ion, heterocyclic group containing quaternarized nitrogen atom, or phosphonium ion.

The mercapto group as the adsorptive group may also be tautomerically isomerized into a thion group.

The thione group as the adsorptive group can also include a linear or cyclic thioamide group, thioureido group, thiourethane group or dithiocarbamate ester group.

The heterocyclic group containing at least one atom selected from the nitrogen atom, sulfur atom, selenium atom and tellurium atom as the adsorptive group is a nitrogen-containing heterocyclic group having —NH— group capable of forming imino silver (>NAg) as a partial structure of the heterocyclic ring, or a heterocyclic group having an —S— group, —Se— group, —Te— group or ═N— group capable of coordination bond to a silver ion by way of coordination bonding as a partial structure of the heterocyclic ring. Examples of the former can include, for example, benzotriazole group, triazole group, indazole group, pyrazole group, tetrazole group, benzoimidazole group, imidazole group, and purine group, and examples of the latter can include, for example, thiophene group, thiazole group, oxazole group, benzothiophene group, benzothiazole group, benzoxazole group, thiadiazole group, oxadiazole group, triazine group, selenoazole group, benzoselenoazole group, tellurazole group, and benzotellurazole group.

The sulfide group or disulfide group as the adsorptive group can include all of the groups having the —S— or —S—S— partial structure.

The cationic group as the adsorptive group means a group containing a quaternarized nitrogen atom, specifically, a group containing a nitrogen-containing heterocyclic group containing an ammonio group or quaternarized nitrogen atom. The nitrogen-containing heterocyclic group containing the quaternarized nitrogen atom can include, for example, pyridinio group, quinolinio group, isoquinolinio group, and imidazolio group.

The ethynyl group as the adsorptive group means —C≡CH group in which the hydrogen atom may be substituted.

The adsorptive group may have an optional substituent.

Further, specific examples of the adsorptive group can include those described in the specification of JP-A No. 11-95355, in pages 4 to 7.

Preferred adsorptive group represented by A in formula (I) can include mercapto-substituted heterocyclic group (for example, 2-mercaptothiadiazole group, 2-mercapto-5-aminothiadiazole group, 3-mercapto-1,2,4-triazole group, 5-mercaptotetrazole group, 2-mercapto-1,3,4-oxadiazole group, 2-mercaptobenzimidazole group, 1,5-dimethyl-1,2,4-triazolium-3-thiorate group, 2,4-dimercapto pyrimidine group, 2,4-dimercapto triazine group, 3,5-dimercapto-1,2,4-triazole group, and 2,5-dimercapto-1,3-thiazole), or a nitrogen-containing heterocyclic group having —NH— group capable of forming imino silver (>NAg) as a partial structure of the heterocyclic ring (for example, benzotriazole group, benzimidazole group, and indazole group). More preferred adsorptive groups are 2-mercaptobenzimidazole group and 3,5-dimercapto-1,2,4-triazole group.

In formula (I), W represents a bivalent connection group. Any connection group may be used so long as it does not give undesired effects on photographic properties. For example, bivalent connection groups constituted with carbon atom, hydrogen atom, oxygen atom, nitrogen atom or sulfur atom can be utilized. They can include, specifically, alkylene group of 1 to 20 carbon atoms (for example, methylene group, ethylene group, trimethylene group, tetramethylene group, and hexamethylene group), alkenylene group of 2 to 20 carbon atoms, alkinylene group of 2 to 20 carbon atoms, arylene group of 6 to 20 carbon atoms (for example, phenylene group and naphthylene group), —CO—, —SO₂—, —O—, and —NR₁— and combination of such connection groups, in which R₁ represents hydrogen atom, alkyl group, heterocyclic group, or aryl group.

The connection group represented by W may further have other optional substituent.

In formula (I), the reducing group represented by B represents a group capable of reducing silver ion and can include, for example, residues derived by removing one hydrogen atom, from formyl group, amino group, triple bond group such as an acetylene group or propargyl group, mercapto group, hydroxyl amines, hydroxamic acids, hydroxy ureas, hydroxy urethanes, hydroxy semicarbazides, reductones (including reductone derivatives), anilines, phenols (including chroman-6-ols, 2,3-dihydrobenzofuran-5-ols, aminophenols, sulfoneamide phenols, and polyphenols such as hydroquinones, catechols, resorcinols, benzene triols and bisphenols), acyl hydrazines, carbamoyl hydrazides, and 3-pyrazolidone. They may have an optional substituent.

In formula (I), the oxidation potential for the reducing agent represented by B can be measured by a measuring method described in “Electrochemical Measuring Method” written by Akira Fujishima (published from Gihodo, pp 150-208) or “Experimental Chemical Course” edited by Chemical Society of Japan, 4th edition (vol. 9, pp 282-344, published from Maruzen). For example, it can be measured by a method of rotational disk volutammetry, specifically, by dissolving a specimen into a solution of methanol: pH 6.5, Britton-Robinson buffer=10%:90% (vol%), passing a nitrogen gIn the case of 10 min, and then measuring at 25° C. under 1000 rpm, at a sweeping velocity of 20 mV/sec while using a rotational disk electrode (RDE) made of glassy carbon as an operational electrode, using a platinum wire as a counter electrode and using a saturation calomel electrode as a reference electrode. A half-wave potential (E1/2) can be determined based on the obtained voltamogram.

The oxidation potential for the reducing group represented by B in the present invention, when measured by the measuring method described above, is preferably within a range from about −0.3 V to about 1.0 V. More preferably, it is within a range from about −0.1 V to about 0.8 V and, particularly preferably, is within a range from about 0 to about 0.7 V.

The reducing agent represented by B in formula (1) is preferably a residue, derived by removing one hydrogen atom from hydroxyl amines, hydroxamic acids, hydroxy ureas, hydroxy semi-carbazid, reductone, phenols, acyl hydrazines, carbamoyl hydrazines and 3-pyrazolidones.

The compound of formula (I) of the present invention may also be incorporated with a ballast group or a polymer chain used customarily as additives for static photography such as couplers. Further, the polymer can include those described, for example, in JP-A No. 1-100530.

The compound of formula (I) in the present invention may be a bis-form or tris-form. The molecular weight of the compound of formula (I) according to the present invention is, preferably, between 100 to 10,000, more preferably, between 120 to 1,000 and, particularly preferably, between 150 to 500.

Compounds of formula (I) according to the present invention are exemplified below but the present invention is not restricted to them.

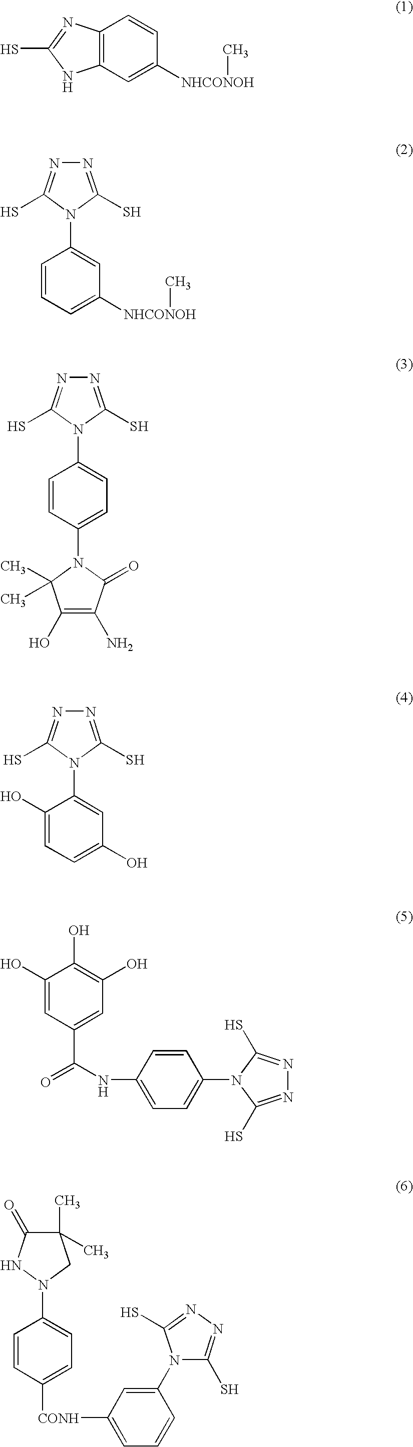

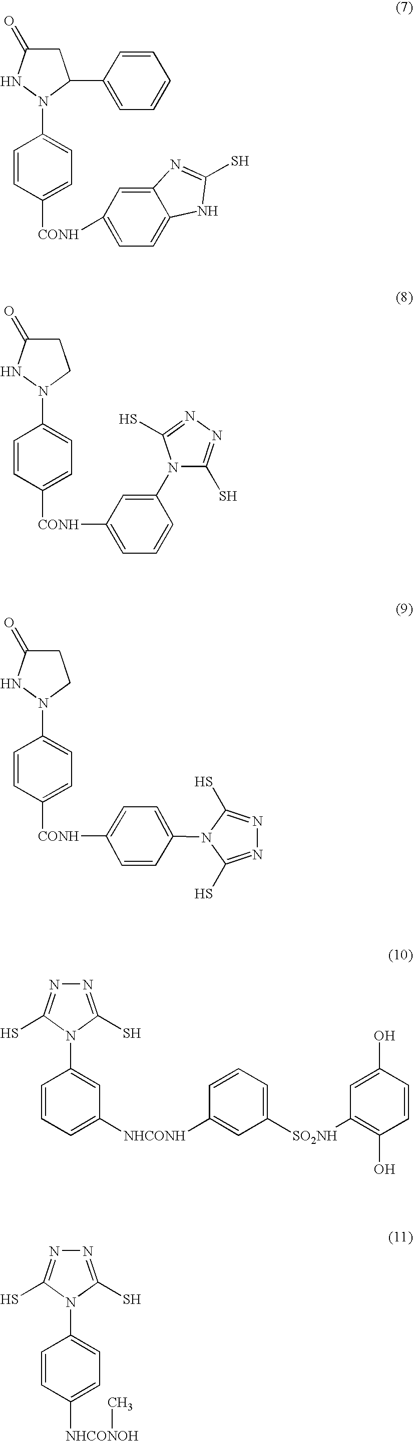

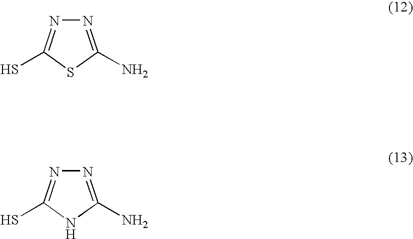

Further, also the specific compounds 1 to 30, 1″-1 to 1″-77 described in the specification of EP No. 1308776A2, pages 73 to 87 can also been mentioned as preferred examples of the compound having the adsorptive group and the reducing group in the present invention.

The compound of the present invention can be synthesized easily according to the known method. The compound of formula (I) in the present invention may be used alone as a single kind of compound and it is also preferred to use two or more kinds of compounds together. In a case of using two or more kinds of compounds, they may be added to an identical layer or two separate layers, and the addition methods may be different, respectively.

The compound of formula (I) according to the present invention is preferably added to a silver halide emulsion layer and it is preferably added upon preparation of the emulsion. In a case of adding upon preparation of the emulsion, it may be added at any step thereof. Examples of addition can include, for example, during the particle forming step of silver halide, before the starting the desalting step, during desalting step, before starting chemical aging, during the chemical aging step and step before preparation of complete emulsion. Further, the compound may be added divisionally for several times during the steps. Further, while it is preferably used for the image-forming layer, it may be added also to the adjacent protective layer or the intermediate layer as well as the image-forming layer, and may be diffused during coating.

A preferred addition amount greatly depends on the addition method described above or species of the compounds to be added. It is generally 1×10⁻⁶ mol or more and 1 mol or less, preferably, 1×10⁻⁵ mol or more and 5×10⁻¹ mol or less and, more preferably, 1×10⁻⁴ mol or more and 1×10⁻¹ mol or less per one mol of the photosensitive silver halide.

The compound of formula (I) in the present invention may be added by being dissolved in water, a water soluble solvent such as methanol or ethanol or a mixed solvent thereof. In this case, pH may be controlled adequately with an acid or base, or a surfactant may be present together. Further, it may be added as an emulsified dispersion being dissolved in a high boiling organic solvent. Further, it may be added also as a solid dispersion.

10) Use of a Plurality of Photosensitive Silver Halides

As the photosensitive silver halide emulsion in the photosensitive material according to the present invention, any one type thereof may singly be used, or two or more types thereof (for example, those having different average grain sizes, different halogen compositions, different crystal habits or different conditions of chemical sensitization from one another) may simultaneously be used. Using a plurality of types of photosensitive silver halides having different extents of sensitivity from one another allows gradation to be adjusted. Related technologies are described in, for example, JP-A Nos. 57-119341, 53-106125, 47-3929, 48-55730, 46-5187, 50-73627 and 57-150841. Sensitivity difference between any two emulsions is preferably 0.21 ogE or more.

11) Coating Amount

An amount of the photosensitive silver halide to be added is, in terms of an amount of applied silver per m² of the sensitive material, preferably in the range of 0.03 g/m² to 0.6 g/m², more preferably in the range of 0.05 g/m² to 0.4 g/m² and, most preferably, in the range of 0.07 g/m² to 0.3 g/m². Further, the amount of the photosensitive silver halide to be added is, based on 1 mol of the non-photosensitive organic silver salt, preferably in the range of 0.01 mol to 0.5 mol, more preferably in the range of 0.02 mol to 0.3 mol and, still more preferably, in the range of 0.03 mol to 0.2 mol.

12) Mixing of Photosensitive Silver Halide and Non-Photosensitive Organic Silver Salt

Regarding a method and a condition for mixing the photosensitive silver halide and the non-photosensitive organic silver salt which have separately been prepared in advance, there are provided a method in which the thus-prepared photosensitive silver halide grain and the non-photosensitive organic silver salt are mixed with each other by using any one of a high-speed stirrer, a ball mill, a sand mill, a colloid mill, a vibration mill and a homogenizer, a method in which the photosensitive silver halide which has been prepared is added to the non-photosensitive organic silver salt at any desired timing while the non-photosensitive organic silver salt is being prepared to prepare a final non-photosensitive organic silver salt, and the like, however, the method and condition are not limited to any specific type, so long as an effect according to the present invention can sufficiently be exerted. Further, mixing two or more types of aqueous dispersions of non-photosensitive organic silver salts and two or more types of aqueous dispersions of photosensitive silver salts is an advantageous method for adjusting photographic properties.

13) Mixing of Silver Halide to Coating Solution

A preferred timing for adding the silver halide to an image-forming layer coating solution in the present invention is from 180 min to immediately before the coating, preferably, from 60 min to 10 sec before the coating, and there are no particular restrictions for the mixing method and the mixing condition so long as the sufficient effect of the present invention is obtained. Concrete mixing method includes a method of mixing in a tank adapted such that an average staying time calculated based on the addition flow rate and the liquid feed amount to a coater give a desired time, or a method of using a static mixer as described, for example, in “Liquid Mixing Technique” written by N. Harnby, M. F. Edwards, and A. W. Nienow, translated by Koji Takahashi (published from Nikkan Kogyo Shinbun Co., 1989), Chapter 8.

(Compound Substantially Decreasing the Visible Light Absorption Derived from Photosensitive Silver Halide after Heat Development)

The photothermographic material in the present invention preferably contains a compound for substantially decreasing the visible light absorption derived from the photosensitive silver halide after heat development as described below.

In the present invention, it is particularly preferred to use a silver iodide complex forming agent as a compound of substantially decreasing the visible light absorption derived from the photosensitive silver halide after heat development.

(Silver Iodide Complex Forming Agent)

At least one of the nitrogen atom or sulfur atom in the compound of the silver iodide complex forming agent can contribute to the Luis acid base reaction of donating electrons to silver ions as a coordination atom (electron doner: Luis base). Stability of the complex is defined by the sequential stability constant or total stability constant and it depends on the combination of three components, that is, silver ion, iodide ion and silver complex forming agent. As a general guide, a large stability constant can be obtained by the means such as the chelating effect by the formation of the intra-molecular chelate ring or increase in the acid base dissociation constant of the ligand.

Although an action mechanism of the silver iodide complex forming agent according to the present invention has not clearly been elucidated, it is considered that silver iodide is allowed to be solubilized by forming a stable complex comprising at least ternary components including an iodine ion and silver ion. Though being deficient in capability of solubilizing silver bromide or silver chloride, the silver iodide complex forming agent according to the present invention specifically acts on silver iodide.

Although a detail of the mechanism in which an image storability is improved by the silver iodide complex forming agent according to the present invention is not elucidated, the mechanism is considered as that at least one portion of the photosensitive silver halide and the silver iodide complex forming agent according to the present invention are allowed to react with each other at the time of thermal development to form a complex and, accordingly, photosensitivity is reduced or lost, to thereby, particularly, greatly improve the image storability under a light irradiation. At the same time, it is marked characteristics in that opacity of a film caused by the silver halide is reduced and, as a result, a clear image having a high image quality can be obtained. The opacity of the film can be confirmed by measuring reduction of ultraviolet visible absorption of spectral absorption spectrum.

According to the present invention, the ultraviolet visible absorption spectrum of the photosensitive silver halide can be measured by a transmittance method or a reflection method. When absorption caused by another compound added to the photothermographic material and absorption caused by the photosensitive silver halide are superimposed, the ultraviolet visible absorption spectrum of the photosensitive silver halide can be observed by using differential spectrum and a measure of, for example, removal of other compounds by a solvent each individually or in combination.

It is essential from the standpoint of forming a stable complex by an iodine ion that the silver iodide complex forming agent according to the present invention is clearly different from a conventional silver ion complex forming agent. There is marked characteristics in that, contrary to the conventional silver ion complex forming agent which performs a dissolution action on a salt having a silver ion such as silver bromide, silver chloride, or an organic silver salt, for example, silver behenate, the silver iodide complex forming agent according to the present invention does not perform such action unless silver iodide is present.

As the silver iodide complex forming agent according to the present invention, a 5- to 7-membered heterocyclic compound containing at least one nitrogen atom is preferable. When the compound has none of a mercapto group, a sulfide group and a thione group as a substituent, a nitrogen-containing 5- to 7-membered heterocycle may be saturated or unsaturated and, also, may have a substituent. Such substituents on the heterocycle may be combined with each other to form a ring.

Examples of such 5-to 7-membered heterocyclic compounds include pyrrole, pyridine, oxazole, isoxazole, thiazole, isothiazole, imidazole, pyrazole, pyrazine, pyrimidine, pyridazine, indole, isoindole, indolidine, quinoline, isoquinoline, benzimidazole, 1H-imidazole, quinoxaline, quinazoline, cinnoline, phthalazine, naphthyridine, purine, pteridine, carbazole, acrydine, phenanthridine, phenanthroline, phenazine, phenoxazine, phenothiazine, benzothiazole, benzoxazole, benzimidazole, 1,2,4-triazine, 1,3,5-triazine, pyrrolidine, imidazolidine, pyrazolidine, piperidine, piperazine, morpholine, indoline and isoindoline. More preferable are pyridine, imidazole, pyrazole, pyrazine, pyrimidine, pyridazine, indole, isoindole, indolidine, quinoline, isoquinoline, benzimidazole, 1H-imidazole, quinoxaline, quinazoline, cinnoline, phthalazine, 1,8-naphthyridine, 1,10-phenanthroline, benzimidazole, benzotriazole, 1,2,4-triazine, 1,3,5-triazine and the like. Particularly preferable are pyridine, imidazole, pyrazine, pyrimidine, pyridazine, phthalazine, triazine, 1,8-naphthyridine, 1,10-phenanthroline and the like.

These rings may each have a substituent. Any substituent is permissible so long as it does not give a detrimental effect on photographic properties. Preferable examples of such substituents include a halogen atom (a fluorine atom, a chlorine atom, a bromine atom, or an iodine atom), an alkyl group (inclusive of a straight-chain, branched-chain, or cyclic alkyl group inclusive of a bicycloalkyl group and an active methine group), an alkenyl group, an alkynyl group, an aryl group, a heterocyclic group (a position in which substitution is performed is not limited), an acyl group, an alkoxycarbonyl group, an aryloxycarbonyl group, a heterocycloxycarbonyl group, a carbamoyl group, an N-acylcarbamoyl group, an N-sulfonylcarbamoyl group, an N-carbamoylcarbamoyl group, an N-sulfamoylcarbamoyl group, a carbazoyl group, a carboxyl group or a salt thereof, an oxalyl group, an oxamoyl group, a cyano group, a carbonimidoyl group, a formyl group, a hydroxyl group, an alkoxy group (inclusive of a group having a recurring unit of an ethyleneoxy group or a propyleneoxy group), an aryloxy group, a heterocycloxy group, an acyloxy group, an (alkoxy or aryloxy) carbonyloxy group, a carbamoyloxy group, a sulfonyloxy group, an amino group, (an alkyl, aryl, or a heterocyclo) amino group, an acylamino group, a sulfonamide group, a ureido group, a thioureido group, an imido group, an (alkoxy or aryloxy) carbonylamino group, a sulfamoylamino group, a semicarbazide group, an ammonio group, an oxamoylamino group, an N-(alkyl or aryl) sulfonylureido group, an N-acylureido group, an N-acylsulfamoylamino group, a nitro group, a heterocyclic group having a quaternized nitrogen atom (for example, a pyridinio group, an imidazolio group, a quinolinio group, or an isoquinolinio group), an isocyano group, an imino group, an (alkyl or aryl) sulfonyl group, an (alkyl or aryl) sulfinyl group, a sulfo group or a salt thereof, a sulfamoyl group, an N-acylsulfamoyl group, an N-sulfonylsulfamoyl group or a salt thereof, a phosphino group, a phosphinyl group, a phosphinyloxy group, a phosphinylamino group, and a silyl group.

Further, the term “active methine group” as used herein is referred to mean a methine group substituted by two electron-attractive groups, the term “electron-attractive group” as used herein is referred to mean an acyl group, an alkoxycarbonyl group, an aryloxycarbonyl group, a carbamoyl group, an alkylsulfonyl group, an arylsulfonyl group, a sulfamoyl group, a trifluoromethyl group, a cyano group, a nitro group, or a carbonimidoyl group. Two electron-attractive groups may be combined with each other to form a cyclic configuration. Further, the term “salt” as used herein is referred to mean a cation of, for example, an alkaline metal, an alkaline earth metal, or a heavy metal, or an organic cation such as an ammonium ion, and a phosphonium ion. The aforementioned substituents may each further be substituted by any one of these substituents.

These heterocycles may each be condenced with any one of other cycles. Further, when the substituent is an anionic group (for example, —CO₂⁻, —SO₃⁻ and —S⁻), the nitrogen-containing heterocycle according to the present invention becomes a cation (for example, pyridinium and 1,2,4-triazolium) and, then, form an intramolecular salt.

In a case where the heterocyclic compound is pyridine, pyradine, pyrimidine, pyridazine, phthalazine, triazine, naphthylidine or phenanthroline derivative, the acid dissociation constant (pKa) of the conjugated acid for the nitrogen containing heterocyclic portion at the acid dissociation equilibrium of the compound in a mixed solution of tetrahydrofuran/water (3/2) at 25° C. is, preferably, 3 to 8 and, more preferably, pKa is 4 to 7.

As such a heterocyclic compound, pyridine, pyridazine or phthaladine derivative is preferred and pyridine or phthaladine derivative is particularly preferred.

In a case where the heterocyclic compound has a mercapto group, sulfide group or thion group as the substituent, it is preferably a pyridine, thiazole, isothiazone, oxazole, isooxazole, imidazole, pyrazole, pyradine, pyrimidine, pyridazine, triazine, triazole, thiazole, or oxadiazole derivative and, particularly preferably, thiazole, imidazole, pyrazole, pyradine, pyrimidine, pyridazine, triazine or triazole derivative.

For example, the compound represented by the following formula (21) or formula (22) can be utilized for the silver iodide complex forming agent.

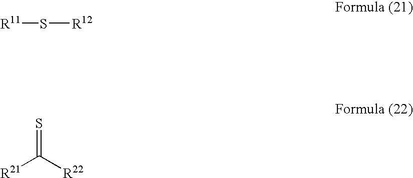

In formula (21), R¹¹ and R¹² each independently represent a hydrogen atom or a substituent. In formula (22), R²¹ and R²² each independently represent a hydrogen atom or a substituent, providing that both R¹¹ and R¹² are not hydrogen atom and both R²¹ and R²² are not hydrogen atom. The substituent referred to herein can include those described as the substituent for the nitrogen containing 5 to 7-membered heterocyclic silver iodide complex forming agents described above.

Further, the compound represented by the following formula (23) can also be used preferably.

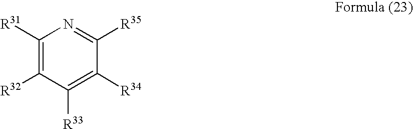

In formula (23), R³¹-R³⁵ each independently represent a hydrogen atom or a substituent. The substituent represented by the R³¹ to R³⁵ can include those described as the substituent for the nitrogen-containing 5 to 7-membered heterocyclic ring silver iodide complex forming agents described above. In a case where the compound represented by formula (23) has a substituent, a preferred substitution positions are at R³² to R³⁴. R³¹ to R³⁵ may join with each other to form a saturated or unsaturated ring. It is preferably, halogen atom, alkyl group, aryl group, carbamoyl group, hydroxy group, alkoxy group, aryloxy group, carbamoyloxy group, amino group, acylamino group, ureido group, (alkoxy or aryloxy) carbonylamino group.

For the compound represented by formula (23), the acid dissociation constant (pKa) of the conjugated acid for the pyridine ring portion in a mixed solution of tetrahydrofuran/water (3/2) at 25° C. is, preferably, 3 to 8 and particularly preferably, 4 to 7.

Further, the compound represented by formula (24) is also preferred.

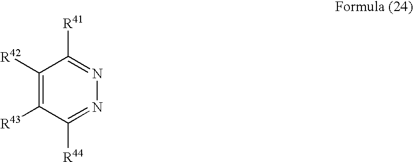

In formula (24), R⁴¹ to R⁴⁴ each independently represent a hydrogen atom or a substituent. R⁴¹ to R⁴⁴ may join with each other to form a saturated or unsaturated ring. The substituent represented by R⁴¹ to R⁴⁴ can include those described as the substituent for the nitrogen-containing 5 to 7-membered heterocyclic silver iodide complex forming agents described above. Preferred group can include an alkyl group, alkenyl group, alkinyl group, aryl group, hydroxy group, alkoxy group, aryloxy group, heterocyclicoxy group, and phthalazine ring formed by benzo ring condensation. In a case where a hydroxyl group is substituted on the carbon atom adjacent with the nitrogen atom of the compound represented by formula (24), equilibrium exists relative to pyridazinone.

The compound represented by formula (24) further preferably forms the phthalazine ring represented by the following formula (25) and, particularly preferably, the phthalazine ring may further have at least one substituent. Examples for the R⁵¹ to R⁵⁶ in formula (25) can include those described as the substituent for the nitrogen containing 5 to 7-membered heterocyclic silver iodide complex forming agents. A further preferred substituent can include an alkyl group, alkenyl group, alkinyl group, aryl group, hydroxy group, alkoxy group, and aryloxy group. Preferred are alkyl group, alkenyl group, aryl group, alkoxy group, or aryloxy group. More preferred are alkyl group, alkoxy group, and aryloxy group.

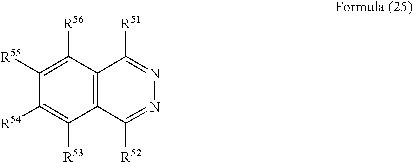

A compound represented by the following formula (26) is also a preferred form.

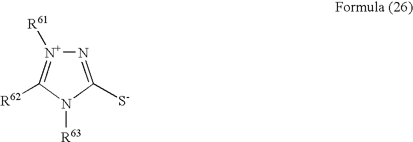

In formula (26), R⁶¹ to R⁶³ each independently represent a hydrogen atom or a substituent. Examples for the substituent represented by R⁶² can include those described as the sbustituent for the nitrogen containing 5 to 7-membered heterocyclic silver iodide complex forming agent described above.

The compound used preferably can include the compound represented by the following formula (27).
R⁷¹—S-(L)ₙ-S—R⁷² Formula (27);

In formula (27), R⁷¹ to R⁷² each independently represent a hydrogen atom or a substituent, L represents a bivalent connection group, n represents 0 or 1. The substituent represented by R⁷¹ to R⁷² can include, for example, an alkyl group (including cycloalkyl group), alkenyl group (including cycloalkenyl group), alkinyl group, aryl group, heterocyclic group, acyl group, aryloxycarbonyl group, alkoxycarbonyl group, carbamoyl group, or imide group, and composite substituent containing them. The bivalent connection group represented by L is a connection group having a length, preferably, for 1 to 6 atoms and, more preferably, 1 to 3 atoms, and it may have a further substituent.

A further example of the compound used preferably is the compound represented by formula (28).

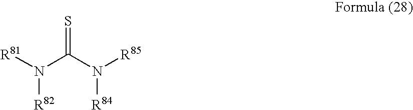

In formula (28), R⁸¹ to R⁸⁵ each independently represent a hydrogen atom or a substituent. The substituent represented by R⁸¹ to R⁸⁵ can include, for example, alkyl group (including cycloalkyl group), alkenyl group (including cycloalkenyl group), alkinyl group, aryl group, heterocyclic group, acyl group, aryloxycarbonyl group, alkoxycarbonyl group, carbamoyl group, or imide group.

Among the silver iodide complex forming agents described above, more preferred are those compounds represented by formulae (23), (24), (25), (26), and (27), and the compounds represented by formulae (23) and (25) are particularly preferred.

Preferred examples for the silver iodide complex forming agent in the present invention are to be described below but the present invention is not restricted to them.

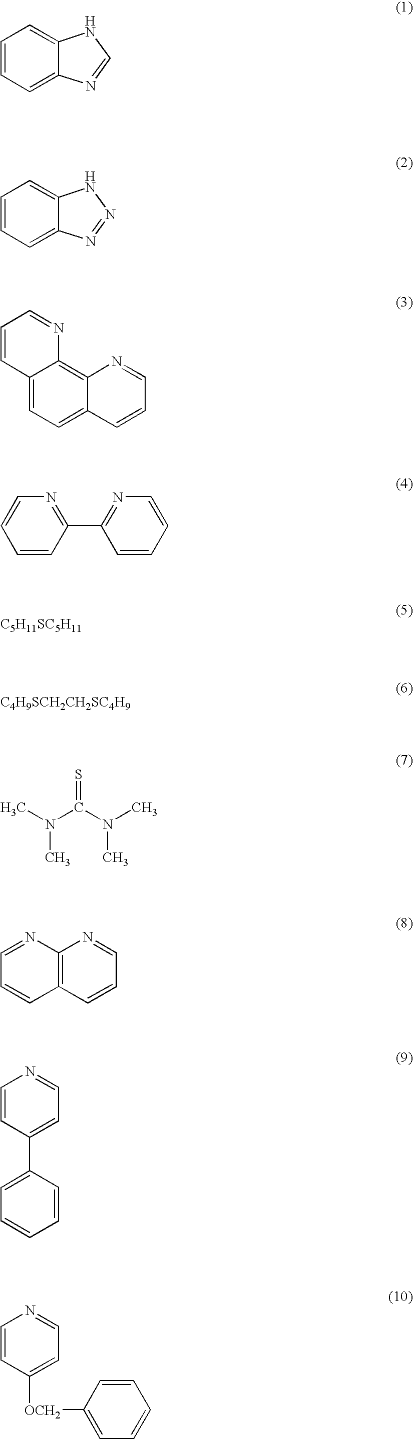

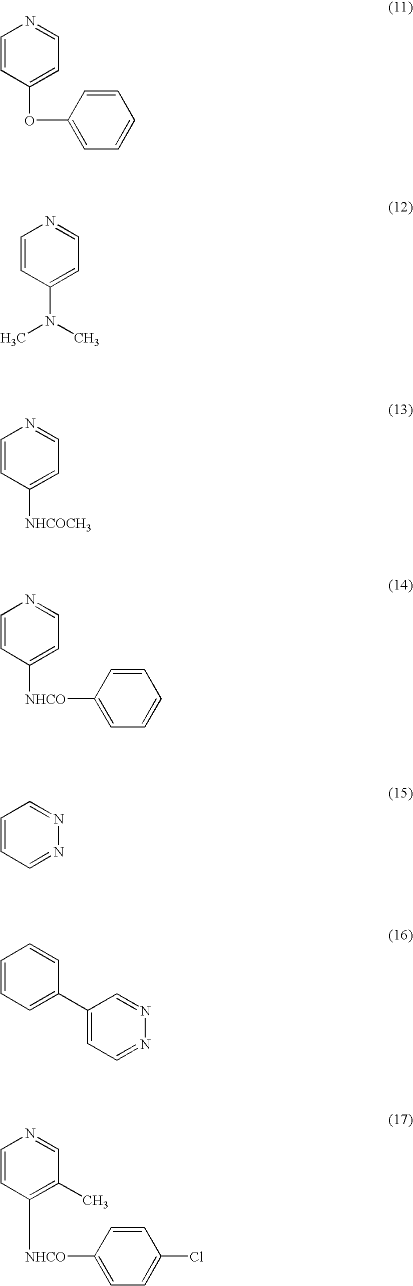

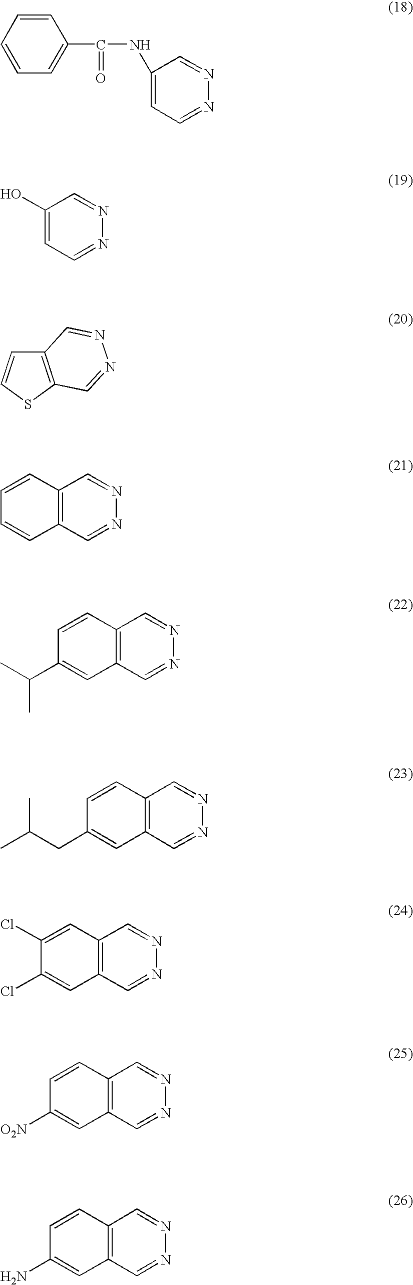

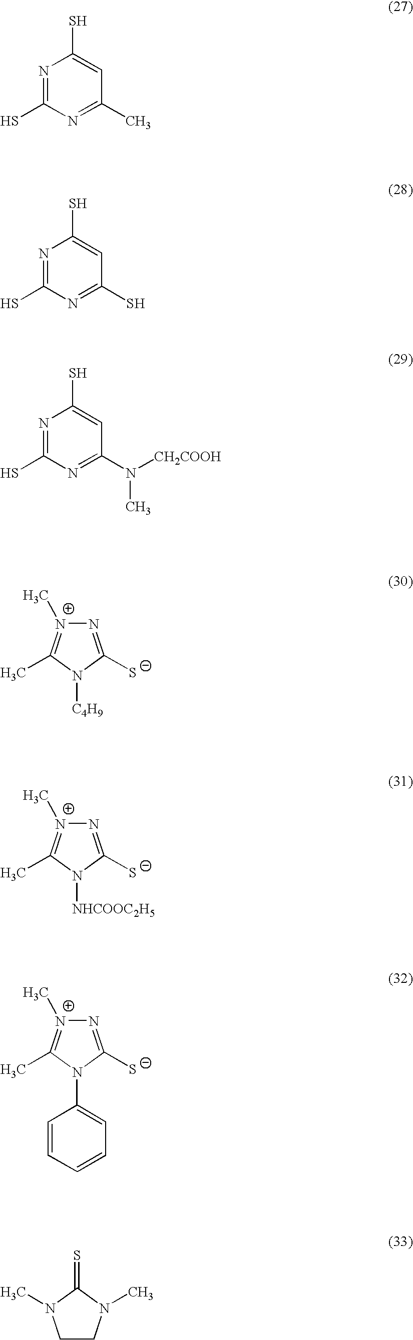

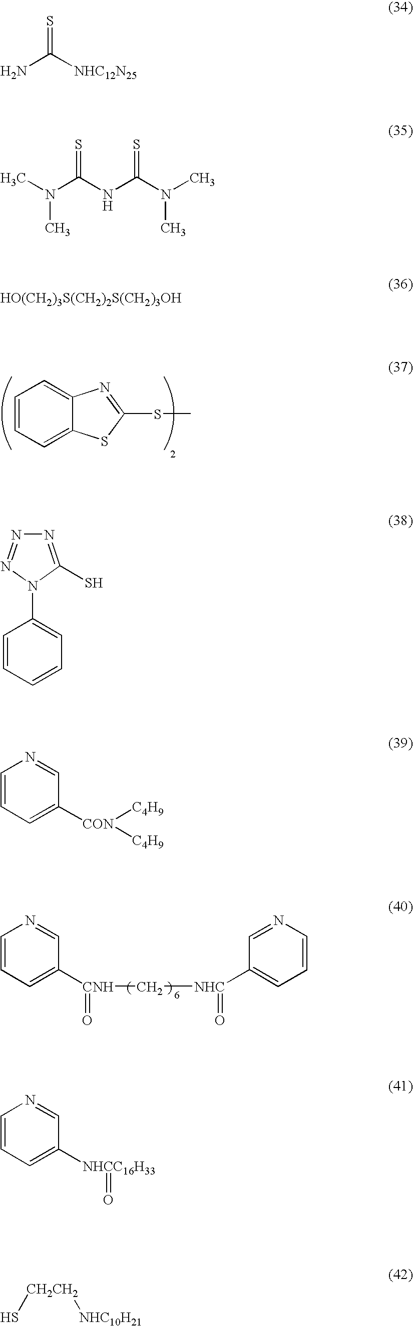

In a case where the silver iodide complex forming agent in the present invention has a function of a color toner known so far, it can also be a compound in common with the color toner. The silver iodide complex forming agent in the present invention can also be used being combined with the color toner. Further two or more kinds of silver iodide complex forming agents may be used in combination.

The silver iodide complex forming agent in the present invention is preferably present in the film in a state being separated from the photosensitive silver halide such as being present as a solid state in the film. It is also preferred to add the agent to the adjacent layer. A melting point of the silver iodide complex forming agent in the present invention is preferably controlled within an appropriate range such that it is melted when heated to a heat development temperature.

In the present invention, it is preferable that the absorption intensity of the UV visible absorption spectrum of the photosensitive silver halide after heat development is 80% or less when compared with that before the heat development. It is more preferably 40% or less and, particularly preferably, 10% or less.

The silver iodide complex forming agent in the present invention may be incorporated into the coating solution by any method such as in the form of solution, in the form of emulsified dispersion or in the form of solid fine particle dispersion and incorporated in the photosensitive material.

The well-known emulsifying dispersion method can include a method of dissolving by using an oil such as dibutyl phthalate, tricresyl phosphate, glyceryl triacetate, diethyl phthalate or an auxiliary solvent such as ethyl acetate and cyclohexanone, and preparing the emulsified dispersion mechanically.

Further, the fine solid particle dispersion method can include a method of dispersing a powder of the silver iodide complex forming agent in the present invention in an appropriate solvent such as water by a ball mill, colloid mill, vibration ball mill, sand mill, jet mill, roller mill or supersonic waves thereby preparing a solid dispersion. In this case, a protection colloid (for example, polyvinyl alcohol), a surfactant (for example, anionic surfactant such as sodium triisopropyl naphthalene sulfonate (mixture of those having different substitution positions for three isopropyl groups)) may be used. In the mills described above, beads of zirconia, etc. are generally used as the dispersion medium, and Zr or the like leaching from the beads may sometimes intrude into the dispersion. Depending on the dispersion condition, it is usually within a range of 1 ppm or more and 1000 ppm or less. When the content of Zr in the photosensitive material is 0.5 mg or less per 1 g of the silver, it causes no practical problem.

The liquid dispersion is preferably incorporated with a corrosion inhibitor (for example, sodium salt of benzoisothiazolinone).

The silver iodide complex forming agent in the present invention is preferably used as a solid dispersion.

The silver iodide complex forming agent in the present invention is preferably used within a range of 1 mol % or more and 5,000 mol % or less, more preferably, within a range of 10 mol % or more and 1000 mol % or less and, further preferably, within a range of 50 mol % or more and 300 mol % or less, based on the photosensitive silver halide.

(Description of Non-Photosensitive Organic Silver Salt)

1) Composition

The non-photosensitive organic silver salt which can be used in the present invention is relatively stable to light, and is a silver salt which functions as a silver ion supplier to form a silver image, when heated at 80° C. or more in the presence of an exposed photosensitive silver halide and a reducing agent. The non-photosensitive organic silver salt may be any type of an organic substance which can supply a silver ion that can be reduced by a reducing agent. Such non-photosensitive organic silver salts are described in, for example, paragraphs 0048 and 0049 of JP-A No. 10-62899, pp. 18 (line 24) to 19 (line 37) of EP-A No. 0803764, EP-A No. 0962812, JP-A Nos. 11-349591, 2000-7683, and 2000-72711. Silver salts of organic acids, particularly, long chain aliphatic carboxylic acids (each having from 10 to 30 carbon atoms, preferably from 15 to 28 carbon atoms) are preferable. Preferable examples of such silver salts of fatty acids include silver lignocerate, silver behenate, silver arachidate, silver stearate, silver oleate, silver laurate, silver caproate, silver myristate, silver palmitate, silver erucate and mixtures thereof. Among silver salts of fatty acids according to the present invention, it is preferable to use a silver salt of a fatty acid in which a silver behenate content is preferably in the range of 50% by mol to 100% by mol, more preferably in the range of 85% by mol to 100% by mol and, still more preferably, in the range of 90% by mol to 100% by mol.

Further, it is preferable to use the silver salt of the fatty acid in which a silver erucate content is preferably 2% by mol or less, more preferably 1% by mol or less and, still more preferably, 0.1% by mol or less.

Furthermore, a silver stearate content is preferably 1% by mol or less. By allowing the silver stearate content to be 1% by mol or less, to thereby obtain a silver salt of an organic acid in which Dmin is low, sensitivity is high and image storability is excellent. Preferably, a stearic acid content in the above case is 0.5% by mol or less and, particularly preferably, it is substantially 0% by mol.

When silver arachidate is contained as a silver salt of an organic acid, it is preferable to allow a silver arachidate content to be 6% by mol or less from the standpoint of obtaining the silver salt of the organic acid in which the Dmin is low and the image storability is excellent. On this occasion, the silver arachidate content is more preferably 3% by mol or less.

2) Shape

A shape of the non-photosensitive organic silver salt that can be used in the present invention is not particularly limited, and any one of a needle shape, a rod shape, a tabular shape, and a flaky shape is permissible. However, according to the present invention, the non-photosensitive organic silver salt in the flake-like shape is preferable. Further, a short needle shape in which a ratio of a long axis to a short axis is less than 5, a rectangular parallelepiped, a cuboidal and an amorphous grain in a potato-like shape are also favorably used. These organic silver grains have characteristics in that fogging may prevent at the time of thermal, compared with a grain in a long needle shape in which a ratio of the long axis to the short axis is 5 or more. Particularly, the grain having a ratio of the long axis to the short axis of 3 or less is preferable since it is improved in a mechanical stability of a coated film. The term “non-photosensitive organic silver salt in a flaky shape” as used herein is defined as described below. An organic silver salt is observed under an electron microscope, and a shape of an organic silver salt grain is approximated to a rectangular parallelepiped. Three sides of the rectangular parallelepiped are represented as a, b and c in which a is shortest, b is in the middle and c is longest (c and b may be same with each other). From the shorter sides a and b, x is obtained according to the following equation:
x=b/a

Values of x are obtained for about 200 grains in the same manner as described above and, then, an average value x (average) thereof is obtained. An article which satisfies the relationship of x (average)≧1.5 is defined as being in a flaky shape. Preferably, it is 30≧x (average)≧1.5 and, more preferably, it is 15≧x (average)≧1.5. In this connection, acicular grains satisfy 1≦x (average)<1.5.

In the flaky particle, a can be regarded as a thickness of a plate particle having a main plane with b and c being as the sides. An average of a is preferably in the range of 0.01 μm to 0.3 μm and, more preferably, in the range of 0.1 μm to 0.23 μm. An average of c/b is preferably in the range of 1 to 9, more preferably in the range of 1 to 6, still more preferably in the range of 1 to 4 and, most preferably, in the range of 1 to 3.

By allowing the aforementioned sphere-equivalent diameter to be from 0.05 μm to 1 μm, coagulation hardly occurs in the photosensitive material and, accordingly, the image storability becomes excellent. The sphere-equivalent diameter is preferably from 0.1 μm to 1 μm. The sphere-equivalent diameter according to the present invention can be obtained by a measuring method in which a sample is firstly direct photographed by using an electron microscope, and then the resultant negative film is subjected to image data processing. In the aforementioned grain in the flaky shape, ‘a sphere-equivalent diameter/a’ is defined as an aspect ratio of the grain. As the aspect ratio of the grain in the flaky shape, from the standpoint of allowing the coagulation to hardly occur in the photosensitive material and the image storability to be excellent, it is preferably in the range of 1.1 to 30 and, more preferably, in the range of 1.1 to 15.

A grain size distribution of the non-photosensitive organic silver salt is preferably a mono-dispersion. The term “mono-dispersion” as used herein is referred to mean that the percentage of a value obtained by dividing the standard deviation of the length of the short axis or long axis by the length of the short axis or long axis, respectively, is preferably 100% or less, more preferably 80% or less, and still more preferably 50% or less. As a method for measuring the shape of the non-photosensitive organic silver salt, it can be determined by a method utilizing a transmission electron microscope image of the non-photosensitive organic silver salt dispersion. Another method for determining the monodispesion property is a method involving obtaining the standard deviation of a volume weight average diameter of the photosensitive organic silver salt. The percentage (coefficient of variation) of the value obtained by dividing the standard deviation by the volume weight average diameter is preferably 100% or less, more preferably 80% or less and, still more preferably, 50% or less. As a measurement method, for example, laser light is irradiated on the non-photosensitive organic silver salt dispersed in the solution to allow the light to be scattered and, then, an autocorrelation function of fluctuation of the resultant scattered light based on time is obtained to measure a grain size (volume weight average diameter) and, thereafter, the mono-dispersion property can be obtained from the thus-measured grain size.

3) Preparation

A preparation method and a dispersion method of the silver salt of organic acid according to the present invention can adopt any one of known methods and the like. Methods described in, for example, JP-A No. 10-62899, EP-A Nos. 0803763, and 0962812, JP-A Nos. 11-349591, 2000-7683, and 2000-72711, 2001-163889, 2001-163890, 2001-163827, 2001-33907, 2001-188313, 2001-83652, 2002-6442, 2002-49117, 2002-31870 and 2002-107868 can be of reference.

Since, when the photosensitive silver salt is allowed to be simultaneously present at the time of dispersing the non-photosensitive organic silver salt, fogging is increased and, accordingly, sensitivity is extremely deteriorated, it is preferable that the photosensitive silver salt is not substantially contained at the time of such dispersion. According to the present invention, an amount of the photosensitive silver salt in the aqueous solution to be dispersed therein is preferably 1% by mol or less and, more preferably, 0.1% by mol or less per mol of the silver salt of the organic acid in the solution. It is still more preferable to refrain from an active addition of the photosensitive silver salt.

According to the present invention, it is possible to prepare a photosensitive material by mixing an aqueous dispersion of the non-photosensitive organic silver salt and an aqueous dispersion of the photosensitive silver salt. Although a mixing ratio between the non-photosensitive organic silver salt and the photosensitive silver salt can be determined in accordance with purposes, the ratio of the photosensitive silver salt based on the non-photosensitive organic silver salt is preferably in the range of 1% by mol to 30% by mol, more preferably in the range of 2% by mol to 20% by mol and, particularly preferably, in the range of 3% by mol to 15% by mol. When such mixing is performed, it is a method for being favorably performed for the purpose of appropriately adjusting photographic properties to mix two or more types of aqueous dispersions of the non-photosensitive organic silver salts and two or more types of aqueous dispersions of the photosensitive silver salts.

4) Addition Amount

Although the non-photosensitive organic silver salt according to the present invention can be used in a desired amount, an entire silver amount inclusive of the photosensitive silver halide to be applied is preferably in the range of 0.1 g/m² to 5.0 g/m², more preferably in the range of 0.3 g/m² to 3.0 g/m² and, still more preferably, in the range of 0.5 g/m² to 2.0 g/m². Particularly, in order to enhance the image storability, the entire silver amount to be applied is preferably 1.8 g/m² or less and, more preferably, 1.6 g/m² or less. When a preferable reducing agent according to the present invention is used, a sufficient image density can be obtained even in such a small silver amount as described above.

(Description of Antifoggant)

As antifoggants, stabilizers and stabilizer precursors according to the present invention, those disclosed as patents as described in paragraph 0070 of JP-A No. 10-62899, pp. 20 (line 57) to 21 (line 7) of EP-A No. 0803764, and compounds described in JP-A Nos. 9-281637 and 9-329864, U.S. Pat. No. 6,083,681 and EP-A No. 1048975 are mentioned.

(1) Description of Polyhalogen Compound

Hereinafter, preferable organic polyhalogen compounds capable of being used in the present invention are specifically described. The preferable polyhalogen compounds according to the present invention are such compounds as represented by the following general formula (H):
Q-(Y)n-C(Z₁)(Z₂)X Formula (H);

wherein, Q represents an alkyl group, an aryl group or a heterocyclic group, Y represents a divalent linking group, n represents 0 or 1, Z₁ and Z₂ each independently represent a halogen atom; and X represnts a hydrogen atom or an electron-attractive group.

In formula (H), Q preferably represents an alkyl group having from 1 to 6 carbon atoms, an aryl group having from 6 to 12 carbon atoms or a heterocyclic group containing at least one nitrogen atom (for example, pyridine or quinoline).

In formula (H), when Q represents an aryl group, Q preferably represents a phenyl group substituted by an electron-attractive group in which the Hammet's substituent constant σp has a positive value. Regarding the Hammet's substituent constant, Journal of Medicinal Chemistry, Vol. 16, No. 11, pp. 1207-1216 (1973) can be referred. Examples of such electron-attractive groups include a halogen atom, an alkyl group substituted by an electron-attractive group, an aryl group substituted by an electron-attractive group, a heterocyclic group, an alkyl or aryl sulfonyl group, an acyl group, an alkoxycarbonyl group, a carbamoyl group and a sulfamoyl group. Among these groups, a halogen atom, a carbamoyl group and an aryl sulfonyl group are more preferable as an electron-attractive group and a carbamoyl group is particularly preferable.

X represents preferably an electron-attractive group. Examples of preferable electron-attractive groups include a halogen atom, an aliphatic, aryl or a heterocyclic sulfonyl group, an aliphatic, aryl or a heterocyclic acyl group, an aliphatic, aryl or a heterocyclic oxycarbonyl group, a carbamoyl group and a sulfamoyl group. Among these groups, a halogen atom and a carbamoyl group are more preferable and a bromine atom is particularly preferable.

Z₁ and Z₂ each individually represent preferably a bromine atom or an iodine atom and, more preferably, a bromine atom.

Y represents preferably —C(═O)—, —SO—, —SO₂—, —C(═O)N(R)— or —SO₂N(R)—, more preferably —C(═O)—, —SO₂— or —C(═O)N(R)— and, particularly preferably, —SO₂— or —C(═O)N(R)—, wherein R represents preferably a hydrogen atom, an aryl group or an alkyl group, more preferably a hydrogen atom or an alkyl group and, particularly preferably a hydrogen atom.

n represents 0 or 1 and, preferably, 1.

In formula (H), when Q is an alkyl group, a preferable Y is —C(═O)N(R)—, while, when Q is an aryl group or a heterocyclic group, the preferable Y is —SO₂—.

In formula (H), a configuration (generally referred to as a bis type, a tris type or a tetrakis type) formed by linking residues, in each of which a hydrogen atom is removed from the compound, with each other can also be favorably used.

In formula (H), a configuration having a dissociative group (for example, a —COOH group or a salt thereof, a —SO₃H group or a salt thereof, or —PO₃H group or a salt thereof), a group containing a quaternary nitrogen cation (for example, an ammonium group or a pyridinium group), a polyethyleneoxy group, a hydroxyl group or the like as a substituent is also preferable.

Specific examples of compounds represented by formula (H) according to the present invention are described below.

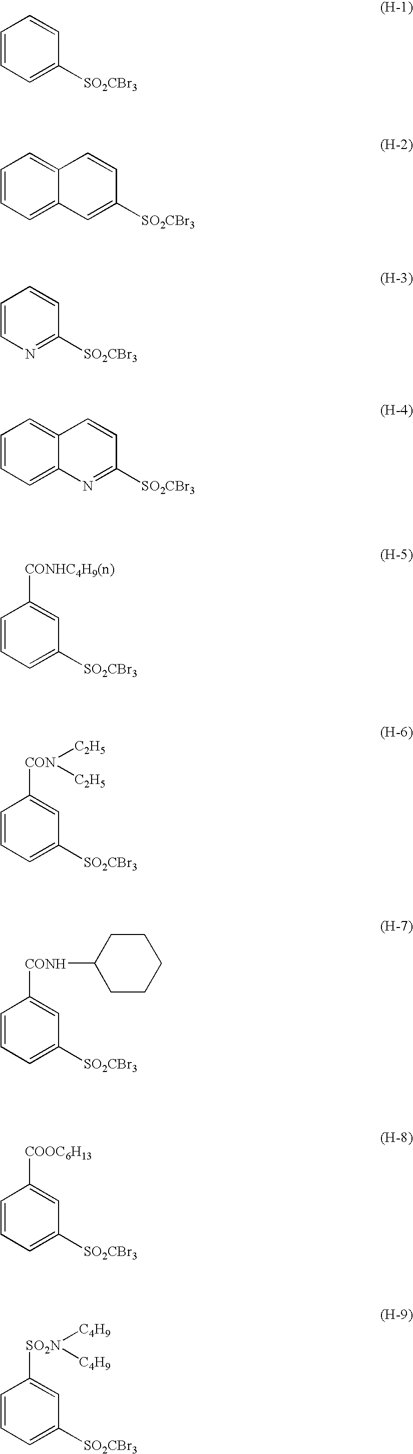

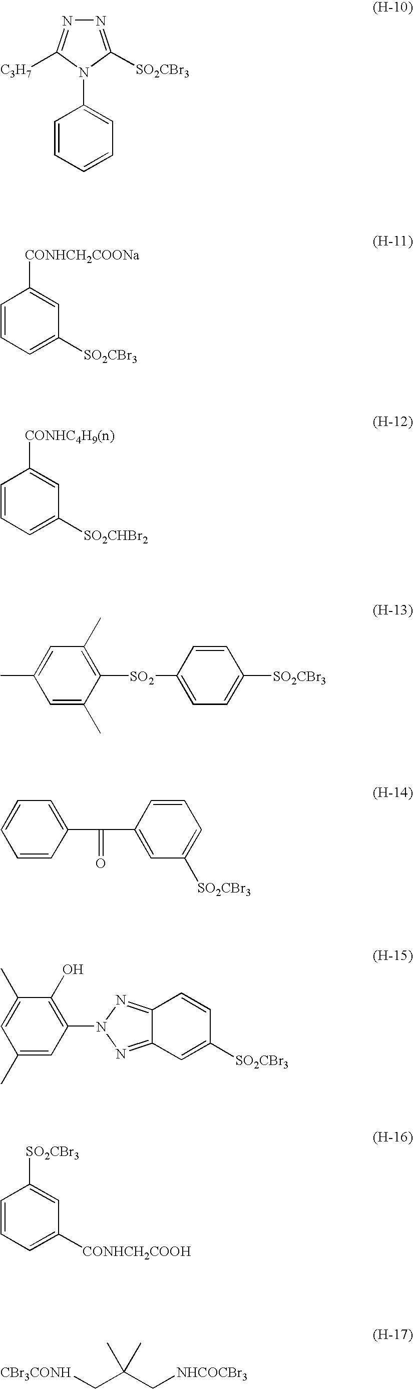

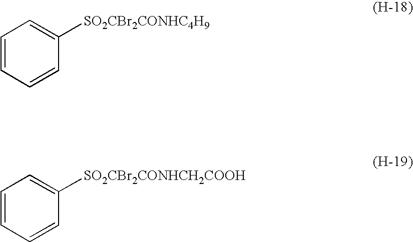

As other polyhalogen compounds capable of being used in the present invention than those described above, favorably used are compounds described as illustrative ones in the following patents and disclosures of patent applications: U.S. Pat. Nos. 3,874,946, 4,756,999, 5,340,712, 5,369,000, 5,464,737 and 6,506,548; and JP-A Nos. 50-137126, 50-89020, 50-119624, 59-57234, 7-2781, 7-5621, 9-160164, 9-244177, 9-244178, 9-160167, 9-319022, 9-258367, 9-265150, 9-319022, 10-197988, 10-197989, 11-242304, 2000-2963, 2000-112070, 2000-284410, 2000-284412, 2001-33911, 2001-31644, 2001-312027 and 2003-50441. Particularly, compounds specifically illustrated in JP-A Nos. 7-2781, 2001-33911 and 2001-312027 are preferable. The compound represented by formula (H) according to the present invention is used, based on 1 mol of non-photosensitive silver salt in the image forming layer, preferably in the range of 1×10⁻⁴ mol to 1 mol, more preferably in the range of 1×10⁻³ mol to 0.5 mol and, still more preferably, in the range of 1×10⁻² mol to 0.2 mol.

According to the present invention, for a method which allows antifoggant to be contained in the photosensitive material, the method for containing the aforementioned reducing agent is mentioned and the organic polyhalogen compound is also preferably added in the state of a solid fine grain dispersion.

(Other Antifoggants)

As other antifoggants, a mercury (II) salt as described in paragraph 0113 of JP-A No. 11-65021, benzoic acids as described in paragraph 0114 of JP-A No. 11-65021, a salicylic acid derivative as described in JP-A No. 2000-206642, a formalin scavenger compound represented by the formula (S) in JP-A No. 2000-221634, a triazine compound related to Claim 9 of JP-A No. 11-352624, compounds represented by formula (III) of JP-A No. 11-11791, 4-hydoxy-6-methyl-1,3,3a,7-tetrazaindene and the like are mentioned.

The photothermographic material according to the present invention may contain an azolium salt for the purpose of inhibiting fogging. As such azolium salts, compounds represented by formula (XI) as described in JP-A No. 59-193447, compounds as described in Japanese Patent Publication No. 55-12581, and compounds represented by formula (II) as described in JP-A No. 60-153039 can be cited. Timing of adding the azolium salt may be in any step for preparing a coating solution. When the azolium salt is added to the image forming layer, the azolium salt may be added in any step of from preparation of the organic silver salt to preparation of a coating solution, however, the azolium salt is preferably added during a period of from after the preparation of the organic silver salt to immediately before the coating. As methods for adding the azolium salt, any addition method, such as that in a powder state, a solution state or a fine grain dispersion state thereof, may be adopted. The azolium salt may also be added in a state of solution mixed with other additives such as a sensitizing dye, a reducing agent and a color toner. According to the present invention, an amount of the azolium salt to be added may be optional, however, it is, based on 1 mol of silver, preferably in the range of 1×10⁻⁶ mol to 2 mol and, more preferably, in the range of 1×10⁻³ mol to 0.5 mol.

The antifoggant may be added in any portion of the photosensitive material, however, as far as a layer to be added with the antifoggant is concerned, the antifoggant is preferably added to a layer on a face having the image forming layer and, more preferably, added to the image forming layer itself.

(Description of Reducing Agent)

The photothermographic material according to the present invention preferably comprises a reducing agent for a non-photosensitive organic silver salt. The reducing agent for the non-photosensitive organic silver salt may be any substance (preferably organic substance) which can reduce a silver ion to metallic silver. Examples of such reducing agents include those as described in paragraphs 0043 to 0045 of JP-A No. 11-65021, and in pp. 7 (line 34) to 18 (line 12) of EP-A No. 0803764.

A preferable reducing agent according to the present invention is a so-called hindered phenolic reducing agent or bisphenolic reducing agent having a substituent in an ortho position of a phenolic hydroxyl group. Particularly, favorable are compounds represented by the following general formula (R):

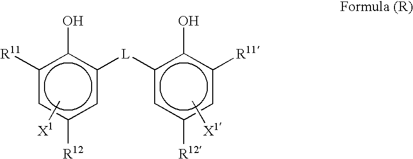

wherein R¹¹ and R^{11′} each independently represent an alkyl group having from 1 to 20 carbon atoms, R¹² and R^{12′} each independently represent a hydrogen atom or a substituent which can be substituted to a benzene ring, L represents an —S— group or a —CHR¹³— group, wherein R¹³ represents a hydrogen atom or an alkyl group having from 1 to 20 carbon atoms, and X¹ and X^{1′} each independently represent a hydrogen atom or a group which can be substituted to a benzene ring.

Formula (R) will be described in detail.

Unless stated otherwise, an alkyl group includes a cycloalkyl group.

1) R¹¹ and R^{11′}

R¹¹ and R^{11′} each independently represent an alkyl group, which is substituted or non-substituted, having from 1 to 20 carbon atoms. A substituent of the alkyl group is not particularly limited and preferable examples of such substituents include an aryl group, a hydroxyl group, an alkoxy group, an aryloxy group, an alkylthio group, an arylthio group, an acylamino group, a sulfonamide group, a sulfonyl group, a phosphoryl group, an acyl group, a carbamoyl group, an ester group, a ureido group, a urethane group and a halogen atom.

2) R¹² and R^{12′}, and X¹ and X^{1′}

R¹² and R^{12′} each independently represent a hydrogen atom or a group which can be substituted to a benzene ring.

X¹ and X^{1′} also each independently represent a hydrogen atom or a group which can be substituted to a benzene ring.

Preferable examples of such groups which can each be substituted to a benzene ring include an alkyl group, an aryl group, a halogen atom, an alkoxy group and an acylamino group.

3) L

L represents an —S— group or a —CHR¹³— group, wherein R¹³ represents a hydrogen atom or an alkyl group having from 1 to 20 carbon atoms, in which the alkyl group may have a substituent.

Specific examples of such non-substituted alkyl groups represented by R¹³ include methyl group, ethyl group, propyl group, butyl group, heptyl group, undecyl group, isopropyl group, 1-ethylpentyl group, 2,4,4-trimethylpentyl group, cyclohexyl group and 2,4-dimethyl-3-cyclohexenyl group.

Examples of substituents of the alkyl groups, being same as those of R¹¹, include a halogen atom, an alkoxy group, an alkylthio group, an aryloxy group, an arylthio group, an acylamino group, a sulfonamide group, a sulfonyl group, a phosphoryl group, an oxycarbonyl group, a carbamoyl group, and a sulfamoyl group.

4) Preferable Substituent

R¹¹ and R^{11′} are each independently preferably a primary, secondary or tertiary alkyl group having from 1 to 15 carbon atoms; specific examples of such alkyl groups include methyl group, isopropyl group, t-butyl group, t-amyl group, t-octyl group, cyclohexyl group, cyclopentyl group, 1-methylcyclohexyl group and 1-methylcyclopropyl group. R¹¹ and R^{11′} are more preferably alkyl groups each having from 1 to 4 carbon atoms and, thereamong, methyl group, t-butyl group, t-amyl group and 1-methylcyclohexyl group are still more preferable and methyl group and t-butyl group are most preferable.

R¹² and R^{12′} are each independently preferably an alkyl group having from 1 to 20 carbon atoms; and specific examples of such alkyl groups include methyl group, ethyl group, propyl group, butyl group, isopropyl group, t-butyl group, t-amyl group, cyclohexyl group, 1-methylcyclohexyl group, benzyl group, methoxymethyl group, and methoxyethyl group and, more preferably, methyl group, ethyl group, propyl group, isopropyl group and t-butyl group and, particularly preferably, methyl group and ethyl group. X¹ and X^{1′} are each independently preferably hydrogen atom, a halogen atom or an alkyl group and, more preferably, hydrogen atom.

L is preferably a —CHR¹³— group.

R¹³ is preferably a hydrogen atom or an alkyl group having from 1 to 15 carbon atoms and, for the alkyl group, besides a chained alkyl group, a cyclic alkyl group is also favorably used. Further, an alkyl group having a C═C bond is also favorably used. Preferable examples of such alkyl groups include methyl group, ethyl group, propyl group, isopropyl group, 2,4,4-trimethylpentyl group, cyclohexyl group, 2,4-dimethyl-3-cyclohexenyl group and 3,5-dimethyl-3-cyclohexenyl group. Particularly preferable examples of R¹³ include hydrogen atom, methyl group, ethyl group, propyl group, isopropyl group and 2,4-dimethhyl-3-cyclohexenyl group.

When R¹¹ and R^{11′} are each independently a tertiary alkyl group and R¹² and R^{12′} are each independently methyl group, R¹³ is preferably a primary or secondary alkyl group having from 1 to 8 carbon atoms (for example, methyl group, ethyl group, propyl group, isopropyl group or 2,4-dimethyl-3-cyclohexenyl group).

When R¹¹ and R^{11′} are each independently a tertiary alkyl group and R¹² and R^{12′} are each independently an alkyl group except methyl group, R¹³ is preferably hydrogen atom.

When R¹¹, R^{11′} are each independently not a tertiary alkyl group, R¹³ is preferably hydrogen atom or a secondary alkyl group and, more preferably, a secondary alkyl group. Examples of preferable groups as secondary alkyl groups represented by R¹³ include isopropyl group and 2,4-dimethyl-3-cyclohexenyl group.

Thermal development properties, developed silver color tones or the like of these reducing agents are changeable in accordance with combinations of R¹¹, R^{11′}, R¹², R^{12′}, and R¹³. Since these characteristics can be adjusted by combining at least two types of reducing agents, it is preferable, depending on applications, to use the reducing agents in combinations of at least two types thereof.

Specific examples of reducing agents according to the present invention, as well as compounds represented by formula (R) according to the present invention are described below; however, the present invention is by no means limited thereto.

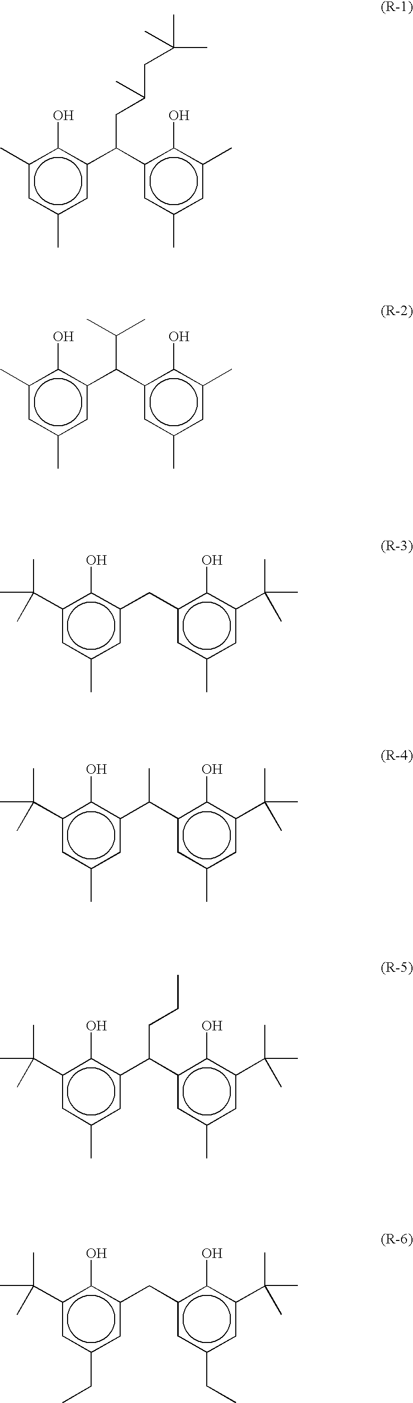

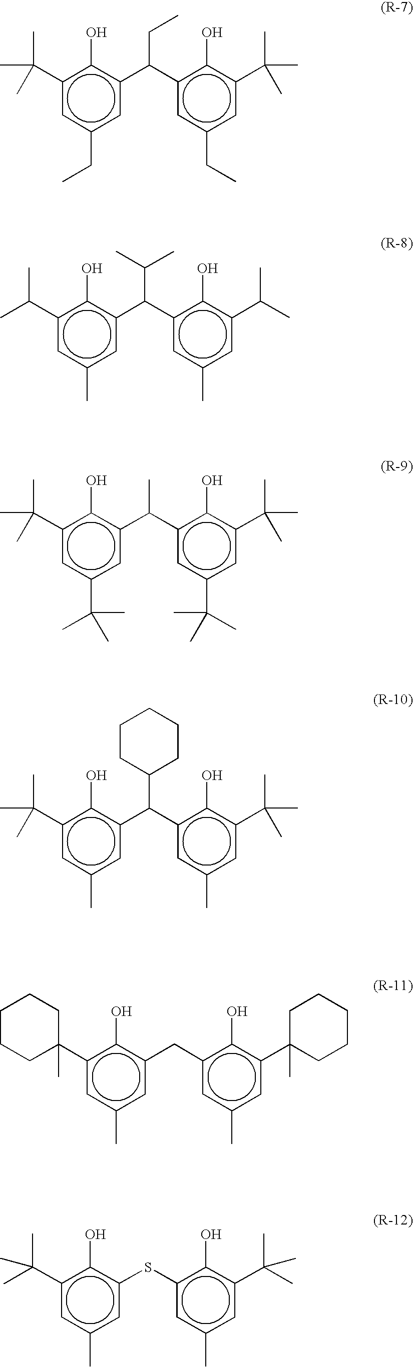

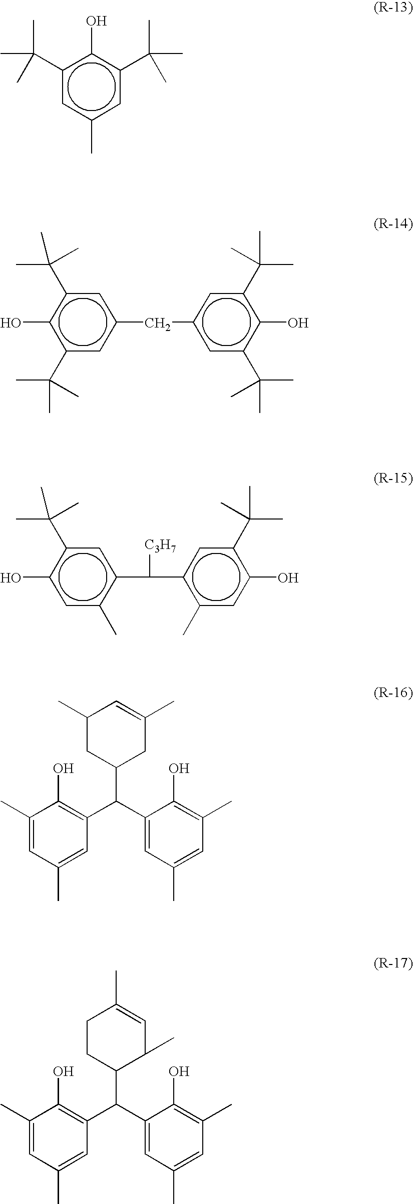

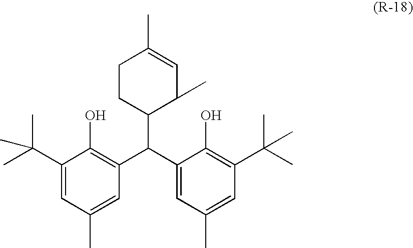

Besides aforementioned compounds, examples of preferable reducing agents according to the present invention include compounds as described in JP-A Nos. 2001 -188314, 2001-209145, 2001-350235 and 2002-156727; and EP-A No. 1278101.

An amount of the reducing agent to be added according to the present invention is preferably in the range of 0.1 g/m² to 3.0 g/m², more preferably in the range of 0.2 g/m² to 2.0 g/m² and, still more preferably, in the range of 0.3 g/m² to 1.0 g/m² as an entire sensitive material. When being based on 1 mol of silver on a face having an image forming layer, it is preferably in the range of 5% by mol to 50% by mol, more preferably in the range of 8% by mol to 30% by mol and, still more preferably, in the range of 10% by mol to 20% by mol.

The reducing agent may be contained in the coating solution in any form of solution form, emulsify-dispersion form, solid fine grain dispersion form and the like and, then, the resultant coating solution may be contained in the photosensitive material. As well known emulsify-dispersion methods, there is a method in which the reducing agent is dissolved by using an auxiliary solvent such as dibutyl phthalate, tricresyl phosphate, an oil such as dioctyl sebacate or tri(2-ethylhexyl)phosphate, ethyl acetate or cyclohexanone and, then, added with a surface active agent such as sodium dodecylbenzene sulfonate, sodium oleoyl-N-methyl taurinate or sodium di(2-ethylhexyl)sulfosuccinate and, thereafter, the resultant solution is mechanically treated to prepare an emulsify-dispersion. On this occasion, for the purpose of adjusting viscosity or refractive index of an oil droplet, a polymer such as α-methyl styrene oligomer or poly(t-butyl acrylamide) is also preferably added.

Further, as solid fine grain dispersion methods, there is a method in which powder of the reducing agent is dispersed in an appropriate solvent such as water by using a ball mill, a colloid mill, a vibration ball mill, a sand mill, a jet mill, a roller mill or an ultrasonic wave to prepare a solid dispersion. On this occasion, any one of a protective colloid (for example, polyvinyl alcohol), and a surface active agent (for example, an anionic surface active agent such as sodium triisopropyl naphthalene sulfonate that is a mixture of different types of such sulfonates in which substitution positions of three isopropyl groups are different from one another) may be used. In the aforementioned mills, beads made of, for example, zirconium are ordinarily used as dispersion media and, then, Zr or the like eluted from the beads is sometimes mixed in the dispersion. Although depending on dispersing conditions, an amount of Zr in the dispersion is ordinarily in the range of 1 ppm to 1000 ppm. There is no practical problem so long as the amount of Zr in the sensitive material is 0.5 mg or less per g of silver. It is preferable that an antiseptic agent (for example, a sodium salt of benzisothiazolinone) is allowed to be contained in an aqueous dispersion.

A particularly favorable method is the solid fine grain dispersion method of the reducing agent. The reducing agent is added as fine grains having an average grain size in the range of 0.01 μm to 10 μm, preferably in the range of 0.05 μm to 5 μm and, more preferably, in the range of 0.1 μm to 2 μm. According to the present invention, it is preferable that any one of other solid dispersions is dispersed in the aforementioned ranges of grain sizes and, then, used.

The reducing agent may be added to any portion of the photosensitive material, and a layer to which the reducing agent is added is preferably a layer on a side having an image forming layer, more preferably the image forming layer or a layer adjacent to the image forming layer and, still more preferably, the image forming layer.

(Description of Development Accelerator)

In the photothermographic material according to the present invention, a development accelerator is preferably added. Such development accelerators can include, for example, sulfonamide phenolic compounds as described in JP-A No. 2000-267222 and represented by formula (A) as described in JP-A No. 2000-330234, hindered phenolic compounds represented by formula (II) as described in JP-A No. 2001-92075, hydrazine-type compounds as described in JP-A No. 10-62895, and represented by formula (I) as described in JP-A No. 11-15116, formula (D) as described in JP-A No. 2002-156727, or formula (1) as described in JP-A No. 2002-278017, and phenolic or naphthol-type compounds represented by formula (2) as described in JP-A No. 2001-264929 are favorably used. Further, phenolic compounds as described in JP-A Nos. 2002-311533 and 2002-341484 are preferable and, also, naphthol-type compounds as described in JP-A No. 2003-66558 is preferable.

The development accelerator according to the present invention is used, based on the reducing agent, in the range of 0.1% by mol to 20% by mol, preferably in the range of 0.5% by mol to 10% by mol and, more preferably, in the range of 1% by mol to 5% by mol.

A method for introducing the development accelerator to the sensitive material may be performed in the same manner as in the reducing agent and, particularly, it is preferably incorporated after being changed into a solid dispersion or an emulsify-dispersion. When the development accelerator is added as the emulsify-dispersion, it is preferable to add the development accelerator in a form of the emulsify-dispersion which has been prepared by emulsifying the development accelerator by simultaneously using a high boiling point solvent that is solid at room temperature and a low boiling point auxiliary solvent or in a form of a so-called oil-less emulsify-dispersion in which a high boiling point solvent is not used.

Among the aforementioned development accelerators according to the present invention, the hydrazine-type compounds as described in JP-A Nos. 2002-156727 and 2002-278017 and the naphthol-type compounds as described in JP-A No. 2003-66558 are more preferable.

The development accelerator may be added to any portion of the photosensitive material, and a layer to which the development accelerator is added is preferably a layer on a face having an image forming layer, more preferably the image forming layer or a layer adjacent to the image forming layer and, still more preferably, the image forming layer.

Particularly preferred development accelerators in the present invention are compounds represented by the following formulae (A-1) and (A-2).
Q₁-NHNH-Q₂ Formula (A-1);

wherein, Q₁ represents an aromatic group or heterocyclic group bonded at a carbon atom to —NHNH-Q₂, and Q₂ represents a carbamoyl group, acyl group, alkoxycarbonyl group, aryloxycarbonyl group, sulfonyl group, or sulfamoyl group.

In formula (A-1), the aromatic group or heterocyclic group represented by Q₁ is, preferably, a 5 to 7 membered unsaturated ring. Preferred examples are benzene ring, pyridine ring, pyrazine ring, pyrimidine ring, pyridazine ring, 1,2,4-triazine ring, 1,3,5-triazine ring, pyrrole ring, imidazole ring, pyrazole ring, 1,2,3-triazole ring, 1,2,4-triazole ring, tetrazole ring, 1,3,4-thiadiazole ring, 1,2,4-thiadiazole ring, 1,2,5-thiadiazole ring, 1,3,4-oxadiazole ring, 1,2,4-oxadiazole ring, 1,2,5-oxadiazole ring, thiazole ring, oxazole ring, isothiazole ring, isooxazole ring, or thiophene ring, and a condensed ring in which the rings described above are condensed to each other is also preferred.

The rings described above may have substituents and in a case where they have two or more substituents, the substituents may be identical or different with each other. Examples of the substituent can include halogen atoms, alkyl groups, aryl groups, carbonamide groups, alkylsulfonamide groups, arylsulfonamide groups, alkoxy groups, aryloxy groups, alkylthio groups, arylthio groups, carbamoyl groups, sulfamoyl groups, cyano groups, alkylsulfonyl groups, arylsulfonyl groups, alkoxycarbonyl groups, aryloxycarbonyl groups or acyl groups. In a case where the substituents are groups capable of substitution, they may have further substituents and examples of preferred substituents can include halogen atoms, alkyl groups, aryl groups, carbonamide groups, alkylsulfonamide groups, arylsulfonamide groups, alkoxy groups, aryloxy groups, alkylthio groups, arylthio groups, acyl groups, alkoxycarbonyl groups, aryloxycarbonyl groups, carbamoyl groups, cyano groups, sulfamoyl groups, alkylsulfonyl groups, arylsulfonyl groups, and acyloxy groups.

The carbamoyl group represented by Q₂ is a carbamoyl group of, preferably, 1 to 50 carbon atoms and, more preferably, 6 to 40 carbon atoms and can include, for example, not-substituted carbamoyl, methyl carbamoyl, N-ethylcarbamoyl, N-propylcarbamoyl, N-sec-butylcarbamoyl, N-octylcarbamoyl, N-cyclohexylcarbamoyl, N-tert-butylcarbamoyl, N-dodecylcarbamoyl, N-(3-dodecyloxypropyl)carbamoyl, N-octadecylcarbamoyl, N-{3-(2,4-tert-pentylphenoxy)propyl} carbamoyl, N-(2-hexyldecyl)carbamoyl, N-phenylcarbamoyl, N-(4-dodecyloxyphenyl)carbamoyl, N-(2-chloro-5-dodecyloxycarbonylphenyl)carbamoyl, N-naphthylcarbamoyl, N-3-pyridylcarbamoyl or N-benzylcarbamoyl.

The acyl group represented by Q₂ is an acyl group of, preferably, 1 to 50 carbon atoms and, more preferably, 6 to 40 carbon atoms and can include, for example, formyl, acetyl, 2-methylpropanoyl, cyclohexylcarbonyl, octanoyl, 2-hexyldecanoyl, dodecanoyl, chloroacetyl, trifluoroacetyl, benzoyl, 4-dodecyloxybenzoyl, or 2-hydroxymethylbenzoyl. The alkoxycarbonyl group represented by Q₂ is an alkoxycarbonyl group of, preferably, 2 to 50 carbon atom and, more preferably, 6 to 40 carbon atoms and can include, for example, methoxycarbonyl, ethoxycarbonyl, isobutyloxycarbonyl, cyclehexyloxycarbonyl, dodecyloxycarbonyl or benzyloxycarbonyl.

The aryloxy carbonyl group represented by Q₂ is an aryloxycarbonyl group of, preferably, 7 to 50 carbon atoms and, more preferably, 7 to 40 carbon atoms and can include, for example, a phenoxycarbonyl, 4-octyloxyphenoxycarbonyl, 2-hydroxymethylphenoxycarbonyl, or 4-dodecyloxyphenoxycarbonyl. The sulfonyl group represented by Q₂ is a sulfonyl group of, preferably, 1 to 50 carbon atoms and, more preferably, 6 to 40 carbon atoms and can include, for example, methylsulfonyl, butylsulfonyl, octylsulfonyl, 2-hexadecylsulfonyl, 3-dodecyloxypropylsulfonyl, 2-octyloxy-5-tert-octylphenyl sulfonyl, or 4-dodecyloxyphenyl sulfonyl.

The sulfamoyl group represented by Q₂ is a sulfamoyl group of, preferably, 0 to 50 carbon atoms, more preferably, 6 to 40 carbon atoms and can include, for example, a not-substituted sulfamoyl, N-ethylsulfamoyl group, N-(2-ethylhexyl)sulfamoyl, N-decylsulfamoyl, N-hexadecylsulfamoyl, N-{3-(2-ethylhexyloxy)propyl}sulfamoyl, N-(2-chloro-5-dodecyloxycarbonylphenyl)sulfamoyl, or N-(2-tetradecyloxyphenyl)sulfamoyl. The group represented by Q₂ may further have a group mentioned as the example of the substituent for the 5 to 7-membered unsaturated ring represented by Q₁ at the position capable of substitution. In a case where the group has two or more substituents, such substituents may be identical or different with each other.

Then, a preferred range for the compound represented by formula (A-1) is to be described. A 5 to 6-membered unsaturated ring is preferred for Q₁, and benzene ring, pyrimidine ring, 1,2,3-triazole ring, 1,2,4-triazole ring, tetrazole ring, 1,3,4-thiadiazole ring, 1,2,4-thiadiazole ring, 1,3,4-oxadiazole ring, 1,2,4-oxadiazole ring, thioazole ring, oxazole ring, isothiazole ring, isooxazole ring, and a ring in which the rings described above are condensed each with a benzene ring or unsaturated hetero-ring is further preferred. Further, Q₂ preferably represents a carbamoyl group and a carbamoyl group having a hydrogen atom on the nitrogen atom is particularly preferred.

Next, the compound represented by formula (A-2) is to be described.

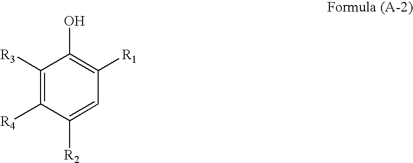

In formula (A-2), R₁ represents alkyl groups, acyl groups, acylamino groups, sulfonamide groups, alkoxycarbonyl groups, or carbamoyl groups. R₂ represents hydrogen atom, halogen atoms, alkyl groups, alkoxy groups, aryloxy groups, alkylthio groups, arylthio groups, acyloxy groups, or carbonate ester groups. R₃ and R₄ each independently represent a group capable of substitution on the benzene ring which has been mentioned as the example of the substituent for formula (A-1). R₃ and R₄ may join to each other to form a condensed ring.

R₁ represents, preferably, an alkyl group of 1 to 20 carbon atoms (for example, methyl group, ethyl group, isopropyl group, butyl group, tert-octyl group, or cyclohexyl group), acylamino group (for example, acetylamino group, benzoylamino group, methylureido group, or 4-cyanophenylureido group), carbamoyl group (for example, n-butylcarbamoyl group, N,N-diethylcarbamoyl group, phenylcarbamoyl group, 2-chlorophenylcarbamoyl group, or 2,4-dichlorophenylcarbamoyl group), with acylamino group (including ureido group or urethane group) being more preferred.

R₂ represents, preferably, a halogen atom (more preferably, chlorine atom, or bromine atom), alkoxy group (for example, methoxy group, butoxy group, n-hexyloxy group, n-decyloxy group, cyclohexyloxy group, or benzyloxy group), and aryloxy group (phenoxy group or naphthoxy group).

R₃ represents, preferably, hydrogen atom, a halogen atom or an alkyl group of 1 to 20 carbon atoms, a halogen atom being most preferred. R₄ represents, preferably, hydrogen atom, an alkyl group or an acylamino group, with an alkyl group or an acylamino group being more preferred. Examples of the preferred substituent thereof are identical with those for R₁. In a case where R₄ is an acylamino group, R₄ may preferably be joined with R₃ to form a carbostyryl ring.

In a case where R₃ and R₄ in formula (A-2) combine each other to form a condensed ring, a naphthalene ring is particularly preferred as the condensed ring. The same substituent as the example of the substituent referred to for formula (A-1) may join to the naphthalene ring. In a case where formula (A-2) is a naphtholic compound, R₁ represents, preferably, a carbamoyl group. Among them, benzoyl group is particularly preferred. R₂ represents, preferably, an alkoxy group or an aryloxy group and, particularly preferably, an alkoxy group.

Preferred specific examples for the development accelerator of the present invention are to be described below. The present invention is not restricted to them.

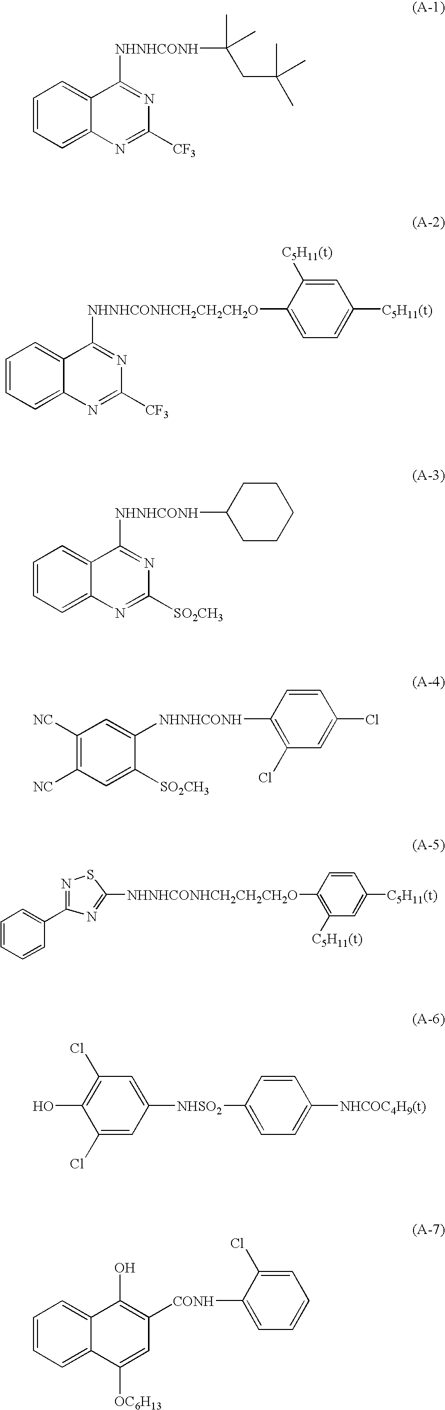

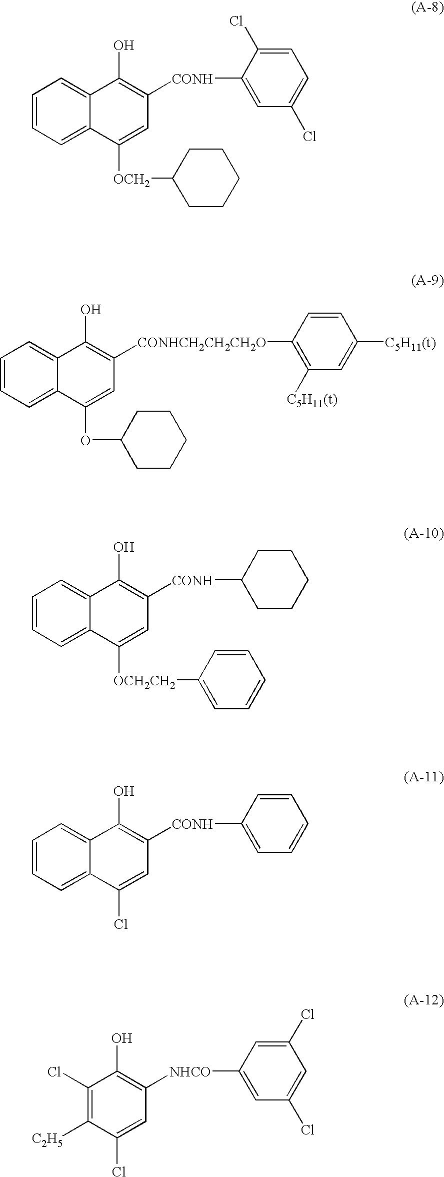

(Description of Hydrogen Bonding Compound)

When the reducing agent according to the present invention has an aromatic hydroxyl group (—OH) or amino group (—NHR, in which R represents a hydrogen atom or an alkyl group), particularly in the case of the aforementioned bisphenols, it is possible that a non-reducible compound having a group capable of forming a hydrogen bond with any one of these groups can simultaneously be used.

Examples of groups each being capable of forming a hydrogen bond with an hydroxyl group or an amino group include a phosphoryl group, a sulfoxide group, a sulfonyl group, a carbonyl group, an amide group, an ester group, a urethane group, a ureido group, a t-amino group, and a nitrogen-containing aromatic group. Among these groups, compounds each having a phosphoryl group, a sulfoxide group, an amide group (however, having no >N—H group; being blocked in form of >N—Ra, in which Ra represents a substituent exclusive of H), a urethane group (however, having no >N—H group; being blocked in form of >N—Ra, in which Ra represents a substituent exclusive of H), a ureido group (however, having no >N—H group; being blocked in form of >N—Ra, in which Ra represents a substituent exclusive of H) are preferable.

Particularly favorable hydrogen bonding compounds according to the present invention are compounds represented by formula (D):

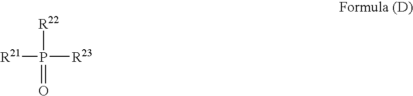

In formula (D), R²¹ to R²³ each independently represent an alkyl group, an aryl group, an alkoxy group, an aryloxy group, an amino group or a heterocyclic group, which may be not substituted or have a substituent.

The substituent in a case where R²¹ to R²³ has a substituent can include, for example, a halogen atom, an alkyl group, an aryl group, an alkoxy group, an amino group, an acyl group, an acylamino group, an alkylthio group, an arylthio group, a sulfoneamide group, an acyloxy group, an oxycarbonyl group, a carbamoyl group, a sulfamoyl group, a sulfonyl group, or a phosphoryl group, and preferred substituent can include an alkyl group or an aryl group, for example, methyl group, ethyl group, isopropyl group, t-butyl group, t-octyl group, phenyl group, 4-alkoxyphenyl group, or 4-acyloxyphenyl group.

The alkyl group for R²¹ to R²³ can include, specifically, methyl group, ethyl group, butyl group, octyl group, dodecyl group, isopropyl group, t-butyl group, t-amyl group, t-octyl group, cyclohexyl group, 1-methylcyclohexyl group, benzyl group, phenethyl group, or 2-phenoxypropyl group.

The aryl group can include, for example, phenyl group, cresyl group, xylyl group, naphthyl group, 4-t-butylphenyl group, 4-t-octylphenyl group, 4-anisidyl group, or 3,5-dichlorophenyl group.

The alkoxy group can include, for example, methoxy group, ethoxy group, butoxy group, octyloxy group, 2-ethylhexyloxy group, 3,5,5-trimethylhexyloxy group, dodecyloxy group, cyclohexyloxy group, 4-methylcyclohexyloxy group, or benzyloxy group.

The aryloxy group can include, for example, phenoxy group, cresyloxy group, isopropylphenoxy group, 4-t-butylphenoxy group, naphthoxy group, or biphenyloxy group.

The amino group can include, for example, dimethylamino group, diethylamino group, dibutylamino group, dioctylamino group, N-methyl-N-hexylamino group, dicyclohexylamino group, diphenylamino group, or N-methyl-N-phenylamino group.

As R²¹ to R²³, an alkyl group, aryl group, alkoxy group, or aryloxy group are preferred. With a view point of the effect of the present invention, it is preferable that at least one of R²¹ to R²³ is alkyl group or aryl group and it is more preferable that two or more of them are alkyl group or aryl group. Further, with a view point of availability at a reduced cost, it is preferable that R²¹ to R²³ are identical groups.

Specific examples of the hydrogen bonding compound including the compound of formula (D) in the present invention are shown below but the present invention is not restricted to them.

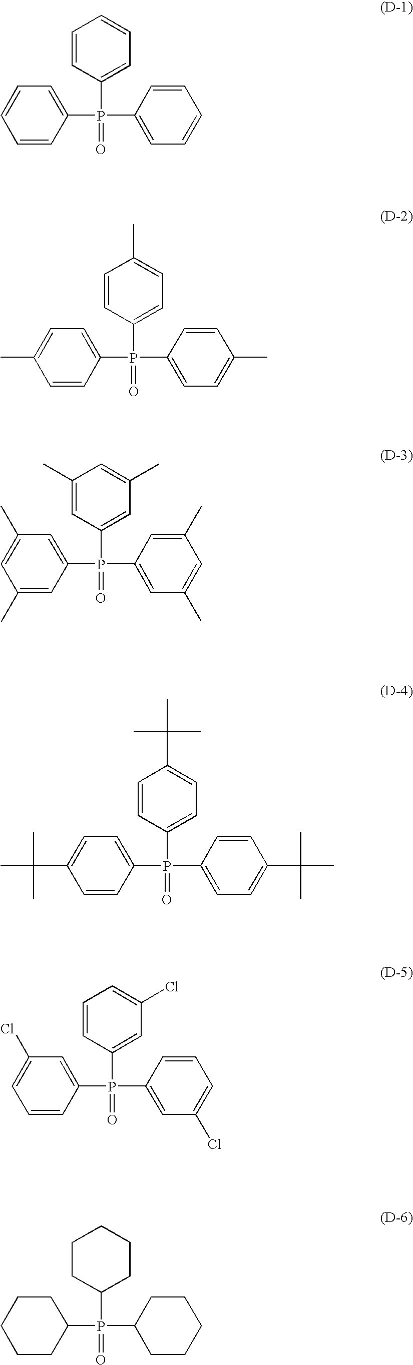

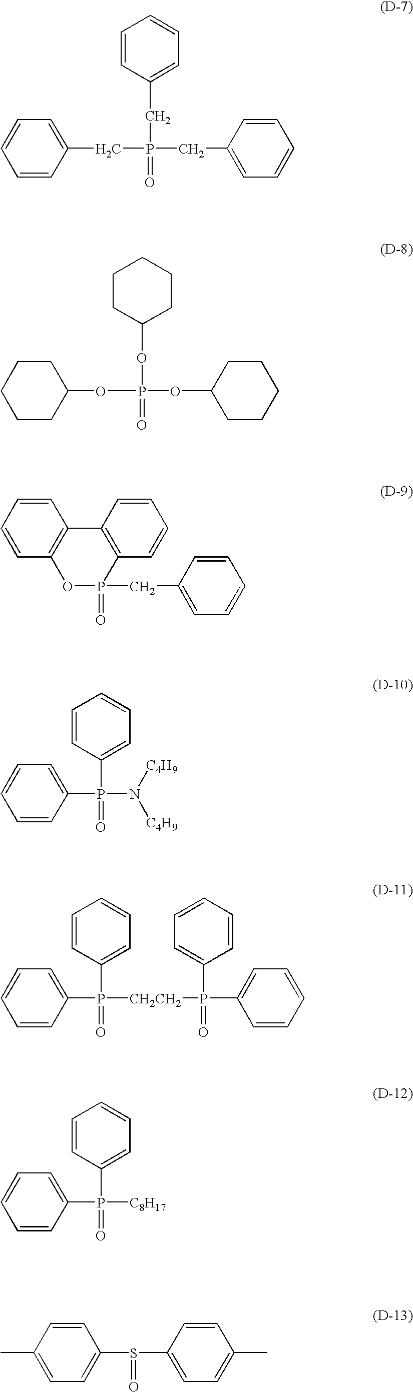

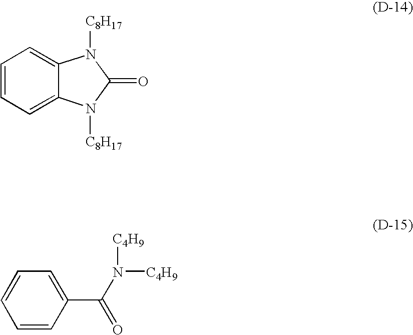

Specific examples of the hydrogen bonding compounds include, besides those described above, compounds as described in EP-A No. 1096310, JP-A Nos. 2002-156727 and 2002-318431. The compounds represented by formula (D) according to the present invention may each be contained in the coating solution in any form of solution form, emulsify-dispersion form, solid-dispersed fine grain dispersion form and the like and, then, the resultant coating solution can be used in the photosensitive material and, on this occasion, it is preferably used as such solid dispersion. These compounds form a hydrogen bonding complex with the compound having the phenolic hydroxyl group or amino group in a solution state and the thus-formed complex can, depending on a combination of the reducing agent and the compound represented by formula (D) according to the present invention, be isolated in a crystalline state.

It is particularly preferable from the standpoint of obtaining a stable performance to use the thus-isolated crystalline powder as solid-dispersed fine grain dispersion. Further, a method in which the reducing agent and the compound represented by formula (D) according to the present invention are mixed with each other in powder form and, then, the resultant mixture is allowed to form a complex at the time of being dispersed by using an appropriate dispersing agent by means of a sand grinder mill or the like is also favorably used.

The compound represented formula (D) according to the present invention is used, based on the reducing agent, preferably in the range of 1% by mol to 200% by mol, more preferably in the range of 10% by mol to 150% by mol and, still more preferably, in the range of 20% by mol to 100% by mol.

(Other Additives)

1) Mercapto, Disulfide and Thions

In the present invention, for controlling the development by suppressing or promoting development, for improving spectral sensitizing efficiency and improving storability before and after development, mercapto compounds, disulfide compounds and thion compounds can be incorporated. They are described in JP-A No. 10-62899, in column Nos. 0067 to 0069, the compound represented by formula (1) in JP-A No. 10-186572 and specific examples thereof, in column Nos. 0033 to 0052, and EP-A No. 0803764A1, page 20, lines 36 to 56. Among them, mercapto substituted heterocyclic aromatic compounds described in JP-A Nos. 9-297367, 9-304875, 2001-100358, 2002-303954 and 2002-303951 are preferred.

2) Color Toner Agent

In the photothermographic material of the present invention, the Color toner is added preferably and the Color toner is described in JP-A No. 10-62899, in column Nos. 0054 to 0055, EP-A No. 0803764A1, in page 21, lines 23 -48, JP-A Nos. 2000-356317 and 2000-187298. Particularly, phthalazinones (phthalazinone, phthalazinone derivatives or metal salts; for example, 4-(1-naphthyl) phthalazinone, 6-chlorophthalazinone, 5,7-dimetoxyphthalazinone and 2,3-dihydro-1,4-phthalazione); combinations of phthalazinones and phthalic acids (for example, phthalic acid, 4-methyl phthalic acid, 4-nitro phthalic acid, diammonium phthalate, sodium phthalate, potassium phthalate, and tetrachloro phthalic acid anhydride); phthalazines (phthalazine, phthalazine derivative or metal salts; for example, 4-(1-naphthyl)phthalazine, 6-isopropyl phthalazine, 6-t-butyl phthalazine, 6-chlorophthalazine, 5,7-dimethoxyphthalazine and 2,3-dihydrophthalazine); and, a combination of phthalazines and phthalic acids is preferred. The combination of phthalazines and phthalic acids is particularly preferred. Among them, particularly preferred combination is that of 6-isopropyl phthalazine and phthalic acid or 4-methylphthalic acid.

3) Plasticizer and Lubricant

In order to improve film physical properties according to the present invention, known plasticizers and lubricants can be used. Particularly, in order to improve handling property at the time of production or scratch resistance at the time of thermal development, it is preferable to use a lubricant such as liquid paraffin, a long-chain fatty acid, a fatty acid amide, fatty acid esters or the like. Particularly, liquid paraffin from which a low boiling point component has been removed or fatty acid esters each having a molecular weight of 1000 or more and a branched structure therein are preferable.

Techniques of the lubricants employable to the present invention are described in paragraphs 0061 to 0064 of JP-A No. 11 -84573 or paragraphs 0049 to 0062 of JP-A No. 2001-83679. Further, for plasticizers and lubricants which can be used in the image forming layer and the non-photosensitive layer, compounds as described in paragraph 0117 of JP-A No. 11-65021, JP-A Nos. 2000-5137, 2004-219794 and 2004-219802 are preferable. Slipping agents are described in paragraphs 0061 to 0064 of JP-A No. 11-84573 or 0049 to 0062 of JP-A No. 2001-83679.

4) Dye and Pigment

As the image-forming layer of the present invention, various kinds of dyes and pigments can be used with a view point of improving the color tone, preventing occurrence of interference fringe upon laser exposure and prevention of irradiation (for example, C.I. Pigment Blue 60, C.I. Pigment Blue 64, C.I. Pigment Blue 15:6). They are specifically described, for example, in WO98/36322, and JP-A Nos. 10-268465 and 11-338098.

5) Super Hard Toner

For the purpose of forming a super hard tone image appropriate for an application of a printing plate fabrication, a super hard toner is preferably added to the image forming layer. As such super hard toners, addition methods thereof, and respective amounts thereof to be added, mentioned are compounds as described in paragraph 0118 of JP-A No. 11-65021, paragraphs 0136 to 0193 of JP-A No. 11-223898; and compounds represented by the formula (H), the formulas (1) to (3) and the formulas (A) and (B) in JP-A No. 2000-284399. Further, hard tone accelerators are described in paragraph 0102 of JP-A No. 11-65021, and paragraphs 0194 to 0195 of JP-A No. 11-223898.

In the case in which formic acid or a salt thereof is used as a strong fogging substance, it is allowed to be contained on a side having the image forming layer containing a photosensitive silver halide in an amount, based on 1 mol of silver, of preferably 5 millimol or less, and more preferably 1 millimol or less.

When the super hard toner is used in the photothermographic material according to the present invention, it is preferably used simultaneously with an acid or a salt thereof which can be formed by hydration of phosphorus pentoxide. As such acids or the salts thereof which can be formed by hydration of phosphorus pentoxide, mentioned are meta-phosphoric acid (and a salt thereof), pyro-phosphoric acid (and a salt thereof), ortho-phosphoric acid (and a salt thereof), triphosphoric acid (and a salt thereof), tetraphosphoric acid (and a salt thereof) and hexameta-phosphoric acid (and a salt thereof). The acids and the salts thereof which can be formed by hydration of phosphorus pentoxide which are particularly preferably used are ortho-phosphoric acid (and salts thereof) and hexameta-phosphoric acid (and salts thereof). Specific examples of the salts include sodium ortho-phosphate, sodium dihydrogen ortho-phosphate, sodium hexameta-phosphate and ammonium hexameta-phosphate.

An amount of the acid or the salt thereof which can be formed by hydration of phosphorus pentoxide to be used (in terms of a coated amount based on 1 m² of the photosensitive material) may be a desired amount, depending on properties of sensitivity, fog, and the like; however, it is preferably in the range of 0.1 mg/m² to 500 mg/m² and, more preferably, in the range of 0.5 mg/m² to 100 mg/m².

6) Crosslinking Agent

According to the present invention, it is preferable to allow a crosslinking agent to be contained in any one layer on the side of the image forming layer. It is more preferable to add the crosslinking agent to the image forming layer or a surface protective layer. By adding the crosslinking agent, a hydrophobic property and waterproofness of the layer are enhanced, to thereby produce an excellent photothermographic material.

The type of the crosslinking agent is not particularly limited, so long as it contains a plurality of groups which each react with a carboxyl group in a molecule. Examples of such crosslinking agents are described in T. H. James, The Theory of the Photographic Process, 4th edition, Macmillan Publishing Co., Inc., pp. 77 to 87 (1977). The crosslinking agent of an inorganic compound (for example, chrome alum) and that of an organic compound are both preferable and that of the organic compound is more preferable.

Examples of preferable compounds as the crosslinking agents of the organic compounds include a carboxylic acid derivative, a carbamic acid derivative, a sulfonic acid ester compound, a sulfonyl compound, an epoxy compound, an aziridine compound, an isocyanate compound, a carbodiimide compound and oxazoline compound. More preferable are en epoxy compound, an isocyanate compound, a carbodiimide compound and an oxizoline compound. These crosslinking agents may be used each independently or in combinations of two or more types thereof.

Specific examples include the compounds cited below, however, the present invention is by no means limited thereto.

(Carbodiimide Compound)

A water-soluble or water-dispersible carbodiimide compound is preferable. Examples of such carbodiimide compounds include a polycarbodiimide derived from isophorone diisocyanate as described in JP-A No. 59-187029 and JP-B No. 5-27450, a carbodiimide compound derived from tetramethyl xylene diisocyanate as described in JP-A No. 7-330849, a branched-type carbodiimide compound as described in JP-A No. 10-30024 and a carbodiimide compound derived from dicyclohexylmethane diisocyanate as described in JP-A No. 2000-7642.

(Oxazoline Compound)

A water-soluble or water-dispersible oxazoline compound is preferable. Examples of such oxazoline compounds include an oxazoline compound as described in JP-A No. 2001-215653.

(Isocyanate Compound)

Since being capable of reacting with water, a water-dispersible isocyanate compound is preferable from the standpoint of a pot life and, particularly, that having a self-emulsifying property is preferable. Examples of such isocyanate compounds include water-dispersible isocyanate compounds as described in JP-A Nos. 7-304841, 8-277315, 10-45866, 9-71720, 9-328654, 9-104814, 2000-194045, 2000-194237 and 2003-64149.

(Epoxy Compound)

A water-soluble or water-dispersible epoxy compound is preferable. Examples of such epoxy compounds include an water-dispersible epoxy compound as described in JP-A Nos. 6-329877 and 7-309954.

Further, specific examples of crosslinking agents capable of being used in the present invention are described below; however, the present invention is by no means limited thereto.

(Epoxy Compound)
Trade name: DIC FINE EM-60; available from Dainippon Ink and Chemicals, Inc.

(Isocyanate Compound)
Trade name: DURANATE WB40-100; available from Asahi Kasei Chemicals Corp.
Trade name: DURANATE WB40-80D; available from Asahi Kasei Chemicals Corp.
Trade name: DURANATE WT20-100; available from Asahi Kasei Chemicals Corp.
Trade name: DURANATE WB30-100; available from Asahi Kasei Chemicals Corp.
Trade name: CR-60N; available from Dainippon Ink and Chemicals, Inc.

(Carbodiimide Compound)
Trade name: CARBODILITE V-02; available from Nisshinbo Industries, Inc.
Trade name: CARBODILITE V-02-L2; available from Nisshinbo Industries, Inc.
Trade name: CARBODILITE V-04; available from Nisshinbo Industries, Inc.
Trade name: CARBODILITE V-06; available from Nisshinbo Industries, Inc.
Trade name: CARBODILITE E-01; available from Nisshinbo Industries, Inc.
Trade name: CARBODILITE E-02; available from Nisshinbo Industries, Inc.

(Oxazoline Compound)
Trade name: EPOCROS K-1010E; available from Nippon Shokubai Co., Ltd.
Trade name: EPOCROS K-1020E; available from Nippon Shokubai Co., Ltd.
Trade name: EPOCROS K-1030E; available from Nippon Shokubai Co., Ltd.
Trade name: EPOCROS K-2010E; available from Nippon Shokubai Co., Ltd.
Trade name: EPOCROS K-2020E; available from Nippon Shokubai Co., Ltd.
Trade name: EPOCROS K-2030E; available from Nippon Shokubai Co., Ltd.
Trade name: EPOCROS WS-500; available from Nippon Shokubai Co., Ltd.
Trade name: EPOCROS WS-700; available from Nippon Shokubai Co., Ltd.

The crosslinking agent according to the present invention can be added in a state of having previously been mixed in a binder solution, at a last stage of a preparation step of a coating solution or immediately before coating.

An amount of the crosslinking agent according to the present invention to be used is, based on 100 parts by mass of the binder of a constituting layer to be contained, preferably in the range of 0.5 part by mass to 200 parts by mass, more preferably in the range of 2 parts by mass to 100 parts by mass and, still more preferably, in the range of 3 parts by mass to 50 parts by mass.

7) Thickening Agent

It is preferable to add a thickening agent to a coating solution containing a hydrophobic polymer. When the thickening agent is added thereto, mixing with an adjacent layer hardly occurs in a coating step and a drying step. Preferable compounds as such thickening agents are described in (i) to (ii) below and, in order to avoid deterioration of a hydrophobilc property and water resistance of a layer, an aqueous dispersion of a polymer described in (ii) is particularly preferable.

(i) Nonionic or Ionic Water-Soluble Polymer

Specifically, polyvinyl alcohol, hydroxyethyl cellulose, hydroxypropylmethyl cellulose, an alkaline metal salt of polyacrylic acid, an alkaline metal salt of carboxymethyl cellulose, carboxymethyl-hydroxyethyl cellulose and the like are used.

(ii) Aqueous Dispersion of Polymer

Specifically, an aqueous dispersion of an acrylic polymer, an aqueous dispersion of a synthetic rubber-type (for example, styrene-butadiene copolymer) polymer, an aqueous dispersion of a polyether-type polymer, an aqueous dispersion of a polyurethane-type polymer are used and, by taking an easy handling property into consideration, articles having thixotropic properties, for example, hydroxyethyl cellulose, sodium hydroxymethyl carboxylate and carboxymethyl-hydroxyethyl cellulose are used.

Further, viscosity of the coating solution added with the thickening agent at 40° C. is preferably in the range of 1 mPa.s to 1000 mPa.s, more preferably in the range of 1 mPa.s to 200 mPa.s and, still more preferably, in the range of 10 mPa.s to 100 mPa.s.

(Preparation and Coating of Coating Solution)

A preparation temperature of a coating solution for an image forming layer according to the present invention is preferably in the range of 30° C. to 65° C., more preferably in the range of 35° C. to less than 60° C. and, still more preferably, in the range of 35° C. to 55° C. Further, a temperature of the coating solution for the image forming layer immediately after addition of a polymer latex is preferably maintained in the range of 30° C. to 65° C.

(3) Constitution and Constitutional Component of Other Layers

1) Surface Protective Layer

The photothermographic material according to the present invention may have a surface protective layer for the purpose of preventing adhesion of the image forming layer and the like. The surface protective layer may be of a single layer or of a plurality of sub-layers.

Such surface protective layers are described in paragraphs 0119 to 0120 of JP-A No. 11-65021 and JP-A No. 2000-171936.

As binders for the surface protective layer according to the present invention, any one of a water-soluble polymer derived from an animal protein such as gelatin, a water-soluble polymer derived from the animal protein such as polyvinyl alcohol (PVA) and a hydrophobic polymer can be used. These polymers can appropriately be selected in accordance with purposes. When the water-soluble polymer derived from the animal protein such as gelatin is used in the binder, since a setting property is imparted, a coating performance becomes enhanced. When the hydrophobic polymer is used, discoloration to be caused by attachment of a finger print can be prevented and, also, deterioration of an image storability to be caused by moisture or the like can effectively be prevented. These polymers can be used singly or in combinations of two or more types.

As gelatin, inert gelatin (for example, Nitta Gelatin 750), phthalated gelatin (for example, Nitta Gelatin 801) and the like can be used.

As PVA, those described in paragraphs 0009 to 0020 of JP-A No. 2000-171936 can be cited. PVA-105 as a completely saponified PVA, PVA-205 and PVA-335 as partly saponified PVA, and MP-203 as a modified polyvinyl alcohol (these are trade names of products manufactured by Kuraray Co., Ltd.) are preferably mentioned.

As hydrophobic polymers, a latex of methyl methacrylate (33.5% by mass)/ethyl acrylate (50% by mass)/methacrylic acid (16.5% by mass) copolymer, a latex of methyl methacrylate (47.5% by mass)/butadiene (47.5% by mass)/itaconic acid (5% by mass) copolymer, a latex of an ethyl acrylate/methacrylic acid copolymer, a latex of methyl methacrylate (58.9% by mass)/2-ethylhexyl acrylate (25.4% by mass)/styrene (8.6% by mass)/2-hydroxyethyl metacrylate (5.1% by mass)/acrylic acid (2.0% by mass) copolymer, and a latex of methyl methacrylate (64.0% by mass)/styrene (9.0% by mass)/butyl acrylate (20.0% by mass)/2-hydroxyethyl metacrylate (5.0% by mass)/acrylic acid (2.0% by mass) copolymer and the like are mentioned.

Further, a technique as described in paragraphs 0021 to 0025 of JP-A No. 2000-267226 and a technique as described in paragraphs 0023 to 0041 of JP-A No. 2000-19678 may be applied.

A ratio of the polymer latex of the surface protective layer is, based on an entire binder, preferably in the range of 10% by mass to 90% by mass, and particularly preferably from 20% by mass to 80% by mass. An amount of polyvinyl alcohol (per m² of support) of the protective layer (per layer) to be applied is preferably in the range of 0.3 g/m² to 4.0 g/m² and, more preferably, in the range of 0.3 g/m² to 2.0 g/m².

Such hydrophobic polymers are described in, for example, “Synthetic Resin Emulsion”, compiled by Taira Okuda and Hiroshi Inagaki, Kobunshi Kankokai (Polymer Publishing) (1978), “Application of Synthesized Latex”, compiled by Takaaki Sugimura, Yasuo Kataoka, Soichi Suzuki and Keiji Kasahara, Kobunshi Kankokai (Polymer Publishing) (1993), and Soichi Muroi, “Chemistry of Synthesized Latex”, Kobunshi Kankokai (Polymer Publishing) (1970).

When the photothermographic material according to the present invention is used for the application of printing in which, particularly, size changes are problematic, a polymer latex is preferably used as a binder.

An amount of an entire binder (inclusive of water-soluble polymer and latex polymer) (per m² of support) of the surface protective layer (per layer) to be applied is preferably in the range of 0.3 g/m² to 5.0 g/m² and, more preferably, in the range of 0.3 g/m² to 2.0 g/m².

Further, a lubricant such as liquid paraffin or an aliphatic ester is preferably used in the surface protective layer. An amount of the lubricant to be used is preferably in the range of 1 mg/m² to 200 mg/m², more preferably in the range of 10 mg/m² to 150 mg/m² and, still more preferably, in the range of 20 mg/m² to 100 mg/m².

2) Antihalation Layer

In the photothermographic material according to the present invention, an antihalation layer can be formed at the farther side from a light source relative to the image forming layer.

Such antihalation layers are described in, for example, paragraphs 0123 to 0124 of JP-A No. 11-65021, JP-A Nos. 11-223898, 9-230531, 10-36695, 10-104779, 11-231457, 11-352625, and 11-352626.

The antihalation layer contains an antihalation dye having an absorption in an exposure wavelength. When such exposure wavelength is in an infrared region, a dye absorbing an infrared ray may be used; on this occasion, the dye having no absorption in a visible wavelength region is preferred.

When antihalation is performed by using a dye having absorption in the visible wavelength region, it is preferred that color of the dye does not remain substantially after an image is formed, a device to decolorize the dye by heat in thermal development is used and a thermal color fading dye and a base precursor are added to the non-photosensitive layer to allow the resultant non-image-forming layer to function as an antihalation layer. Such techniques are described in JP-A No. 11 -231457 and the like.

An amount of the color fading dye to be added is determined depending on the applications of the dye. Ordinarily, the color fading dye is used in such an amount as an optical density (absorbance) measured at the objective wavelength exceeds 0.1. The optical density is preferably in the range of 0.15 to 2 and, more preferably, in the range of 0.2 to 1. An amount of the color fading dye for obtaining the above-described optical density is ordinarily in the range of about 0.001 g/m² to about 1 g/m².

Further, when the dye is subjected to color fading in such a manner as described above, the optical density after thermal development is performed can be lowered to 0.1 or less. Two or more types of the color fading dyes may simultaneously be used in a thermal color fading-type recording material or in the photothermographic material. In a similar way, two or more types of base precursors may simultaneously be used.

In the thermalcolor fading using such a color fading dye and base precursor as described above, it is preferable from the viewpoint of thermal color fading properties and the like that a substance (for example, diphenylsulfone, or 4-chlorophenyl (phenyl) sulfone) which decreases a melting point by 3° C. or more when mixed with the base precursor as described in JP-A No. 11-352626 is simultaneously used.

3) Back Layer

When the image forming layer is provided only on the side of the support, it is preferable to provide a back layer on the side of the other face.

Back layers applicable to the present invention are described in paragraphs 0128 to 0130 of JP-A No. 11-65021.

According to the present invention, a coloring agent having an absorption maximum in the wavelength region of from 300 nm to 450 nm can be added for the purpose of improving silver color tone and improving change of image over time. Such coloring agents are described in, for example, JP-A Nos. 62-210458, 63-104046, 63-103235, 63-208846, 63-306436, 63-314535, 1-61745 and 2001-100363.

When the photothermographic material according to the present invention is used for the application of printing in which, particularly, size changes are problematic, a polymer latex is preferably used as a binder of the back layer.

4) Matting Agent

According to the present invention, it is preferable to add a matting agent to the surface protective layer for improving transportation properties. Such matting agents are described in paragraphs 0126 to 0127 of JP-A No. 11-65021.

An amount of the matting agent to be added is, based on 1 m² of the photosensitive material, preferably in the range of 1 mg/m² to 400 mg/m² and, more preferably, in the range of 5 mg/m² to 300 mg/m².

Although a shape of the matting agent according to the present invention may be either fixed or amorphous, a fixed spherical shape is favorably used.

A volume weighted average of a sphere-equivalent diameter of the matting agent to be used on an emulsion layer side (image forming layer side) is preferably in the range of 0.3 μm to 10 μm and, more preferably, in the range of 0.5 μm to 7 μm. Further, coefficient of variation of a size distribution of the matting agent is preferably in the range of 5% to 80% and, more preferably, in the range of 20% to 80%. The term “coefficient of variation” as used herein is referred to mean a value represented by the formula: (standard variation of grain diameter)/(average of grain diameter)×100. Still further, two or more types of matting agents which are different in an average grain size from one another can simultaneously be used on the emulsion layer side (image forming layer side). On this occasion, a difference in the average grain size between the matting agent having the maximum grain size and that having the minimum grain size is preferably in the range of 2 μm to 8 μm and, more preferably, in the range of 2 μm to 6 μm.

A volume weighted average of a sphere-equivalent diameter of the matting agent to be used on a back face is preferably in the range of 1 μm to 15 μm and, more preferably, in the range of 3 μm to 10 μm. Further, the coefficient of variation of the size distribution of the matting agent is preferably in the range of 3% to 50% and, more preferably, in the range of 5% to 30%. Still further, two or more types of matting agents having different average grain size from one another can simultaneously be used as the matting agent for the back face. On this occasion, a difference in the average grain size between the matting agent having the maximum grain size and that having the minimum grain size is preferably in the range of 2 μm to 14 μm and, more preferably, in the range of 2 μm to 9 μm.

Further, as a matting degree of an emulsion layer side (image forming layer side), any degree is permissible so far as a so-called star dust-like defect does not occur; however, Beck smoothness is preferably in the range of 30 seconds to 2000 seconds and, particularly preferably, in the range of 40 seconds to 1500 seconds. The Beck smoothness can easily be obtained in accordance with “Testing Method for Smoothness of Paper and Paperboard by Beck's Tester” by the Japanese Industrial Standards (JIS) P8119 and the TAPPI Standard Method T479.

According to the present invention, the Beck smoothness as a matting degree for the back layer is preferably in the range of 10 seconds to 1200 seconds, more preferably in the range of 20 seconds to 800 seconds and, still more preferably, in the range from 40 seconds to 500 seconds.

According to the present invention, the matting agent is preferably contained in an outermost surface layer of the photosensitive material, a layer functioning as the outermost surface layer thereof, or a layer in a neighborhood of the outer surface layer, or otherwise in a layer functioning as the so-called protective layer.

5) Film Surface pH

In the photothermographic material according to the present invention, a film surface pH before the thermal development is preferably 7.0 or less and, more preferably, 6.6 or less. A lower limit thereof is not particularly restricted but is approximately 3. A most preferable pH is in the range of 4 to 6.2. As adjusting the film surface pH, it is preferred from the viewpoint of lowering the film surface pH that an organic acid such as a phthalic acid derivative, a non-volatile acid such as sulfuric acid or a volatile base such as ammonia is used. Particularly, ammonia is preferable for achieving a low film surface pH, because ammonia is particularly apt to be vaporized and can be removed during a coating step or before being subjected to the thermal development.

Further, it is also preferred that a non-volatile base such as sodium hydroxide, potassium hydroxide or lithium hydroxide is used with ammonia in combination. Furthermore, a measurement method of the film surface pH is described in paragraph 0123 of JP-A No. 2000-284399.

6) Film Hardener

A film hardener may be used in each of the image forming layer, the protective layer, the back layer and the like according to the present invention. Examples of such film hardener are found in various methods described in T. H. James, The Theory of the Photographic Process, 4th edition, Macmillan Publishing Co., Inc., pp. 77 to 87 (1977). In addition to compounds such as chrome alum, sodium salt of 2,4-dichloro-6-hydroxy-s-triazine, N,N-ethylene bis(vinylsulfone acetamide) and N,N-propylene bis(vinylsulfone acetamide), polyvalent metal ions as described in the above-cited reference, page 78 and the like, polyisocyanates as described in U.S. Pat. No. 4,281,060, JP-A No. 6-208193 and the like, epoxy compounds as described in U.S. Pat. No. 4,791,042 and vinyl sulfone-type compounds as described in JP-A No. 62-89048 are preferably used.

The film hardener is added as a solution. Timing of adding such film hardener solution into the coating solution for the protective layer is in a period of from 180 minutes before coating to immediately before coating and, preferably, in a period of from 60 minutes before coating to 10 seconds before coating; however, mixing methods and mixing conditions for the film hardener solution are not particularly limited so far as the effects according to the present invention are sufficiently realized. Specific examples of mixing methods include a mixing method using a tank in which an average staying time calculated from an addition flow rate and a feeding flow rate to a coater is adjusted to be a desired time, and a mixing method using a static mixer described in N. Harnby, M. F. Edwards and A. W. Nienow, Techniques of Mixing Liquids, translated by Koji Takahashi, Nikkan Kogyo Newspaper (1989), Chapter 8 and the like.

7) Surface Active Agent

Surface active agents according to the present invention are described in paragraph 0132 of JP-A No. 11-65021.

According to the present invention, fluorine-type surface active agents may preferably be used. Specific examples of the fluorine-type surface active agents include compounds as described in, for example, JP-A Nos. 10-197985, 2000-19680 and 2000-214554. Also, polymeric fluorine-type surface active agents as described in JP-A 9-281636 are preferably used. In the photothermographic material according to the present invention, the fluorine-type surface active agents as described in JP-A Nos. 2002-82411 and 2003-057780 are preferably used. Particularly, when a coating operation is performed by using an aqueous coating solution, a fluorine-type surface active agent as described in JP-A No. 2003-057780 is preferable from the standpoints of electric charge adjusting performance, stability of a coated face state and slipperiness, while, since a fluorine-type surface active agent as described in JP-A No. 2003-149766 is high in electric charge adjusting performance and low in an amount to be used, the thus described fluorine-type surface active agent is most preferable.

Although the fluorine-type surface active agent according to the present invention can be used on any one of an image forming layer side and a back side, it is preferable to use the fluorine-type surface active agent on both sides. Further, it is particularly preferable to use the fluorine-type surface active agent in combination with the aforementioned conductive layer containing the metal oxide. On this occasion, sufficient performance can be obtained, even when the fluorine-type surface active agent on a face containing the conductive layer is reduced in usage or eliminated.

A preferable amount of the fluorine-type surface active agent to be used on each of the image forming layer side and the back layer side is preferably in the range of 0.1 mg/m² to 100 mg/m², more preferably in the range of 0.3 mg/m² to 30 mg/m² and, still more preferably, in the range of 1 mg/m² to 10 mg/m².

8) Antistatic Agent

An antistatic or conductive layer capable of being applied to the present invention is described in paragraph 0135 of JP-A No. 11-65021.

According to the present invention, the antistatic layer preferably comprises a conductive layer containing a metal oxide or a conductive polymer. The antistatic layer may concurrently functions as the undercoat layer, the surface protective layer of the back layer or the like, or may separately be provided from these layers. As a conductive material for the antistatic layer, a metal oxide in which a conductive property has been enhanced by incorporating oxygen deficiency or a dissimilar metal atom is preferably used. Such metal oxides are preferably, for example, ZnO, TiO₂ and SnO₂ and, on this occasion, it is preferable that Al or In is added to ZnO; Sb, Nb, P, a halogen element or the like is added to SnO₂; and Nb, Ta or the like is added to SnO₂. Particularly, SnO₂ added with Sb is preferable. An amount of the dissimilar atom to be added is preferably in the range of 0.01% by mol to 30% by mol and, more preferably, in the range of 0.1% by mol to 10% by mol. A shape of the metal oxide may be any one of a spherical shape, a needle shape and a planar shape and, from the standpoints of an effect of imparting the conductive property, a needle shape grain having a ratio of long axis/short axis being 2.0 or more and, preferably, in the range of 3.0 to 50 is preferred. An amount of the metal oxide to be used is preferably in the range of 1 mg/m² to 1000 mg/m², more preferably in the range of 10 mg/m² to 500 mg/m² and, still more preferably, in the range of 20 mg/m² to 200 mg/m². Although the antistatic layer according to the present invention may be provided on any of the side of the image forming layer face and the side of the back face, it is preferably provided between the support and the back layer. Specific examples of the antistatic layers are described in paragraph 0135 of JP-A No. 11-65021, JP-A Nos. 56-143430, 56-143431, 58-62646, and 56-120519, paragraphs 0040 to 0051 of JP-A No. 11-84573, U.S. Pat. No. 5,575,957, and paragraphs 0078 to 0084 of JP-A No. 11-223898.

9) Support

A support capable of being applied to the present invention is described in paragraph 0134 of JP-A No. 11-65021.

As transparent supports, polyester, particularly, polyethylene terephthalate, which has been subjected to a thermal treatment in the temperature range of from 130° C. to 185° C. in order to relax residual internal stress in the film generated when being biaxially stretched and to eliminate the strain of thermal contraction generated when subjected to the thermal development treatment, is preferably used. In the case of the photothermographic material for medical diagnosis use, the transparent support may be colored with a blue dye (for example, Dye-1 as described in JP-A No. 8-240877) or may remain uncolored.

To the supports, undercoat techniques of, for example, a water-soluble polyester as described in JP-A No. 11-84574, a styrene-butadiene copolymer as described in JP-A No. 10-186565 and vinylidene chloride copolymers as described in JP-A No. 2000-39684 are preferably applied. When the image forming layer or the back layer is applied to the support, a moisture content of the support is preferably 0.5% by mass or less.

10) Other Additives

To the photothermographic material, an antioxidant, a stabilizing agent, a plasticizer, a UV absorbent or a coating aid may further be added. Various types of these additives are added either to the image forming layer or to the non-photosensitive layer. In regard to those additives, WO98/36322, EP-A No. 803764, JP-A Nos. 10-186567 and 10-18568 and the like can be of reference.

11) Coating Method

The photothermographic material according to the present invention may be applied by any method. Various types of coating operations may be used; and specific examples thereof include extrusion coating, slide coating, curtain coating, dip coating, knife coating, flow coating, and extrusion coating using such a kind of hopper as described in U.S. Pat. No. 2,681,294. Extrusion coating or slide coating as described in Stephen F. Kistler and Petert M. Schweizer, Liquid Film Coating, Chapman & Hall, pp. 399 to 536 (1997) is preferably used. The slide coating is particularly preferably used. Examples of shapes of slide coaters to be used in the slide coating are described in the above-cited book, p. 427, FIG. 11b-1. Further, as desired, two or more layers can simultaneously be coated by methods described in the above-cited book, pp. 399 to 536, U.S. Pat. No. 2,761,791 and BP-A No. 837,095. Particularly preferable coating methods according to the present invention are those as described in JP-A Nos. 2001-194748, 2002-153808, 2002-153803 and 2002-182333.

It is preferable that the coating solution for the image forming layer according to the present invention is a so-called thixotropic fluid. Techniques related to this fluid can be referred to JP-A No. 11-52509. In regard to the coating solution for the image forming layer according to the present invention, a viscosity thereof at the shearing velocity of 0.1 S⁻¹ is preferably in the range of 400 mPa.s to 100,000 mPa.s and, more preferably, in the range of 500 mPa.s to 20,000 mPa.s. Further, a viscosity at the shearing velocity of 1000 S⁻¹ is preferably in the range of 1 mPa.s to 200 mPa.s and, more preferably, in the range of 5 mPa.s to 80 mPa.s.

When two types of solution are mixed with each other for preparing a coating solution, a known in-line mixing machine or in-plant mixing machine is preferably used. The preferable in-line mixing machine according to the present invention is described in JP-A No. 2002-85948, while the in-plant mixing machine is described in JP-A No. 2002-90940.

In order to maintain a favorable coated face condition, it is preferable to perform a defoaming treatment on the coating solution according to the present invention. A preferable method for the defoaming treatment according to the present invention is such a method as described in JP-A No. 2002-66431.

When the coating solution is applied, it is preferable to eliminate static electricity in order to prevent attraction of dirt, dust or the like by the static electricity. A preferable example of eliminating the static electricity is described in JP-A No. 2002-143747.

According to the present invention, in order to dry a non-setting type coating solution of the image forming layer, it is important to precisely control a drying air and drying temperature. The preferable drying method according to the present invention is described in detail in JP-A Nos. 2001-194749 and 2002-139814.

In order to enhance a film forming property of the photothermographic material according to the present invention, a heating treatment is preferably performed immediately after a drying treatment is performed. A temperature of the heating treatment is preferably in the range of 60° C. to 100° C. as a temperature of a film face. A heating time is preferably in the range of 1 second to 60 seconds. The heating temperature and heating time are, more preferably, in the range of 70° C. to 90° C. and in the range of 2 seconds to 10 seconds, respectively. A preferable method for performing the heating treatment according to the present invention is described in JP-A No. 2002-107872.

Further, in order to continuously produce the photothermographic material according to the present invention in a consistent manner, a production method as described in JP-A Nos. 2002-156728 and 2002-182333 is favorably used.

The photothermographic material according to the present invention is preferably of a monosheet type (type capable of forming an image on the photothermographic material without using another sheet made of, for example, an image receiving material).

12) Packaging Material

It is preferable that the photosensitive material according to the present invention is packed by a packaging material having at least one of a low oxygen transmittance and a low moisture transmittance in order to suppress fluctuations of photographic properties at the time of storage in an unprocessed state, or improve a curl or a curl habit. The oxygen transmittance at 25° C. is preferably 50 ml/atm·m²·day or less, more preferably 10 ml/atm·m²·day or less and, still more preferably, 1.0 ml/atm·m²·day or less. The moisture transmittance is preferably 10 g/atm·m²·day or less, more preferably 5 g/atm·m²·day or less and, still more preferably, 1 g/atm·m²·day or less.

Specific examples of packaging materials in which at least one of the oxygen transmittance and the moisture transmittance is low include those as described in JP-A Nos. 8-254793 and 2000-206653.

13) Other Employable Techniques

As techniques employable in the phototermographic materials according to the present invention, techniques described in the following references are further cited: EP-A Nos. 803764, and 883022, WO98/36322, JP-A Nos. 56-62648, 58-62644, 9-43766, 9-281637, 9-297367, 9-304869, 9-311405, 9-329865, 10-10669, 10-62899, 10-69023, 10-186568, 10-90823, 10-171063, 10-186565, 10-186567, from 10-186569 to 10-186572, 10-197974, 10-197982, 10-197983, from 10-197985 to 10-197987, 10-207001, 10-207004, 10-221807, 10-282601, 10-288823, 10-288824, 10-307365, 10-312038, 10-339934, 11-7100, 11-15105, 11-24200, 11-24201, 11-30832, 11-84574, 11-65021, 11-109547, 11-125880, 11-129629, from 11-133536 to 11-133539, 11-133542, 11-133543, 11-223898, 11-352627, 11-305377, 11-305378, 11-305384, 11-305380, 11-316435, 11-327076, 11-338096, 11-338098, 11-338099, 11-343420, 2001-200414, 2001-234635, 2002-020699, 2001-275471, 2001-275461, 2000-313204, 2001-292844, 2000-324888, 2001-293864, 2001-348546 and 2000-187298.

A method for obtaining a color image capable of being applied to the present invention is described in paragraph 0136 of JP-A No.11-65021.

In the case of a multi-color photothermographic material, respective image forming layers are, as described in U.S. Pat. No. 4,460,681, ordinarily maintained in a separate manner from one another by being provided with a functional or non-functional barrier layer between any two of the respective photosensitive layers.

A constitution of the multi-color photothermographic material may comprise a combination of two layers of different colors or may comprise one layer containing all colors therein as described in U.S. Pat. No. 4,708,928.

2. Image Forming Method

(1) Exposure

1) Laser Exposure

He—Ne laser or red semiconductor laser which radiates red to infrared light, or Ar⁺, He—Ne, or He—Cd laser or blue semiconductor laser which radiates blue to green light can be used. A red to infrared light semiconductor laser is preferable, and a peak wavelength of the laser light is in the range of 600 nm to 900 nm and, preferably, in the range of 620 nm to 850 nm.

In recent years, a module fabricated by unifying an SHG (Second Harmonic Generator) element with the semiconductor laser, or the blue semiconductor laser has been developed, to thereby rapidly attract people's attention to a laser output device in a short wavelength region. Since the blue semiconductor laser is capable of performing image recording of high precision, increasing a recording density and obtaining a long-life and consistent output, it is expected that demand for the blue semiconductor laser will be increased. A peak wavelength of blue laser light is in the range of 300 nm to 500 nm and, preferably, from 400 nm to 500 nm.

The laser light is favorably used also from the point in which it is oscillated in a vertical multi-mode by a method such as a high frequency superimposition method.

2) X-Ray Exposure

In the photothermogrphic material according to the present invention, an image for the purpose of medical diagnosis and the like can be formed by using an X ray.

A method for forming an image by using the X ray comprises the following:
(1) obtaining an assembly for image forming by placing the photothermographic material according to claim 1 between a pair of X-ray sensitizing screens,
(2) setting a subject between the assembly for image forming and an X-ray source,
(3) irradiating the subject with X rays having an energy level in the range of 25 kVp to 125 kVp,
(4) removing the photothermographic material from the assembly; and
(5) heating the removed photothermographic material at a temperature in the range of 90° C. to 180° C.

The photothermographic material to be used in the assembly is preferably prepared such that an image to be obtained by exposing the photosensitive material by an X ray in a stepwise manner and, then, thermally developing it has a characteristic curve, being constructed on a crossed coordinates having same unit lengths of coordinate axes denoting optical density (D) and exposure amount (logE) respectively, in which an average gamma (γ) obtained between a point of a minimum density (Dmin) plus density 0.1 and a point of a minimum density (Dmin) plus density 0.5 is in the range of 0.5 to 0.9 and another average gamma (γ) obtained between a point of a minimum density (Dmin) plus density 1.2 and a point of a minimum density (Dmin) plus density 1.6 is in the range of 3.2 to 4.0. When the photothermographic material having the characteristic curve is used in an X-ray photographing system, an X-ray image having excellent photographic properties in which a foot portion of the characteristic curve is extremely extended and also a gamma value in an intermediate density portion is high can be obtained. By these photographic properties, there is advantageous in that depiction of a low density area, for example, a mediastinum area, or cardioshadowgraph which is low in X-ray transmission amount becomes enhanced and, further, an image of a lung field which is subjected to a large X-ray exposure amount comes to have a density which allows the lung field to be easily recognized and, also, comes to have a favorable contrast.

The photothermographic material having such favorable characteristic curve as described above can easily be produced by, for example, a method in which an image forming layer on each side is constituted by two or more photosensitive silver halide emulsion layers which are different in sensitivity from one another. Particularly, it is preferable to form the image forming layer by using an emulsion of high speed as an upper layer and another emulsion having photographic properties of low speed and hard tone as a lower layer. When the image forming layer comprising such two layers as described above is used, a difference of speed of photosensitive silver halide emulsion between the two layers is in the range of 1.5 time to 20 times and, preferably, in the range of 2 times to 15 times. Further, a ratio between amounts of emulsions to be used in forming respective layers differs depending on differences of speeds and covering powers of the emulsions to be used. Ordinarily, as the difference of speed becomes larger, the ratio of the amount of the emulsion of high speed to be used is allowed to be lower. For example, when the difference of speed is two times, a preferable ratio between the emulsions to be used, namely, the emulsion of high speed to the emulsion of low speed, is adjusted to be in the range of 1:20 to 1:50 in terms of silver amount on condition that covering powers of respective emulsions are same with each other.

As techniques of cross-over cut (for double-sided photosensitive material) and antihalation (for single-sided photosensitive material), dyes or combinations of dyes and mordants as described in JP-A No. 2-68539, from page 13, left lower column, line 1 to page 14, left lower column, line 9 can be used.

Next, a fluorescent intensifying paper (radiation intensifying screen) according to the present invention will be described. The radiation intensifying screen comprises, as a basic structure, a support, and a phosphor layer formed on one side of the support. The phosphor layer is a layer in which a phosphor is dispersed in a binder. Further, a transparent protective film is ordinarily provided on a surface of the phosphor layer opposite to the support (a surface thereof on a side not facing the support) to protect the phosphor layer from a chemical change in quality or a physical impact.

Examples of preferable phosphors according to the present invention include a tungstate-type phosphor (for example, CaWO₄, MgWO₄, or CaWO₄:Pb), a terbium-activated rare earth element oxysulfide-type phosphor (for example, Y₂O₂S:Tb, Gd₂O₂S:Tb, La₂O₂S:Tb, (Y,Gd)₂O₂S:Tb, (Y,Gd)O₂S:Tb, Tm), a terbium-activated rare earth element phosphate-type phosphor (for example, YPO₄:Tb, GdPO₄:Tb, or LaPO₄:Tb), a terbium-activated rare earth element oxyhalogenide type phosphor (for example, LaOBr:Tb, LaOBr:Tb,Tm, LaOCl:Tb, LaOCl:Tb, Tm, LaOBr:Tb, GdOBr:Tb, or GdOCl:Tb), a thulium-activated rare earth element oxyhalogenide-type phosphor (for example, LaOBr:Tm, or LaOCl:Tm), a barium sulfate-type phosphor [for exmple, BaSO₄:Pb, BaSO₄:Eu²⁺, or (Ba, Sr) SO₄: Eu²⁺], a divalent europium-activated alkaline earth metal phosphate-type phosphor [for example, (Ba₂PO₄)₂:Eu²⁺, or (Ba₂PO₄)₂:Eu²⁺], a divalent europium-activated alkaline earth metal fluorohalogenide-type phosphor [for example, BaFCl:Eu²⁺, BaFBr:Eu²⁺, BaFCl:Eu²⁺, Tb, BaFBr:Eu²⁺, Tb, BaF₂.BaCl.KCl:Eu²⁺, or (Ba,Mg)F₂.BaCl.KCl:Eu²⁺], an iodide-type phosphor (for example, CsI:Na, CsI:TI, NaI, or KI:TI), sulfide-type phosphor (for example, ZnS:Ag(Zn, Cd)S:Ag, (Zn, Cd)S:Cu, or (Zn, Cd)S:Cu, Al), and a hafnium phosphate-type phosphor (for example, HfP₂O₇: Cu), YTaO₄, and YTaO₄ added with any one of various types of activators as a luminescence center. However, the present invention is by no means limited thereto and any types of phosphors can be used, so long as they can emit visible light or light in a near-ultraviolet region by radiation.

The fluorescent intensifying paper according to the present invention is preferably filled with the phosphor in a gradient diameter structure. Particularly, it is preferable that a phosphor grain having a large diameter is applied on the side of the surface protective layer and the phosphor grain having a small diameter is supplied on the side of the support. It is preferable that the small diameter is in the range of 0.5 μm to 2.0 μm while the large diameter is in the range of 10 μm to 30 μm.

As image forming methods using the photothermographic material according to the present invention, a method in which an image is formed in combination with a phosphor having a main peak at preferably 400 nm or less and, more preferably, 380 nm or less can be used. Any one of the double-sided photosensitive material and the single-sided photosensitive material can be used as an assembly. As such screens each having a main peak at 400 nm or less, screens as described in, for example, JP-A No. 6-11804, and WO93/01521 can be used; however, the present invention is by no means limited thereto. As techniques of crossover-cut of the ultraviolet ray (for double-sided photosensitive material) and antihalation (for single-sided photosensitive material), those as described in JP-A No. 8-76307 can be used. As such ultraviolet ray-absorbing agents, a dye as described in JP-A No. 2001-144030 is particularly preferred.

2) Thermal Development

The photothermographic material according to the present invention may be developed by any method. Ordinarily, a temperature of the photothermographic material which has imagewise been exposed is raised to allow the photothermographic material to be developed. A development temperature is preferably in the range of 80° C. to 250° C., more preferably in the range of 100° C. to 140° C. and, still more preferably, in the range of 110° C. to 130° C.

A development time is preferably in the range of 1 second to 60 seconds, more preferably in the range of 3 seconds to 30 seconds, still more preferably in the range of 5 seconds to 25 seconds and, particularly preferably, in the range of 7 seconds to 15 seconds.

As methods for thermal development, any one of drum-type heater and a plate-type heater may preferably be used and, on this occasion, the plate-type heater is more preferably used. As the thermal development process utilizing the plate-type heater, a method as described in JP-A No. 11-133572 is preferable. The method uses a thermal development apparatus for obtaining a visible image by allowing the photothermographic material, in which a latent image has been formed, to come in contact with a heating unit in a thermal development portion. The heating unit, comprising a plate heater and a plurality of pressing rollers arranged opposite to one another along one surface of the plate heater, is characterized in that the photothermographic material is allowed to pass through between the pressing rollers and the plate heater and is thermally developed. It is preferable that the plate heater is divided into 2 to 6 steps, and that a temperature in the top step is lowered by approximately 1° C. to 10° C. For example, 4 sets of plate heaters which can separately control respective temperatures and, then, for example, control respective temperatures at 112° C., 119° C., 121° C. and 120° C. Such methods are also described in JP-A No. 54-30032. According to these methods, moisture and organic solvents contained in the photothermographic material can be removed out of a system, and deformation of the support of the photothermographic material to be caused by rapid heating can also be suppressed.

For a purpose of miniaturizing the thermal development apparatus and shortening the thermal development time, it is preferred that heater control can be performed in a more stable manner and it is desirable that exposure to a sheet of the photothermographic material is started from the leading end of the material and thermal development is started before the exposure is finished at the tail end of the material. The imager that is able to perform a rapid treatment preferred in the present invention is disclosed, for example, in JP-A Nos. 2002-289804 and 2002-287668. With use of this imager, thermal development treatment can be performed in 14 seconds with a 3-step plate heater controlled to 107° C.-121° C.-121° C., for example, and the output time of the first sheet can be shortened to about 60 seconds. As such a rapid development treatment, it is preferred to use in combination a thermal a photothermographic material of high sensitivity and less prone to be affected by the ambient temperature.

3) System

As laser imagers each having an exposure portion and a thermal development portion for the medical diagnosis use, Fuji Medical Dry Imager FM-DPL and Fuji Medical Dry Imager DRYPIX 7000 (both being trade name; manufactured by Fuji Photo Film Co., Ltd.) can be mentioned. Such systems are described in Fuji Medical Review No. 8, pp. 39 to 55. Techniques described therein can be applied not only as a laser imager of the photothermographic material according to the present invention, but as a photothermographic material for the laser imager in “AD network” proposed by Fuji Film Medical Systems as a network system adapted to DICOM Standards.

3. Application of the Present Invention

The photothermographic material according to the present invention forms a black-and-white image based on a silver image and is preferably used as a photothermographic material for medical diagnosis, a photothermographic material for industrial photography, a photothermographic material for printing use and a photothermographic material for COM use.

### EXAMPLES

Hereinafter, the present invention is specifically described with reference to embodiments but is not limited thereto.

### Example 1

(Preparation of PET Support)

1) Film Forming

PET having an intrinsic viscosity IV=0.66 (measured at 25° C. in phenol/tetrachloroethane=6/4 (ratio by weight)) was obtained in accordance with an ordinary preparation method by using terephthalic acid and ethylene glycol. After the thus-obtained PET is pelletized, the resultant pellets were dried at 130° C. for 4 hours. Then, the thus-dried pellets were extruded from a T-type die after melted at 300° C., and rapidly quenched, to thereby prepare an unstretched film.

The thus-prepared film was stretched up to 3.3 times in the machine direction with rollers having different peripheral velocities, then up to 4.5 times in the transverse direction by means of a tenter. The temperatures at the time of such stretching were 110° C. and 130° C. in the above sequence. Subsequently, the thus-stretched film was subjected to thermal fixation at 240° C. for 20 seconds and, then, to relaxation by 4% in the transverse direction at the same temperature as at the thermal fixation. Thereafter, chucking portions of the tenter were slit off, and both edges of the film were subjected to knurl processing. The film was rolled at 4 kg/cm² to obtain a roll of film having a thickness of 175 μm.

2) Corona Discharge Surface Treatment

Both surfaces of the support were treated at room temperature at the handling velocity of 20 m/min by using a solid-state corona discharge processor Model 6KVA manufactured by Pillar Co. From values of electric current and voltage read at that time, it was found that a treatment of 0.375 kV·A·min/m² was applied to the support. A treatment frequency was 9.6 kHz and a gap clearance between an electrode and a dielectric roll was 1.6 mm.

3) Undercoat

Prescription-1 (For Undercoat Layer on the Side of Image Forming Layer)

| | | |
|---|---|---|
| Pesresin A-520 (30% by mass solution) manufactured by | 46.8 | g |
| Takamatsu Oil & Fat, Inc. | | |
| VYLONAL MD-1200 manufactured by Toyobo Co., Ltd. | 10.4 | g |
| Polyethylene glycol monononylphenyl ether (average number | 11.0 | g |
| of ethylene oxide = 8.5; 1% by mass solution) | | |
| MP-1000 (PMMA polymeric fine grains; average grain | 0.91 | g |
| diameter: 0.4 μm) manufactured by Soken Kagaku Co., Ltd. | | |
| Distilled water | 931 | ml |

Prescription-2 (For Back Face First Layer)

| | | |
|---|---|---|
| Styrene/butadiene copolymer latex (solid content: 40% by | 130.8 | g |
| mass; weight ratio of styrene/butadiene = 68/32) | | |
| Sodium salt of 2,4-dichloro-6-hydroxy-S-triazine (8% by mass | 5.2 | g |
| aqueous solution) | | |
| Sodium laurylbenzene sulfonate (1% by mass aqueous | 10 | ml |
| solution) | | |
| Polystyrene grain dispersion (average grain diameter: 2 μm; | 0.5 | g |
| 20% by mass) | | |
| Distilled water | 854 | ml |

Prescription-3 (For Back Face Second Layer)

| | |
|---|---|
| SnO₂/SbO (9/1 mass ratio; average grain diameter: | 84 g |
| 0.5 μm; 17% by mass dispersion) | |
| Gelatin | 7.9 g |
| Metolose TC-5 (2% by mass aqueous solution) manufactured | 10 g |
| by Shin-Etsu Chemical Co., Ltd. | |
| Sodium dodecylbenzene sulfonate (1% by mass | 10 ml |
| aqueous solution) | |
| NaOH (1% by mass) | 7 g |
| Proxel manufactured by Avecia K.K. | 0.5 g |
| Distilled water | 881 ml |

After the corona discharge treatment was performed on both faces of the resultant biaxially stretched polyethylene terephthalate support having a thickness of 175 μm, the undercoating solution of the prescription-1 was applied on one face (image forming layer side) thereof by means of a wire-bar in a wet coated amount of 6.6 ml/m² (per face) and dried at 180° C. for 5 minutes. Then, the undercoating solution of the prescription-2 was applied on the opposite face (back face) by means of a wire-bar in a wet coated amount of 5.7 ml/m² and dried at 180° C. for 5 minutes. Further, the undercoating solution of the prescription-3 was applied on the opposite face (back face) by means of a wire-bar in a wet coated amount of 8.4 ml/m² and dried at 180° C. for 6 minutes, to thereby prepare an undercoated support.

(Back Layer)

1) Preparation of Coating Solution for Back Layer

(Preparation of Solid Fine Grain Dispersion (a) of Base Precursor)

2.5 kg of a base precursor compound-1, 300 g of a surface active agent DEMOL N (trade name; manufactured by Kao Corporation), 800 g of diphenylsulfone, 1.0 g of sodium benzisothiazolinone and such an amount of distilled water as to make an entire amount to 8.0 kg were mixed. The resultant mixture was dispersed by using beads media by means of a horizontal sand mill UVM-2 (trade name; manufactured by Imex Co., Ltd.). A dispersion was performed by a method comprising sending the mixture into the UVM-2 filled with zirconia beads having an average diameter of 0.5 mm by means of a diaphragm pump and dispersing the mixture under a condition of an inner pressure of 50 hPa or more until a desired average diameter was obtained.

The resultant dispersion was further dispersed until a ratio (D450/D650) of absorbance at 450 nm to absorbance at 650 nm came to be 3.0 when a spectral absorption measurement was performed on spectral absorption of the dispersion. The resultant dispersion was diluted with distilled water until a concentration of the base precursor came to be 25% by weight and, then, filtered (polypropylene-made filter: average pore diameter being 3 μm) for removing dust or the like and, thereafter, put to practical use.

2) Preparation of Dye Solid Fine Grain Dispersion

6.0 kg of a cyanine dye compound-1, 3.0 kg of sodium p-dodecylbenzene sulfonate, 0.6 kg of a surface active agent DEMOL SNB (trade name; manufactured by Kao Corporation), 0.15 kg of a defoaming agent SAFINOL 104E (trade name; manufactured by Nisshin Chemical Co., Ltd.) and such an amount of distilled water as to make an entire amount to 60 kg were mixed. The resultant mixture was dispersed by using zirconia beads of 0.5 mm by means of a horizontal sand mill UVM-2 (trade name; manufactured by Imex Co., Ltd.).

The resultant dispersion was further dispersed until a ratio (D650/D750) of absorbance at 650 nm to absorbance at 750 nm came to be 5.0 or more when a spectral absorption measurement was performed on spectral absorption of the dispersion. The resultant dispersion was diluted with distilled water until a concentration of the cyanine dye came to be 6% by weight and, then, filtered (filter: average pore diameter being 1 μm) for removing dust or the like and, thereafter, put to practical use.

3) Preparation of Coating Solution for Antihalation Layer

In a vessel maintained at 40° C., 40 g of gelatin, 0.1 g of benzisothiazolinone and 490 ml of water were added and, then, mixed until gelatin was dissolved. The resultant mixture was further added with 2.3 ml of a 1 mol/L aqueous solution of sodium hydroxide, 40 g of the dye solid fine grain dispersion, 90 g of the solid fine grain dispersion (a) of the above-described base precursor, 12 ml of a 3% by mass aqueous solution of sodium polystyrene sulfonate and 180 g of a 10% by mass solution of SBR latex. The resultant mixture was added with 80 ml of a 4% by mass aqueous solution of N,N-ethylenebis(vinylsulfone acetamide) immediately before coating, to thereby prepare a coating solution for an antihalation layer.

4) Preparation of Coating Solution for Back Face Protective Layer

<<Preparation of Coating Solution-1 for Back Face Protective Layer>>

In a vessel maintained at 40° C., 40 g of gelatin, 35 mg of benzisothiazolinone and 840 ml of water were added and, then, mixed until gelatin was dissolved. The resultant mixture was further added with 5.8 ml of a 1 mol/L aqueous solution of sodium hydroxide, 5 g of a 10% by mass emulsion of liquid paraffin, 5 g of a 10% by mass emulsion of trimethylol propane triisostearate, 10 ml of a 5% by mass aqueous solution of sodium sulfosuccinate di(2-ethylhexyl), 20 ml of a 3% by mass aqueous solution of sodium polystyrene sulfonate, 2.4 ml of a 2% by mass solution of a fluorine-type surface active agent (F-1), 2.4 ml of a 2% by mass solution of a fluorine-type surface active agent (F-2) and 32 g of a 19% by mass solution of a latex of methyl methacrylate/styrene/butyl acrylate/hydroxyethyl methacrylate/acrylic acid copolymer (weight ratio of copolymerization: 57/8/28/5/2). The resultant mixture was added with 25 ml of a 4% by mass aqueous solution of N,N-ethylene-bis(vinylsulfone acetamide) immediately before coating, to thereby prepare a coating solution for a back face protective layer.

5) Coating of Back Layer

On the side of the back face of the thus-undercoated support, the coating solution for the antihalation layer and the coating solution for the back face protective layer were applied in a simultaneous superposition coating such that amounts of gelatin in those coating solutions to be applied came to be 0.52 g/m² and 1.7 g/m², respectively.

(Image Forming Layer, Intermediate Layer and Surface Protective Layer)

1. Preparation of Material for Coating

1) Photosensitive Silver Halide Emulsion

<<Preparation of Photosensitive Silver Halide Emulsion-1>>

0.8 g of KBr and 1178 ml of an aqueous solution containing 3.2 g of gelatin having an average molecular weight of 20000 which had been subjected to an oxidation treatment were stirred while being kept at 35° C. To the resultant mixture, respective aqueous solutions of 1.6 g of silver nitrate, 1.16 g of KBr and 1.1 g of gelatin having an average molecular weight of 20000 which had been subjected to the oxidation treatment were added by a triple-jet method consuming 45 seconds. A concentration of silver nitrate in the resultant mixture was 0.3 mol/L. The mixture was heated to 76° C. consuming 20 minutes and, then, added with 26 g of succinated gelatin having an average molecular weight of 100000 and, thereafter, added with an aqueous solution containing 209 g of silver nitrate and an aqueous KBr solution while keeping a pAg value at 8.0 and accelerating a flow rate by a controlled-double-jet method consuming 75 minutes. After being added with gelatin having an average molecular weight of 100000, the resultant mixture was desalted in accordance with an ordinary method and, then, added with gelatin having an average molecular weight of 100000 while allowing it to be dispersed and, thereafter, adjusted so as to have a pH value of 5.8 and a pAg value of 8.0 at 40° C., to thereby obtain an emulsion. It has been found that the thus-obtained emulsion contained one mol of silver and 40 g of gelatin based on 1 kg of the emulsion and that silver halide grains therein were tabular grains having an average projected area diameter of 0.97 μm, a coefficient of variation of a projected area diameter of 19.1%, an average thickness of 0.12 μm and an average aspect ratio of 8.1.

<<Preparation of Photosensitive Silver Halide Emulsion-2>>

A photosensitive silver halide emulsion-2 was prepared in the same manner as in the photosensitive silver halide emulsion-1 except for appropriately changing the temperature at the time of forming grains and the addition time of each of the aqueous solution containing 209 g of silver nitrate and an aqueous KBr solution.

It has been found that silver halide grains of the thus-prepared photosensitive silver halide emulsion-2 were tabular grains having an average projected area diameter of 0.88 μm, a coefficient of variation of a projected area diameter of 18.0%, an average thickness of 0.29 μm and an average aspect ratio of 3.0.

<<Preparation of Photosensitive Silver Halide Emulsion-3>>

A photosensitive silver halide emulsion-3 was prepared in the same manner as in the photosensitive silver halide emulsion-1 except for appropriately changing the temperature at the time of forming grains and the addition time of each of the aqueous solution containing 209 g of silver nitrate and the aqueous KBr solution.

It has been found that silver halide grains of the thus-prepared photosensitive silver halide emulsion-3 were tabular grains having an average projected area diameter of 0.93 μm, a coefficient of variation of a projected area diameter of 17.8%, an average thickness of 0.055 μm and an average aspect ratio of 16.9.

Each emulsion thus prepared was subjected to chemical sensitization while kept stirring at 56° C.

Firstly, the emulsion was added with 1×10⁻⁴ mol, based on 1 mol of silver halide, of a thiosulfonic acid compound-1 and, then, added with 0.15% by mol, based on an entire silver amount, of AgI grains having a size of 0.03 μm. Three minutes after such additions, the resultant mixture was added with 1×10⁻⁶ mol/Ag mol of thiourea dioxide and kept to stand for 22 minutes as it was to allow a reduction sensitization to be performed. Next, the thus-reduction-sensitized mixture was added with 3×10⁻⁴ mol equivalent, based on 1 mol of silver halide, of 4-hydroxy-6-6-methyl-1,3,3a,7-tetrazaindene, 1×10⁻⁴ mol equivalent, based on 1 mol of silver halide, of each of sensitizing dyes-1 and -2 to be described below and calcium chloride.

Subsequently, the resultant mixture was added with 6×10⁻⁶ mol equivalent, based on 1 mol of silver halide, of sodium thiosulfate and 4×10⁻⁶ mol equivalent, based on 1 mol of silver halide, of a selenium compound-1 and, then, added with 2×10⁻³ mol equivalent, based on 1 mol of silver halide, of chloroauric acid and, thereafter, added with 67 mg equivalent, based on 1 mol of silver halide, of nucleic acid (trade name: RNA-F; manufactured by Sanyo-Kokusaku Pulp Co., Ltd.). Forty minutes after such additions, the resultant mixture was added with 1×10⁻⁴ mol equivalent, based on 1 mol of silver halide, of a water-soluble mercapto compound-1 and, then, cooled to 35° C., to thereby terminate the chemical sensitization.

<Preparation of Emulsions-1 to -3 for Coating Solution>

Each of the silver halide emulsions-1 to -3 was dissolved and, then, added with 7×10⁻³ mol, based on 1 mol of silver, of a 1% by mass aqueous solution of benzothiazolium iodide and, thereafter, added with each of compounds 1, 2 and 3 in which a one-electron-oxidized form generated by oxidizing one electron therein can release one or more electrons such that each of the compounds is allowed to be 2×10⁻³ mol based on 1 mol of silver of silver halide and, further, added with each of compounds 1 and 2 having an adsorptive group and a reducing group, such that each of the compounds is allowed to be 8×10⁻³ mol based on 1 mol of silver halide and, still further, added with water such that a silver halide content per liter of the emulsion for the coating solution is allowed to be 15.6 g in terms of silver.

2) Preparation of Non-Photosensitive Organic Silver Salt Dispersion B

<Preparation of Recrystllized Behenic Acid B>

100 kg of behenic acid (product name: Edenor C22-85R; manufactured by Henkel Co.) was added to 1200 kg of isopropyl alcohol, dissolved therein at 50° C., filtered by a filter of 10 μm, and cooled to 30° C., to thereby be recrystallized. A cooling speed at the time of such recrystallization was controlled to be 3° C./hour. Such crystal obtained in a manner as described above was subjected to centrifugal filtration, rinsed with 100 kg of isopropyl alcohol in a sprinkling manner, and dried. The thus-dried crystal was esterified and subjected to a GC-FID measurement to find that the crystal contained 96% by mol of silver behenate, 2% by mol of lignoceric acid, 2% by mol of arachidic acid, and 0.001% by mol of erucic acid.

<Preparation of Non-Photosensitive Organic Silver Salt Dispersion B>

88 kg of the thus-recrystallized behenic acid B, 422 L of distilled water, 49.2 L of an aqueous solution of NaOH having a concentration of 5 mol/L and 120 L of t-butyl alcohol were mixed and, then, while being kept stirring at 75° C. for 1 hour, allowed to react with one another, to thereby obtain a sodium behenate solution B. Separately, 206.2 L of an aqueous solution (pH: 4.0) containing 40.4 kg of silver nitrate was prepared and maintained at 10° C. A reaction vessel filled with 635 L of distilled water and 30 L of t-butyl alcohol was maintained at 30° C. and, then, while being kept sufficiently stirring, added with an entire amount of the foregoing sodium behenate solution B and an entire amount of the foregoing silver nitrate aqueous solution at a constant flow rate consuming 93 minutes 15 seconds and 90 minutes, respectively. At that time, the silver nitrate aqueous solution was solely added for 11 minutes after the addition of the silver nitrate aqueous solution was started. After that, the addition of the sodium behenate solution B was started. For 14 minutes 15 seconds after the addition of the silver nitrate aqueous solution was completed, the sodium behenate solution B was solely added. At that time, a temperature inside the reaction vessel was maintained at 30° C. and a solution temperature was maintained constant by means of an external temperature control. Further, piping of an addition system for the sodium behenate solution B was warmed by circulating warm water in an outer portion of a double-walled tube so that the solution temperature at an outlet of an addition nozzle tip was adjusted to be 75° C. Piping of an addition system of the aqueous silver nitrate solution was also heat-controlled by circulating cold water in an outer portion of a double-walled tube. Positions where the sodium behenate solution B and the aqueous silver nitrate solution were added were arranged symmetrically in relation to a stirring shaft in the center, and respective heights of the positions were adjusted such that they do not touch a reaction solution.

After the addition of the sodium behenate solution B was completed, the resultant reaction solution was held at a temperature thereof as it was for 20 minutes with stirring and, then, the temperature was raised to 35° C. consuming 30 minutes. After that, the reaction solution was ripened for 210 minutes. Immediately after such ripening, the solid content was separated by centrifugal filtration and, then, the thus-separated solid content was rinsed with water until electrical conductivity of the filtrate reached 30 μS/cm. Thus, a non-photosensitive organic silver salt was obtained. The thus-obtained solid content was stored as a wet cake without drying.

Shapes of silver behenate grains thus obtained were evaluated by electron microscopic photography. The obtained silver behenate grains were crystals having average values of a=0.21 μm, b=0.4 μm and c=0.4 μm, an average aspect ratio of 2.1 and a coefficient of variation of a sphere-equivalent diameter of 11% (a, b and c were defined according to respective definitions previously described herein).

19.3 kg of polyvinyl alcohol (trade name: PVA-217; manufactured by Kuraray Co., Ltd.) and water were added to the thus-stored wet cake corresponding to 260 kg of dried solid content to make an entire amount of the resultant mixture to 1,000 kg and, then, the resultant mixture was changed into a slurry by means of dissolver-blades. Further, the slurry was preliminarily dispersed with a pipeline-mixer (Model PM-10; manufactured by Mizuho Industrial Co., Ltd.).

Then, the thus-preliminarily-dispersed starting solution was processed three times with a dispersing machine (trade name: Microfluidizer M-610 equipped with a Z-type interaction chamber; manufactured by Microfluidex International Corporation) under a pressure adjusted to 1,150 kg/cm², to thereby obtain a silver behenate dispersion. A dispersion temperature was set at 18° C. by adjusting a temperature of coolant such that a cooling operation was performed by using coiled heat exchangers installed in front and rear of the interaction chamber, respectively.

3) Preparation of Reducing Agent Dispersion

<<Preparation of Reducing Agent-1 Dispersion>>

10 kg of water was added to 10 kg of a reducing agent-1 (2,2′-methylenebis(4-ethyl-6-tertbutyl phenol) and 16 kg of a 10% by mass aqueous solution of modified polyvinylalcohol (trade name: POVAL MP203; manufactured by Kuraray Co. Ltd.). The resultant mixture was thoroughly mixed to form a slurry. The slurry was fed by means of a diaphragm pump into a horizontal sand mill UVM-2 (trade name; manufactured by Imex Co., Ltd.) filled with zirconia beads having an average diameter of 0.5 mm, and dispersed therein for 3 hours. Then, 0.2 g of a sodium salt of benzisothiazolinone and water were added to the resultant dispersion so as to allow a concentration of the reducing agent to be 25% by mass. The resultant dispersion was heated at 60° C. for 5 hours, to thereby obtain a reducing agent-1 dispersion. Reducing agent grains contained in the thus-obtained reducing agent-1 dispersion had a median diameter of 0.40 μm and a maximum grain diameter of 1.4 μm or less. The reducing agent-1 dispersion was filtrated with a filter made of polypropylene having a pore diameter of 3.0 μm to remove foreign matters such as dust and, then, stored.

<<Preparation of Reducing Agent-2 Dispersion>>

10 kg of water was added to 10 kg of a reducing agent-2 (6,6′-di-t-butyl-4,4′-dimethyl-2,2′-butylidene diphenol), and 16 kg of a 10% by mass aqueous solution of modified polyvinylalcohol (trade name: POVAL MP203; manufactured by Kuraray Co. Ltd.). The resultant mixture was thoroughly mixed to form a slurry. The slurry was fed by means of a diaphragm pump into a horizontal sand mill UVM-2 (trade name; manufactured by Imex Co., Ltd.) filled with zirconia beads having an average diameter of 0.5 mm, and dispersed for 3 hours 30 minutes. Then, 0.2 g of a sodium salt of benzisothiazolinone and water were added to the resultant dispersion so as to allow a concentration of the reducing agent to be 25% by mass. The resultant dispersion was heated at 40° C. for one hour and, subsequently, at 80° C. for one hour, to thereby obtain a reducing agent-2 dispersion. Reducing agent grains contained in the thus-obtained reducing agent-2 dispersion had a median diameter of 0.50 μm and a maximum grain diameter of 1.6 μm or less. The reducing agent-2 dispersion was filtrated with a filter made of polypropylene having a pore diameter of 3.0 μm to remove foreign matters such as dust and, then, stored.

4) Preparation of Hydrogen Bonding Compound-1 Dispersion

10 kg of water was added to 10 kg of a hydrogen bonding compound-1 (tri(4-t-butylphenyl)phosphine oxide), and 16 kg of a 10% by mass aqueous solution of modified polyvinylalcohol (trade name: POVAL MP203; manufactured by Kuraray Co., Ltd.). The resultant mixture was thoroughly mixed to form a slurry. The slurry was fed by means of a diaphragm pump into a horizontal sand mill UVM-2 (trade name; manufactured by Imex Co., Ltd.) filled with zirconia beads having an average diameter of 0.5 mm, and dispersed for 4 hours. Then, 0.2 g of a sodium salt of benzisothiazolinone and water were added to the resultant dispersion so as to allow a concentration of the hydrogen bonding compound to be 25% by mass. The resultant dispersion was heated at 40° C. for one hour and, subsequently, at 80° C. for one hour, to thereby obtain a hydrogen bonding compound-1 dispersion. Hydrogen bonding compound grains contained in the thus-obtained hydrogen bonding compound-1 dispersion had a median diameter of 0.45 μm and a maximum grain diameter of 1.3 μm or less. The hydrogen bonding compound-1 dispersion was filtrated with a filter made of polypropylene having a pore diameter of 3.0 μm to remove foreign matters such as dust and, then, stored.

5) Preparation of Development Accelerator-1 Dispersion

10 kg of water was added to 10 kg of a development accelerator-1, and 20 kg of a 10% by mass aqueous solution of modified polyvinylalcohol (trade name: POVAL MP203; manufactured by Kuraray Co., Ltd.). The resultant mixture was thoroughly mixed to form a slurry. The slurry was fed by means of a diaphragm pump into a horizontal sand mill UVM-2 (trade name; manufactured by Imex Co., Ltd.) filled with zirconia beads having an average diameter of 0.5 mm, and dispersed for 3 hours 30 minutes. Then, 0.2 g of a sodium salt of benzisothiazolinone and water were added to the resultant dispersion so as to allow a concentration of the development accelerator to be 20% by mass, to thereby obtain a development accelerator-1 dispersion. Development accelerator grains contained in the thus-obtained development accelerator-1 dispersion had a median diameter of 0.48 μm and a maximum grain diameter of 1.4 μm or less. The development accelerator-1 dispersion was filtrated with a filter made of polypropylene having a pore diameter of 3.0 μm to remove foreign matters such as dust and, then, stored.

6) Preparation of Dispersions of Development Accelerator-2 and Color Tone Adjusting Agent-1

Solid dispersions of a development accelerator-2 and a color tone adjusting agent-1 were dispersed in the same manner as in the development accelerator-1, to thereby obtain 20% by mass and 15% by mass dispersions, respectively.

7) Preparation of Polyhalogen Compound

<<Preparation of Organic Polyhalogen Compound-1 Dispersion>>14 kg of water was added to 10 kg of an organic polyhalogen compound-1 (tribromomethane sulfonylbenzene), 10 kg of a 20% by mass aqueous solution of modified polyvinylalcohol POVAL MP203 (trade name; manufactured by Kuraray Co., Ltd.), and 0.4 kg of a 20% by mass aqueous solution of sodium triisopropylnaphthalene sulfonate. The resultant mixture was thoroughly mixed to form a slurry. The slurry was fed by means of a diaphragm pump into a horizontal sand mill UVM-2 (trade name; manufactured by Imex Co., Ltd.) filled with zirconia beads having an average diameter of 0.5 mm, and dispersed for 5 hours. Then, 0.2 g of a sodium salt of benzisothiazolinone and water were added to the resultant dispersion so as to allow a concentration of the organic polyhalogen compound to be 26% by mass, to thereby obtain an organic polyhalogen compound-1 dispersion. Organic polyhalogen compound grains contained in the thus-obtained organic polyhalogen compound-1 dispersion had a median diameter of 0.41 μm and a maximum grain diameter of 2.0 μm or less. The organic polyhalogen compound dispersion was filtrated with a filter made of polypropylene having a pore diameter of 10.0 μm to remove foreign matters such as dust and, then, stored.

<<Preparation of Organic Polyhalogen Compound-2 Dispersion>>

10 kg of an organic polyhalogen compound-2 (N-butyl-3-tribromomethane sulfonylbenzamide), 20 kg of a 10% by mass aqueous solution of modified polyvinylalcohol POVAL MP203 (trade name; manufactured by Kuraray Co., Ltd.) and 0.4 kg of a 20% by mass aqueous solution of sodium triisopropylnaphthalene sulfonate was thoroughly mixed, to thereby form a slurry. The slurry was fed by means of a diaphragm pump into a horizontal sand mill UVM-2 (trade name; manufactured by Imex Co., Ltd.) filled with zirconia beads having an average diameter of 0.5 mm, and dispersed for 5 hours. Then, 0.2 g of a sodium salt of benzisothiazolinone and water were added to the resultant dispersion so as to allow a concentration of the organic polyhalogen compound to be 30% by mass. The resultant dispersion was heated at 40° C. for 5 hours, to thereby obtain an organic polyhalogen compound-2 dispersion. Organic polyhalogen compound grains contained in the thus-obtained organic polyhalogen compound-2 dispersion had a median diameter of 0.40 μm and a maximum grain diameter of 1.3 μm or less. The organic polyhalogen compound-2 dispersion was filtrated with a filter made of polypropylene having a pore diameter of 3.0 μm to remove foreign matters such as dust and, then, stored.

8) Preparation of Phthalazine Compound-1 Solution

8 kg of modified polyvinylalcohol (trade name: MP203; manufactured by Kuraray Co., Ltd.) was dissolved in 174.57 kg of water. Then, 3.15 kg of a 20% by mass aqueous solution of sodium triisopropylnaphthalene sulfonate and 14.28 kg of a 70% by mass aqueous solution of a phthalazine compound-1 (6isopropylphthalazine) were added to the resultant solution, to thereby prepare a 5% by mass solution of the phthalazine compound-1.

9) Preparation of Mercapto Compound

<<Preparation of Aqueous Solution of Mercapto Compound-1>>

7 g of a mercapto compound-1 (sodium salt of 1-3-sulfophenyl)-5-mercaptotetrazole) was dissolved in 993 g of water, to thereby prepare a 0.7% by mass aqueous solution.

<<Preparation of Mercapto Compound-2>>

20 g of a mercapto compound-2 (1-(3-methylureidophenyl)-5-mercaptotetrazole) was dissolved in 980 g of water, to thereby prepare a 2.0% by mass aqueous solution.

10) Preparation of Pigment-1 Dispersion

250 g of water was added to 64 g of C.I. Pigment Blue 60 and 6.4 g of DEMOL N (trade name; manufactured by Kao Corporation). Then, the resultant mixture was thoroughly mixed to form a slurry. 800 g of zirconia beads having an average diameter of 0.5 mm was prepared and fed in a vessel together with the slurry. The slurry was dispersed for 25 hours with a dispersing machine ¼ G Sand-Grinder Mill (trade name; manufactured by Imex Co., Ltd.) and, then, added with water to allow a concentration of such pigment to be 5% by mass, to thereby obtain a pigment-1 dispersion. Pigment grains contained in the thus-obtained pigment-1 dispersion had an average grain diameter of 0.21 μm.

11) Preparation of Binder Solution

<<Preparation of Binder Solution-1>>

A 16% by mass aqueous solution of inert gelatin was prepared by dissolving inert gelatin for one hour at 60° C.

<<Preparation of Binder Solution-2>>

An SBR latex was prepared in a manner as described below.

287 g of distilled water, 7.73 g of a surface active agent PIONIN A-43-S (trade name; solid content: 48.5% by mass; manufactured by Takemoto Oil & Fat Co., Ltd.), 14.06 ml of 1 mol/L NaOH, 0.15 g of tetra sodium ethylene diamine tetraacetate, 255 g of styrene, 11.25 g of acrylic acid, and 3.0 g of tert-dodecylmercaptan were loaded in a polymerization vessel of a gas monomer reaction apparatus TAS-2J TYPE (trade name; manufactured by Taiatsu Techno Corporation) and, after the vessel was hermetically sealed, stirred at a stirring rate of 200 rpm. The vessel was vacuumized by a vacuum pump and, after being purged with nitrogen gas several times, fed with 108.7 g of 1,3-butadiene with pressure and, then, a temperature inside the vessel was raised to 60° C. Thereafter, a solution in which 1.875 g of ammonium persulfate was dissolved in 50 ml of water was added in the vessel and stirred for 5 hours as it was. A temperature of the resultant content was further raised to 90° C. and, then, stirred for 3 hours. After a reaction is completed, the inside temperature of the vessel was lowered to room temperature and a pH value of the content was adjusted to be 8.4 by performing an addition treatment on the content by using a 1 mol/L aqueous solution of each of NaOH and NH₄OH such that a relation of Na⁺ ion:NH₄⁺ ion=1:5.3 (in molar ratio) is established. Then, the content was filtrated with a filter made of polypropylene having a pore diameter of 1.0 μm to remove foreign matters such as dust and, then, stored; accordingly, 774.7 g of an SBR latex was obtained. When a halogen ion concentration was measured by using ion chromatography, a chloride ion concentration was 3 ppm. When a chelating agent concentration was measured by high-speed liquid chromatography, the result was 145 ppm.

Properties of the thus-obtained latex were as follows:
an average grain diameter, 90 nm, Tg 17° C.; a solid content: 44% by mass, an equilibrium moisture content at 25° C. 60% RH: 0.6% by mass; and ionic conductance 4.80 mS/cm (an ionic conductance measurement was conducted on a latex starting solution of 44% by mass at 25° C. by using a diagometer CM-30S (trade name; manufactured by Toa Denpa Kogyo Co., Ltd.))

<<Preparation of Binder Solution-3>>

An SBR latex in which Tg=45° C. was prepared in the same manner as in the binder solution-2 except for changing ratios of styrene and butadiene. Equilibrium moisture content at 25° C. 60% RH of the thus-obtained SBR latex was 0.7% by mass.

<<Preparation of Binder Solution-4>>

An acrylic latex was prepared in a manner as described below.

296 g of distilled water, 10.89 g of a surface active agent (solid content: 27.6% by mass; prepared by purifying SANDET BL (trade name; manufactured by Sanyo Chemical Industries, Ltd.) by using MICRO ACILYZER G3 (film: AC110-800; manufactured by Asahi Chemical Industry Co., Ltd.) until electric conductance came to be consistent), 15 ml of a 1 mol/L aqueous solution of NaOH, 0.3 g of nitrilotriacetic acid, 135 g of methyl methacrylate, 150 g of butyl acrylate, 12 g of sodium styrene sulfonate, 3 g of methyl bisacrylamide and 2.4 g of tert-dodecyl mercaptan were added to a 3-necked flask equipped with a stirrer and a cooling tube and, then, a temperature inside the flask was raised to 60° C. while the resultant mixture was stirred at a stirring rate of 200 rpm in a flow of a nitrogen gas. Thereafter, a solution in which 0.6 g of sodium persulfate was dissolved in 40 ml of water was added in the flask and, then, the resultant mixture was stirred for 5 hours as it was. A temperature inside the flask was further raised to 90° C. and, subsequently, the resultant mixture was stirred for 3 hours. After a reaction is completed, the inside temperature of the flask was lowered to room temperature and, then, Na+ ion: NH₄+ ion=1:3 (in molar ratio) was established by an addition treatment by using a 1 mol/L aqueous solution of each of NaOH and NH₄OH, to thereby adjust a pH value of the mixture to be 8.4. Thereafter, the mixture was filtered with a filter made of polypropylene having a pore diameter of 1.0 μm to remove foreign matters such as dust and, then, stored; accordingly, 622 g of an acrylic latex (solid content: 45% by mass; grain size: 108 nm; a mass average molecular weight: 140000; and Tg: 5° C.) was obtained. When a halogen ion concentration was measured by using ion chromatography, a chloride ion concentration was 10 ppm. When a chelating agent concentration was measured by using high-speed liquid chromatography, the result was 450 ppm. Equilibrium moisture content at 25° C. 60% RH of the thus-obtained acrylic latex was 0.9% by mass.

2. Preparation of Coating Solution

1) Preparation of Coating Solution-1 for Image Forming Layer

1000 g of the above-obtained fatty acid silver salt dispersion B, 1350 ml of water, 36 g of the pigment-1 dispersion, 25 g of the organic polyhalogen compound-1 dispersion, 39 g of the organic polyhalogen compound-2 dispersion, 171 g of the phthalazine compound-1 solution, 2624 g of the binder solution-1, 153 g of the reducing agent-2 dispersion, 55 g of hydrogen boding compound-1 dispersion, 4.8 g of the development accelerator-1 dispersion, 5.2 g of the development accelerator-2 dispersion, 2.1 g of the color tone adjusting agent-1 dispersion and 8 ml of the mercapto compound-2 aqueous solution were mixed in the stated order and, then, 140 g of a photosensitive silver halide mixed emulsion A for coating was added to the resultant mixture immediately before it was applied and, thereafter, thoroughly mixed to obtain a coating solution for the image forming layer which was, then, directly fed to a coating die and applied.

Viscosity of the thus-obtained coating solution for the image forming layer was measured by using a B-type viscometer (available from Tokyo Keiki K.K.) at 40° C. (No. 1 rotor; 60 rpm) and found to be 40 mPa.s.

Viscosities of the coating solution measured under shearing velocities of 0.1, 1, 10, 100 and 1,000 (1/second) at 38° C. by using RHEOSTRESS® RS150 (available from Haake) were 78, 86, 70, 61 and 43 mPa.s, respectively.

Further, an amount of zirconium in the coating solution was 0.30 mg based on 1 g of silver.

<<Preparation of Coating Solutions-2 to -12 for Image Forming Layer>>

Coating solutions-2 to 12 for the image forming layer were prepared in the same manner as in the coating solution-1 for the image forming layer except for changing the photosensitive silver halide emulsion and the binder solution by a same weight as a solid content as shown in Table 1.

2) Preparation of Coating Solution for Intermediate Layer

1000 g of polyvinyl alcohol PVA-205 (trade name; manufactured by Kuraray Co., Ltd.), 163 g of the pigment-1 dispersion, 33 g of a 18.5% by mass solution of the blue dye compound-1 KAYAFECT TURQUOISE RN LIQUID 150 (trade nme; manufactured by Nippon Kayaku Co., Ltd.), 27 ml of a 5% by mass solution of sodium salt of sulfosuccinic acid di(2-ethylhexyl), 4200 ml of a 19% by mass solution of a latex of methyl methacrylate/styrene/butyl acrylate/hydroxyethyl methacrylate/acrylic acid copolymer (weight ratio of copolymerization: 57/8/28/5/2) and 27 ml of a 5% by mass aqueous solution of Aerosol OT (trade name; available from American Cyanamide Corporation), 135 ml of a 20% by mass aqueous solution of diammonium phthalate and such an amount of water as to make an entire amount to 10000 g were mixed and, then, a pH value of the resultant mixture was adjusted to be 7.5 by using NaOH; accordingly, a coating solution for an intermediate layer was prepared. Then, the thus-prepared coating solution for the intermediate layer was fed to a coating die such that a coating amount came to be 8.1 ml/m².

Viscosity of the coating Solution measured at 40° C. using a B-type viscometer (No. 1 rotor; 60 rpm) was 58 mPa.s.

3) Preparation of Coating Solution for First Layer of Surface Protective Layer

100 g of inert gelatin and 10 mg of benzisothiazolinone were dissolved in 840 ml of water and, then, to the resultant solution, 180 g of a 19% by mass solution of a latex of methyl methacrylate/styrene/butyl acrylate/hydroxyethyl methacrylate/acrylic acid copolymer (weight ratio of copolymerization: 57/8/28/5/2), 46 ml of a 15% by mass methanol solution of phthalic acid and 5.4 ml of a 5% by mass aqueous solution of a sodium salt of sulfosuccinic acid di(2-ethylhexyl) were added and, then, immediately before coating, 40 ml of a 4% by mass solution of chrome alum was added to the resultant mixture by a static mixer, to thereby prepare a coating solution. Then, the thus-prepared coating solution was fed to a coating die such that a coating amount came to be 26.1 ml/m².

Viscosity of the coating solution measured at 40° C. by using a B-type viscometer (No. 1 rotor; 60 rpm) was 20 mPa.s.

4) Preparation of Coating Solution for Second Layer of Surface Protective Layer

100 g of inert gelatin and 10 mg of benzisothiazolinone were dissolved in 800 ml of water and, then, to the resultant solution, 40 g of a 10% by mass dispersion of liquid paraffin, 40 g of a 10% by mass dispersion of hexaisostearic acid pentaerythrityl, 180 g of a 19% by mass solution of a latex of methyl methacrylate/styrene/butyl acrylate/hydroxyethyl methacrylate/acrylic acid copolymer (weight ratio of copolymerization: 57/8/28/5/2), 40 ml of a 15% by mass methanol solution of phthalic acid, 5.5ml of a 1% by mass solution of the fluorine-type surface active agent (F-1), 5.5 ml of a 1% by mass solution of the fluorine-type surface active agent (F-2), 28 ml of a 5% by mass aqueous solution of a sodium salt of sulfosuccinic acid di(2-ethylhexyl), 4 g of polymethylmethacrylate fine grains (average grain diameter: 0.7 μm; volume weighted average distribution: 30%) and 21 g of polymethylmethacrylate fine grains (average grain diameter: 3.6 μm; volume weighted average distribution: 60%) were added, to thereby prepare a coating solution for the surface protective layer. Then, the thus-prepared coating solution was fed to a coating die such that a coating amount came to be 8.3 ml/m².

Viscosity of the coating solution measured at 40° C. by using a B-type viscometer (No. 1 rotor; 60 rpm) was 19 mPa.s.

3. Preparation of Photothermographic Material

1) Preparation of Photothermographic Material-1

On a face opposite to a back face, the coating solution-1 for the image forming layer, the coating solution for the intermediate layer, the coating solution for the first layer of the surface protective layer and the coating solution for a second layer of the surface protective layer were applied in a simultaneous superposition coating in the stated order from an undercoat face using a slide bead application method, to thereby prepare a sample of a photothermographic material. On this occasion, coating temperatures of the coating solutions for the image forming layer and the intermediate layer were adjusted to be 31° C., while coating temperatures of the coating solutions for the first and second layers of the surface protective layer were adjusted to be 36° C. and 37° C., respectively.

A coated amount (g/m²) of each compound in the image forming layer is shown below.

| | |
|---|---|
| Fatty acid silver salt | 5.27 |
| Pigment (C.I.Pigment Blue 60) | 0.036 |
| Polyhalogen compound-1 | 0.14 |
| Polyhalogen compound-2 | 0.28 |
| Phthalazine compound-1 | 0.18 |
| Gelatin | 8.49 |
| Reducing agent-2 | 0.77 |
| Hydrogen bonding compound-1 | 0.28 |
| Development accelerator-1 | 0.019 |
| Development accelerator-2 | 0.016 |
| Color tone adjusting agent-1 | 0.003 |
| Mercapto compound-2 | 0.003 |
| Photosensitie silver halide (in terms of silver) | 0.13 |

Coating and drying conditions are described below.

Coating was performed at a coating speed of 160 m/min. A distance between the tip of the coating die and the support was set in the range of 0.10 mm to 0.30 mm. Pressure inside a reduced pressure chamber was set lower than the atmospheric pressure by from 196 Pa to 882 Pa. Static electricity of the support was eliminated by ionized air before coating.

After the coating solution was chilled in a subsequent chilling zone with air having a dry bulb temperature of from 10° C. to 20° C., the coated support was transported to a helical type contactless drying apparatus in a contactless manner and, then, dried therein with drying air having a dry bulb temperature of from 23° C. to 55° C. and a wet bulb temperature of from 15° C. to 31° C. to form a film.

After such drying, the thus-formed film was conditioned at 25° C. from 40% to 60% RH and, then, heated such that a temperature of a film face thereof came to be from 70° C. to 90° C. and, subsequently, cooled such that the temperature of the film face thereof came to be 25° C.

2) Preparation of Photothermographic Materials-2 to -12

Photothermographic materials-2 to -12 were prepared in the same manner as in the photothermographic material-1 except that the coating solution-1 for the image forming layer was changed to the coating solutions-2 to 12 for the image forming layer. On this occasion, an amount (g/m²) of each compound in the image forming layer was same as that in the photothermographic material-1.

Chemical structures of compounds which are employed in Example according to the present invention are described below.

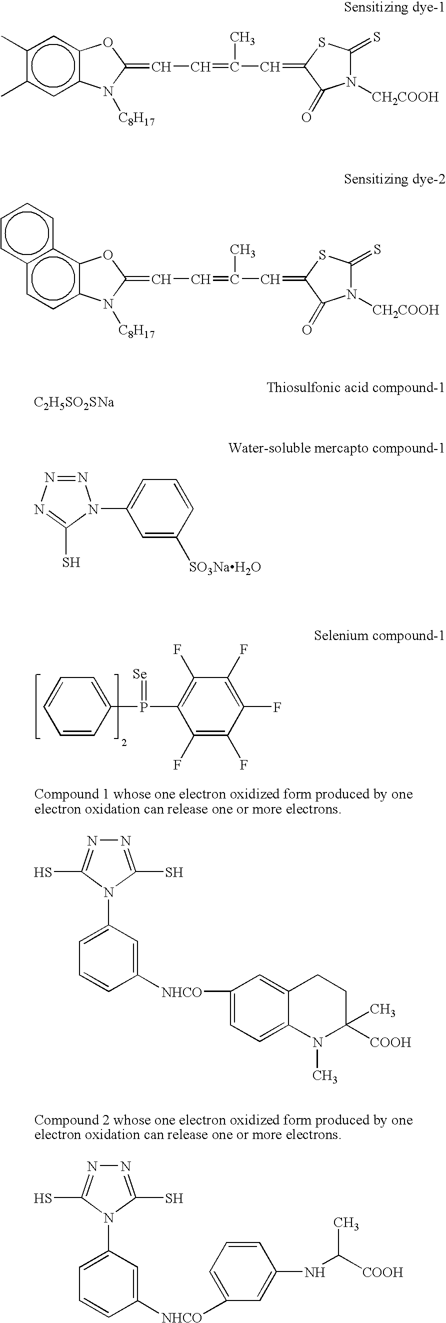

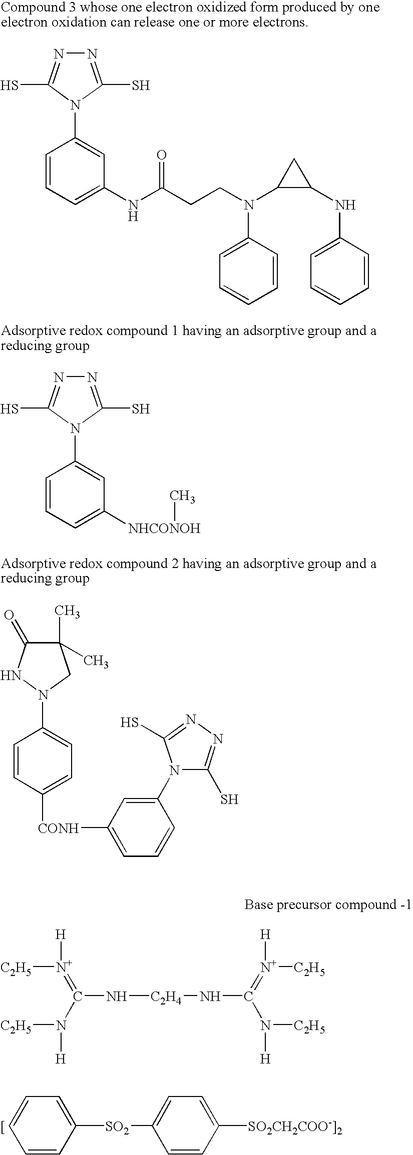

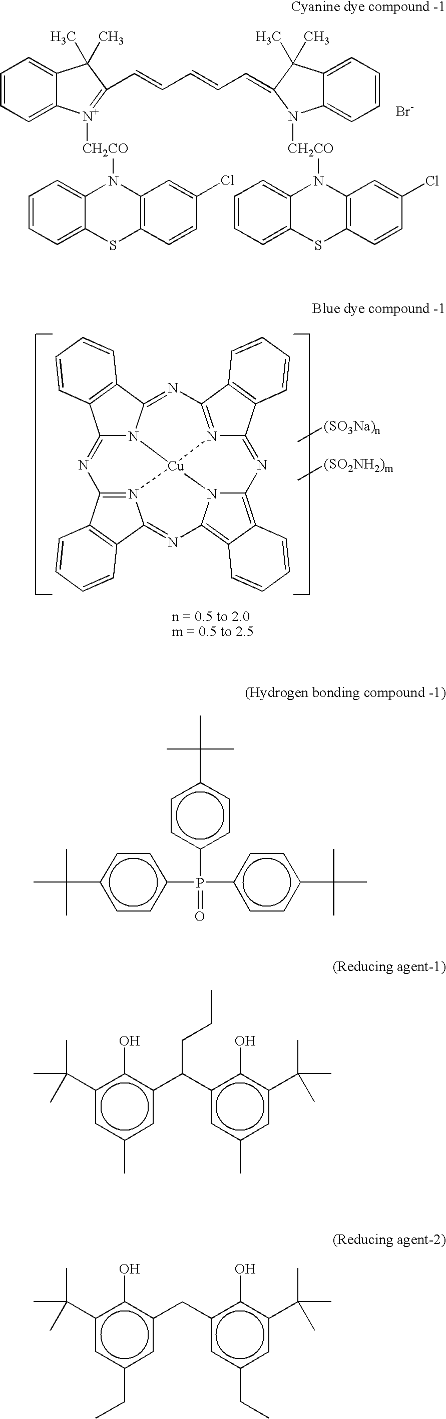

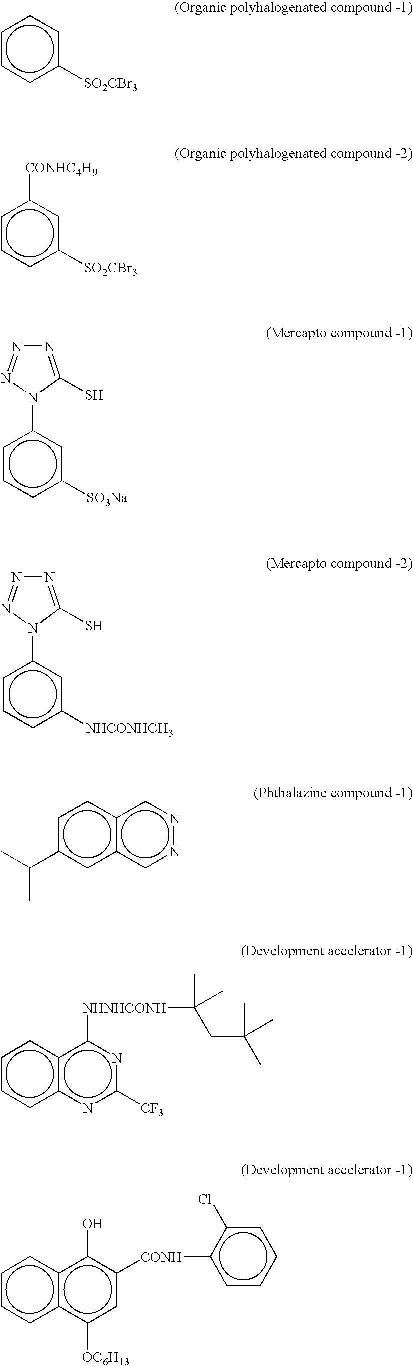

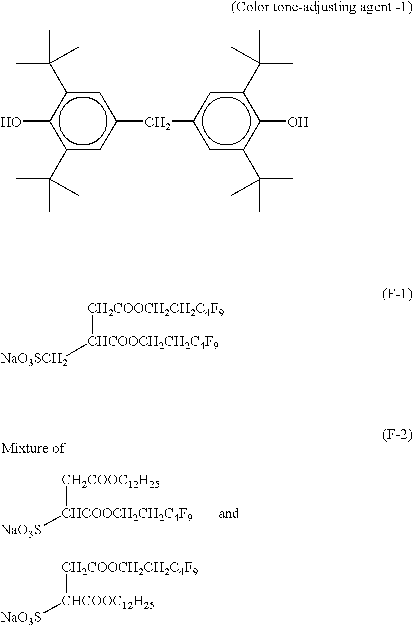

4. Evaluation of Photographic Performance

1) Preparation

Each of the thus-obtained samples was cut into pieces each in a size of 14×17 in., packaged with a packaging material described below at 25° C. 50% RH, stored for 2 weeks at room temperature and, then, subjected to evaluations as described below.

2) Packaging Material

The packaging material used was 50 μm thick polyethylene film comprising 10 μm PET/12 μm PE/9 μm aluminum foil/15 μm Ny/3% by mass carbon.

Oxygen transmittance was 0.02 ml/atm·m².25° C.·day; and moisture transmittance was 0.10 g/atm·m²·25° C.·day.

3) Exposure and Development of Photosensitive Material

The photothermographic materials-1 to -12 were subjected to exposure and thermal development treatments (for totally 24 seconds by 3 plates of panel heaters with respectively-set temperatures of 107° C., 121° C. and 121° C.) by a Fuji Medical Dry Laser Imager DRYPIX7000 (mounted with a 660 nm semiconductor laser having a maximum output of 50 mW (IIIB)) and the resultant images were evaluated by using a densitometer.

4) Evaluation of Photographic Performance

<Evaluation of Sensitivity>

Density of each of the resultant images was measured by using a Macbeth densitometer, to thereby construct a characteristic curve of the density to a logarithm of exposure light quantity. Sensitivity was expressed in terms of a reciprocal number of exposure light quantity necessary for obtaining an optical density of Dmin+1.5 and was expressed as a difference from sensitivity of the photothermographic material-1 which was assumed to be 0.

<Evaluation of Adhesion Property>

6 lines having even intervals of 4 mm were provided horizontally and vertically on a surface of a face, on which the photosensitive layer was applied, of the sample thus treated by cutting it by a razor edge, to thereby produce 25 squares. Such cut reaches a surside of the support in depth. A Mylar tape of 25 mm wide was attached thereon with a sufficient pressure. Five minutes after such attachment, the Mylar tape was forcibly peeled therefrom at a peeling angle of 180°. The number of squares peeled off was counted and, then, an adhesion property was evaluated in accordance with the following criteria:
A: number of peeled squares: 0
B: number of peeled squares: less than 1
C: number of peeled squares: less than 5
D: number of peeled squares: 5 or more

<Evaluation of Pressure Resistance>

Thermal development was performed while adjusting a pressure between a transport roller of the thermal development portion of the Dry Laser Imager DRYPIX7000 and the photosensitive material to be 0.5 kgf/cm². Such pressure condition as described above was severer than that ordinarily set.

Fogging density obtained by performing a thermal development treatment under the above-described pressure condition was raised compared with that obtained by performing the thermal development treatment under the ordinarily set pressure condition. A rise of fogging density was allowed to be an evaluation value of pressure resistance and expressed as a relative number assuming the rise of fogging density of the sample 1 to be 100.

The evaluation results are shown in Table 1.

TABLE 1

| | Silver halide | Binder | | | | | |
|---|---|---|---|---|---|---|---|
| Photothermographic | (aspect | | Tg | | Adhesion | Pressure | |
| material | ratio) | Type | (° C.) | Sensitivity | property | resistance | Remarks |
| 1 | Emulsion 1 | Binder solution-1 | 70 | 0 | D | 100 | Comparative |
| | (8.1) | (gelatin) | | | | | |
| 2 | Emulsion 1 | Binder solution-2 | 17 | +0.12 | A | 21 | Present |
| | (8.1) | (SBR) | | | | | invention |
| 3 | Emulsion 1 | Binder solution-3 | 45 | +0.11 | A | 22 | Present |
| | (8.1) | (SBR) | | | | | invention |
| 4 | Emulsion 1 | Binder solution-4 | 5 | +0.14 | A | 20 | Present |
| | (8.1) | (acrylic type) | | | | | invention |
| 5 | Emulsion 2 | Binder solution-1 | 70 | +0.01 | D | 95 | Comparative |
| | (3.0) | (gelatin) | | | | | |
| 6 | Emulsion 2 | Binder solution-2 | 17 | +0.10 | A | 18 | Present |
| | (3.0) | (SBR) | | | | | invention |
| 7 | Emulsion 2 | Binder solution-3 | 45 | +0.10 | A | 18 | Present |
| | (3.0) | (SBR) | | | | | invention |
| 8 | Emulsion 2 | Binder solution-4 | 5 | +0.12 | A | 16 | Present |
| | (3.0) | (acrylic type) | | | | | invention |
| 9 | Emulsion 3 | Binder solution-1 | 70 | −0.02 | D | 133 | Comparative |
| | (16.9) | (gelatin) | | | | | |
| 10 | Emulsion 3 | Binder solution-2 | 17 | +0.12 | A | 23 | Present |
| | (16.9) | (SBR) | | | | | invention |
| 11 | Emulsion 3 | Binder solution-3 | 45 | +0.11 | A | 22 | Present |
| | (16.9) | (SBR) | | | | | invention |
| 12 | Emulsion 3 | Binder solution-4 | 5 | +0.13 | B | 22 | Present |
| | (16.9) | (acrylic type) | | | | | invention |

As is apparent from Table 1, it has been found 50% or more of the projected area of the photosensitive silver halide contains grains each having an aspect ratio of from 2 to 100 and also that, when the binder of the image forming layer contains an aqueous dispersion of a hydrophobic polymer, the photothermographic material excellent in sensitivity, adhesion property and pressure resistance was obtained.

### Example 2

1. Preparation of Undercoated Support

(1) Preparation of Coating Solution for Undercoat Layer

Prescription-1 (For Undercoat Layer on the Side of Photosensitive Layer)

| | | |
|---|---|---|
| Pesresin A-520 (30% by mass solution) manufactured by | 59 | g |
| Takamatsu Oil & Fat, Inc. | | |
| Polyethylene glycol monononylphenyl ether (average number | 5.4 | g |
| of ethylene oxide = 8.5; 10% by mass solution) | | |
| MP-1000 (polymeric fine grains; average grain diameter: | 0.91 | g |
| 0.4 μm) manufactured by Soken Kagaku Co., Ltd. | | |
| Distilled water | 935 | ml |

Prescription-3 (For Back Face Second layer)

| | |
|---|---|
| SnO₂/SbO (9/1 mass ratio; average grain diameter: | 84 g |
| 0.038 μm; 17% by mass dispersion) | |
| Gelatin (10% by mass aqueous solution) | 89.2 g |
| Metolose TC-5 (2% by mass aqueous solution) manufactured | 8.6 g |
| by Shin-Etsu Chemical Co., Ltd. | |
| MP-1000 manufactured by Soken Kagaku Co., Ltd. | 0.01 g |
| 1% by mass aqueous solution of sodium | 10 ml |
| dodecylbenzene sulfonate | |
| NaOH (1% by mass) | 6 ml |
| Proxel manufactured by ICI | 1 ml |
| Distilled water | 805 ml |

After the corona discharge treatment was performed on both faces of the resultant biaxially stretched polyethylene terephthalate support having a thickness of 175 μm, the undercoating solution of the prescription-1 was applied on one face (photosensitive layer face) thereof by means of a wire-bar in a wet coated amount of 6.6 ml/m² (per face) and dried at 180° C. for 5 minutes. Then, the undercoating solution of the prescription-2 was applied on the opposite face (back face) by means of a wire-bar in a wet coated amount of 5.7 ml/m² and dried at 180° C. for 5 minutes. Further, the undercoating solution of the prescription-3 was applied on the opposite face (back face) by means of a wire-bar in a wet coated amount of 7.7 ml/m² and dried at 180° C. for 6 minutes, to thereby prepare an undercoated support.

2. Preparation of Coating Solution for Back Face

Preparation of Coating Solution for Antihalation Layer

32.7 g of lime-treated gelatin maintained at 40° C., 0.77 g of mono-dispersed polymethylmethaccrylate fine grains (average grain size: 8 μm; standard deviation of grain diameters: 0.4 μm), 0.08 g of benzisothiazolinone, 0.3 g of solium polystyrene sulfornate, 0.06 g of a blue dye compound-1, 1.5 g of an ultraviolet light absorbing agent-1, 5.0 g of an acrylic acid/ethyl acrylate copolymer latex (copolymerization ratio: 5/95), 1.7 g of N,N-ethylene-bis(vinylsulfone acetamide) were mixed with one another and, then, a pH value of the resultant mixture was adjusted to be 6.0 by using a 1 mol/L NaOH solution and, thereafter, added with such an amount of water as to make an entire amount to be 818 ml, to thereby prepare a coating solution for an antihalation layer.

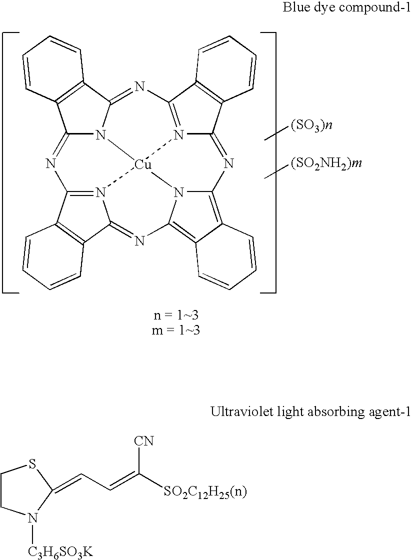

Preparation of Coating Solution of Back Face Protective Layer

66.5 g of lime-treated gelatin maintained at 40° C., 5.4 g, in terms of liquid paraffin, of a liquid paraffin dispersion, 0.10 mg of benzisothiazolinone, 0.5 g of sodium sulfosuccinate di(2-ethylhexyl), 0.27 g sodium polystyrene sulfonate, 13.6 ml of a 2% by mass aqueous solution of a fluorine-type surface active agent (F-1) and 10.0 g of an acrylic acid/ethyl acrylate copolymer (weight ratio of copolymerization: 5/95) were mixed thereamong. A pH value of the resultant mixture was adjusted to be 6.0 by using a 1 mol/L NaOH solution and, then, added with such an amount of water as to make an entire amount to be 1000 ml, to thereby prepare a coating solution for a back face protective layer.

2. Image Forming Layer, Intermediate Layer and Surface Protective Layer

<<Preparation of Coating Solution for Image Forming Layer>>

1) Preparation of Silver Halide Emulsion

<Preparation of Silver Halide Emulsion 4>

To 1,421 ml of distilled water, 4.3 ml of a 1% by mass potassium iodide solution was added and, further, 3.5 ml of sulfuric acid having a concentration of 0.5 mol/L, 36.5 g of phthalated gelatin, and 160 ml of a 5% by mass methanol solution of 2,2′-(ethylenedithio)diethanol were added. While being kept stirring at 75° C. in a reaction vessel made of stainless steel, the resultant mixture was added with both of a solution A which has been prepared by adding distilled water to 22.22 g of silver nitrate to make an entire volume to 218 ml and a solution B which has been prepared by adding distilled water to 36.6 g of potassium iodide to make an entire volume to 366 ml such that an entire quantity of the solution A was added at a constant flow-rate consuming 16 minutes and the solution B was added by a controlled-double-jet method while keeping a pAg value at 10.2 and, then, added with 10 ml of a 3.5% by mass aqueous solution of hydrogen peroxide and, thereafter, added with 10.8 ml of a 10% by mass aqueous solution of benzimidazole and, further, added with both of a solution C which has been prepared by adding distilled water to 51.86 g of silver nitrate to make an entire volume to 508.2 ml and a solution D which has been prepared by adding distilled water to 63.9 g of potassium iodide to make an entire volume to 639 ml such that an entire quantity of the solution C was added at a constant flow rate consuming 80 minutes and the solution D was added by a controlled-double-jet method while keeping a pAg value at 10.2. Then, 10 minutes after such additions of the solution C and the solution D were started, the resultant mixture was added with an entire quantity of potassium hexachloroiridate (III) so as to be 1×10⁻⁴ mol, based on 1 mol of silver and, five seconds after the addition of the solution C was completed, added with an entire quantity of 3×10⁻⁴ mol, based on 1 mol of silver, of an aqueous solution of potassium hexacyanoiron (II). A pH value of the resultant mixture was adjusted to 3.8 by using sulfuric acid having a concentration of 0.5 mol/L and, then, a stirring operation was stopped to perform precipitation/desalination/washing steps. Subsequently, a pH of the mixture thus subjected to these steps was adjusted to 5.9 by using sodium hydroxide having a concentration of 1 mol/L, to thereby prepare a photosensitive silver halide emulsion 4 having a pAg value of 11.0.

The thus-prepared photosensitive silver halide emulsion 4 was a pure silver iodide emulsion in which tabular grains having an average projected area diameter of 0.93 μm, a coefficient of variation of the average projected area diameter of 17.7%, an average thickness of 0.057 μm, and an average aspect ratio of 16.3 occupied 80% or more of an entire projected area. A sphere-equivalent diameter of the grain was 0.42 μm. As a result of an X-ray powder diffraction analysis, it was found that 90% or more of silver iodide was present in a form of γ phase.

<Preparation of Photosensitive Silver Halide Emulsion 5>

1 mol of a tabular grain AgI emulsion prepared in the photosensitive silver halide emulsion 4 was put in a reaction vessel. When a pAg value was measured at 38° C., it was 10.2. Subsequently, the emulsion was added with a 0.5 mol/L KBr solution and a 0.5 mol/L AgNO₃ solution by a double-jet method at an addition rate of 10 ml/minute consuming 20 minutes to allow substantially 10% by mol of silver bromide to be deposited on an AgI host emulsion in an epitaxial state. During such addition operation, a pAg value was maintained at 10.2. Further, a pH value of the resultant mixture was adjusted to 3.8 by using sulfuric acid having a concentration of 0.5 mol/L and, then, a stirring operation was stopped to perform precipitation/desalination/washing steps. Subsequently, a pH value of the mixture thus subjected to these steps was adjusted to 5.9 by using sodium hydroxide having a concentration of 1 mol/L, to thereby prepare a photosensitive silver halide dispersion having a pAg value of 11.0.

While being kept stirring at 38° C., the thus-prepared photosensitive silver halide dispersion was added with 5 ml of a 0.34% by mass methanol solution of 1,2-benzisothiazolin-3-one and, after 40 minutes elapsed, heated to 47° C. and, 20 minutes after such heating, added with 7.6×10⁻⁵ mol, based on 1 mol of silver, of a methanol solution of sodium benzene thiosulfonate and, after 5 minutes elapsed, added with 2.9×10⁻⁵ mol, based on 1 mol of silver, of a methanol solution of a tellurium sensitizing agent C and, then, ripened for 91 minutes and, thereafter, added with 1.3 ml of a 0.8% by mass methanol solution of N,N′-dihydroxy-N″-diethylmelamine and, after 4 minutes elapsed, added with 4.8×10⁻³ mol, based on 1 mol of silver, of a methanol solution of 5-methyl-2-mercaptobenzimidazole, 5.4×10⁻³ mol, based on 1 mol of silver, of a methanol solution of 1-phenyl-2-heptyl-5-mercapto-1,3,4-triazole, and 8.5×10⁻³ mol, based on 1 mol of silver, of an aqueous solution of 1-(3-methylureidophenyl)-5-mercaptotetrazole, to thereby prepare a photosensitive silver halide emulsion 5.

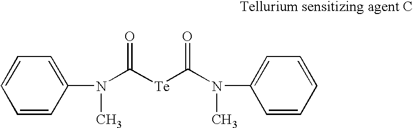

<Preparation of Photosensitive Silver Halide Emulsion 6>

A photosensitive silver halide emulsion 6 was prepared in the same manner as in the photosensitive silver halide emulsion 4 except for appropriately changing the amount of a 5% by mass methanol solution of 2,2′-(ethylenedithio)diethanol to be added, the temperature at the time of forming grains and the addition time of the solution A, to thereby prepare a photosensitive silver halide emulsion 6. It has been found that the thus-prepared photosensitive silver halide emulsion 6 was a pure silver iodide emulsion in which tabular grains having an average projected area diameter of 1.369 μm, a coefficient of variation of the average projected area diameter of 19.7%, an average thickness of 0.130 μm, and an average aspect ratio of 11.1 occupied 80% or more of an entire projected area. A sphere-equivalent diameter of the grain was 0.71 μm. As a result of an X-ray powder diffraction analysis, it was found that 90% or more of silver iodide was present in a form of γ phase.

<Preparation of Photosensitive Silver Halide Emulsion 7>

A photosensitive silver halide emulsion 7 containing 10% by mol of silver bromide epitaxitial was prepared in an entirely same manner as in the photosensitive silver halide emulsion 5 except for using the photosensitive silver halide emulsion 6.

<Preparation of Photosensitive Silver Halide Emulsion 8>

A photosensitive silver halide emulsion 8 was prepared in the same manner as in the photosensitive silver halide emulsion 4 except for appropriately changing the amount of a 5% by mass methanol solution of 2,2′-ethylenedithio)diethanol to be added, the temperature at the time of forming grains and the addition time of the solution A, to thereby prepare a photosensitive silver halide emulsion 8. It has been found that the thus-prepared photosensitive silver halide emulsion 8 was a pure silver iodide emulsion in which tabular grains having an average projected area diameter of 0.66 μm, a coefficient of variation of the average projected area diameter of 18.0%, an average thickness of 0.18 μm, and an average aspect ratio of 3.7 occupied 80% or more of an entire projected area. A sphere-equivalent diameter of the grain was 0.39 μm. As a result of an X-ray powder diffraction analysis, it was found that 90% or more of silver iodide was present in a form of γ phase.

<Preparation of Photosensitive Silver Halide Emulsion 9>

A photosensitive silver halide emulsion 9 containing 10% by mol of silver bromide epitaxitial was prepared in an entirely same manner as in the photosensitive silver halide emulsion 5 except for using the photosensitive silver halide emulsion 8.

2) Preparation of Mixed Emulsion for Coating Solution

<Preparation of Mixed Emulsion 4 for Coating Solution>

The photosensitive silver halide emulsion 5 was dissolved and, then, added with 7×10⁻³ mol, based on 1 mol of silver, of a 1% by mass aqueous solution of benzothiazolium iodide and, thereafter, added with compounds 1, 2 and 3 in each of which a one-electron-oxidized form generated by oxidizing one electron therein can discharge one or more electrons such that each of the compounds is allowed to be 2×10⁻³ mol based on 1 mol of silver of the photosensitive silver halide and, still further, added with each of compounds 1 and 2 each having an adsorptive group and a reducing group such that each of the compounds is allowed to be 8×10⁻³ mol based on 1 mol of the photosensitive silver halide and, furthermore, added with such an amount of water as to allow a content of the photosensitive silver halide to be 15.6 g, in terms of silver, per liter of the mixed emulsion for the coating solution.

<Preparation of Mixed Emulsions 5 and 6 for Coating Solution>

Mixed emulsions 5 and 6 for coating solution were prepared in the same manner as in the preparation of the mixed emulsion 4 for the coating solution except for using the photosensitive silver halide emulsion 7 or 9 in place of the photosensitive silver halide emulsion 5.

3) Preparation of Silver Iodide Complex Forming Agent

8 kg of modified polyvinylalcohol MP203 was dissolved in 174.57 kg of water. Then, 3.15 kg of a 20% by mass aqueous solution of sodium triisopropylnaphthalene sulfonate and 14.28 kg of a 70% by mass aqueous solution of 6-isopropylphthalazine were added to the resultant solution, to thereby prepare a 5% by mass solution of a silver iodide complex forming agent compound.

4) Preparation of Coating Solution of Image Forming Layer (Photosensitive Layer)

<Preparation of Coating Solution-201 for Image Forming Layer>

1000 g of the fatty acid silver salt dispersion B in Example 1 was added to 276 ml of water and, then, to the resultant solution, the pigment-1 dispersion, the organic polyhalogen compound-1 dispersion, the organic polyhalogen compound-2 dispersion, the silver iodide complex forming agent (No. 22) solution, 2624 g of the binder solution-1, the reducing agent-1 dispersion, the reducing agent-2 dispersion, the hydrogen boding compound-1 dispersion, the development accelerator-1 dispersion, the development accelerator-2 dispersion, the color tone adjusting agent-1 dispersion, the mercapto compound-1 aqueous solution and the mercapto compound-2 aqueous solution were added in the stated order and, then, the silver halide emulsion for coating solution mixture was added to the resultant mixture immediately before it was applied and, thereafter, thoroughly mixed to obtain a coating solution for the image forming layer which was, then, directly fed to a coating die and applied.

<Preparation of Coating Solutions-202 to 212>

In the preparation of the coating solution-1 for the image forming layer, any one of the mixed emulsions 4 to 6 for the silver halide coating solution was used in place of the mixed emulsion 4 for the silver halide coating solution and any one of the binder solutions-1 to 4 in place of the binder solution-1. Combinations of the mixed emulsions for the silver halide coating solution and the binder solutions are shown in Table 2. Coating solutions-2 to -12 for the image forming layer were prepared in the same manner as in the coating solution-1 for the image forming layer except for the above-described changes. The binder solutions were added such that the solid contents thereof came to be same.

(Preparation of Coating Solution-2 for Intermediate Layer)

1000 g of polyvinyl alcohol PVA-205 (manufactured by Kuraray Co., Ltd.), 272 g of the pigment-1 dispersion, 4200 ml of a 19% by mass solution of a latex of methyl methacrylate/styrene/butyl acrylate/hydroxyethyl methacrylate/acrylic acid copolymer (weight ratio of copolymerization: 64/9/20/5/2), 27 ml of a 5% by mass aqueous solution of Aerosol OT (manufactured by American Cyanamide Corporation), 135 ml of a 20% by mass aqueous solution of diammonium phthalate and such an amount of water as to make an entire amount to 10000 g were mixed thereamong and, then, a pH value of the resultant mixture was adjusted to be 7.5 by using NaOH; accordingly, a coating solution for an intermediate layer was prepared. Then, the thus-prepared coating solution for the intermediate layer was fed to a coating die such that a coating amount came to be 9.1 ml/m².

Viscosity of the coating solution measured at 40° C. using a B-type viscometer (No. 1 rotor; 60 rpm) was 58 mPa.s.

(Preparation of Coating Solution-2 for First Layer of Surface Protective Layer)

64 g of inert gelatin was dissolved in water and, then, to the resultant solution, 112 g of a 19% by mass solution of a latex of methyl methacrylate/styrene/butyl acrylate/hydroxyethyl methacrylate/acrylic acid copolymer (weight ratio of copolymerization: 64/9/20/5/2), 30 ml of a 15% by mass methanol solution of phthalic acid, 23 ml of a 10% by mass aqueous solution of 4-methylphthalic acid, 28 ml of a 0.5 mol/L conc. H₂SO₄, 5 ml of a 5% by mass aqueous solution of Aerosol OT (manufactured by American Cyanamid Corporation), 0.5 g of phenoxyethanol, 0.1 g of benzisothiazolinone and such an amount of water as to make an entire amount to be 750 g were added in the stated order and, then, immediately before coating, 26 ml of a 4% by mass solution of chrome alum was added to the resultant mixture by a static mixer, to thereby prepare a coating solution. Then, the thus-prepared coating solution was fed to a coating die such that a coating amount came to be 18.6 ml/m².

Viscosity of the coating solution measured at 40° C. by using a B-type viscometer (No. 1 rotor; 60 rpm) was 20 mPa.s.

(Preparation of Coating Solution-2 for Second Layer of Surface Protective Layer)

80 g of inert gelatin was dissolved in water and, then, to the resultant solution, 102 g of a 27.5% by mass solution of a latex of methyl methacrylate/styrene/butyl acrylate/hydroxyethyl methacrylate/acrylic acid copolymer (weight ratio of copolymerization: 64/9/20/5/2), 5.4 ml of a 2% by mass solution of the fluorinetype surface active agent (F-1), 5.4 ml of a 2% by mass solution of the fluorine-type surface active agent (F-2), 23 ml of a 5% by mass aqueous solution of Aerosol OT (manufactured by American Cyanamid Corporation), 4 g of polymethylmethacrylate fine grains (average grain diameter: 0.7 μm; 21 g of polymethylmethacrylate fine grains (average grain diameter: 4.5 μm), 1.6 g of 4-methyl phthalic acid, 4.8 g of phthalic acid, 44 ml of a 0.5 mol/L conc. H₂SO₄, 10 mg of benzisothiazolinone and such an amount of water as to make an entire amount to be 650 g and, then, immediately before the coating, 445 ml of an aqueous solution containing 4% by mass of chrome alum and 0.67% by mass of phthalic acid was added to the resultant mixture by a static mixer, to thereby prepare a coating solution for the surface protective layer. Then, the thus-prepared coating solution was fed to a coating die such that a coating amount came to be 8.3 ml/m².

Viscosity of the coating solution measured at 40° C. by using a B-type viscometer (No. 1 rotor; 60 rpm) was 19 mPa.s.

3. Preparation of Photothermographic Material

1) Preparation of Photothermographic Material-201

On a face opposite to a back face, the coating solution-201 for the image forming layer, the coating solution-2 for the intermediate layer, the coating solution-2 for the first layer of the surface protective layer and the coating solution-2 for the second layer of the surface protective layer were applied in a simultaneous superposition coating in the stated order from an undercoat face using a slide bead application method, to thereby prepare a photothermographic material-201. On this occasion, the coating solutions for the image forming layer and the intermediate layer were adjusted to be 31° C., while the coating solutions for the first and second layers of the surface protective layer were adjusted to be 36° C. and 37° C., respectively.

A coated amount (g/m²) of each compound in the image forming layer is shown below.

| | |
|---|---|
| Fatty acid silver salt | 5.60 |
| Polyhalogen compound-1 | 0.056 |
| Polyhalogen compound-2 | 0.188 |
| Silver iodide complex forming agent | 0.92 |
| Gelatin | 9.36 |
| Reducing agent-1 | 0.66 |
| Reducing agent-2 | 0.26 |
| Hydrogen bonding compound-1 | 0.30 |
| Development accelerator-1 | 0.01 |
| Development accelerator-2 | 0.07 |
| Color tone adjusting agent-1 | 0.004 |
| Mercapto compound-1 | 0.002 |
| Mercapto compound-2 | 0.006 |
| Silver halide (in terms of silver) | 0.290 |

Viscosity of the resultant coating solution for the image forming layer measured by a B-type viscometer (No. 1 rotor at 60 rpm) (available from Tokyo Keiki Co., Ltd.) was 25 mPa.s at 40° C.

Viscosities of the coating solution measured by RFS Fluidspectrometer (manufactured by Rheometric Scientific F. L. Ltd.) at 25° C. were 242 mPa.s, 65 mPa.s, 48 mPa.s, 26 mPa.s, and 20 mPa.s at shearing velocities of 0.1 [1/second], 1 [1/second], 10 [1/second], 100 [1/second] and 1000 [1/second], respectively.

An amount of zirconium in the coating solution was 0.52 mg based on 1 g of silver.

2) Photothermographic Materials-202 to 212

Photothermographic materials-202 to 212 were produced in the same manner as in the preparation of the photothermographic material-201 except for using the coating solutions-202 to -212 for the image forming layer in place of the coating solution-201 for the image forming layer. An amount (g/m²) of each compound to be applied to the image forming layer is same as in the photothermographic material-201.

4. Exposure and Development

A semiconductor laser (trade name: NLHV3000E; manufactured by Nichia Corporation) was attached to an exposure portion of the Fuji Medical Dry Laser Imager FM-DP L as a laser light source and a beam diameter was restricted to 100 μm. The sample was irradiated for 10⁻⁶ second by the laser light emitted therefrom by varing luminance of the laser light on a face of the photosensitive material in the range of 0 and from 1 mW/mm² to 1000 mW/mm². Thermal development was performed under conditions in which an oscillation wavelength of the laser light was 405 nm; temperatures of 4 panels of a panel-heater were set at 112° C., 118° C., 120° C. and 120° C., recpectively, and a transportation speed was increased such that development was allowed to be performed in 14 seconds in total. The resultant image was evaluated by using a densitometer.

5. Evaluation

Evaluations were performed in the same manner as those in Example 1. The results are shown in Table 2.

TABLE 2

| | Silver | | | | | | |
|---|---|---|---|---|---|---|---|
| | halide | Binder | | | | | |
| Photothermographic | (aspect | | Tg | | Adhesion | Pressure | |
| material | ratio) | Type | (° C.) | Sensitivity | property | resistance | Remarks |
| 201 | Emulsion 4 | Binder solution-1 | 70 | 0 | D | 100 | Comparative |
| | (16.3) | (gelatin) | | | | | |
| 202 | Emulsion 4 | Binder solution-2 | 17 | +0.21 | A | 19 | Present |
| | (16.3) | (SBR) | | | | | invention |
| 203 | Emulsion 4 | Binder solution-3 | 45 | +0.22 | A | 20 | Present |
| | (16.3) | (SBR) | | | | | invention |
| 204 | Emulsion 4 | Binder solution-4 | 5 | +0.20 | B | 18 | Present |
| | (16.3) | (acrylic type) | | | | | invention |
| 205 | Emulsion 5 | Binder solution-1 | 70 | −0.02 | D | 96 | Comparative |
| | (11.1) | (gelatin) | | | | | |
| 206 | Emulsion 5 | Binder solution-2 | 17 | +0.25 | A | 15 | Present |
| | (11.1) | (SBR) | | | | | invention |
| 207 | Emulsion 5 | Binder solution-3 | 45 | +0.24 | A | 14 | Present |
| | (11.1) | (SBR) | | | | | invention |
| 208 | Emulsion 5 | Binder solution-4 | 5 | +0.22 | A | 15 | Present |
| | (11.1) | (acrylic type) | | | | | invention |
| 209 | Emulsion 6 | Binder solution-1 | 70 | −0.05 | D | 88 | Comparative |
| | (3.7) | (gelatin) | | | | | |
| 210 | Emulsion 6 | Binder solution-2 | 17 | +0.19 | A | 15 | Present |
| | (3.7) | (SBR) | | | | | invention |
| 211 | Emulsion 6 | Binder solution-3 | 45 | +0.18 | A | 15 | Present |
| | (3.7) | (SBR) | | | | | invention |
| 212 | Emulsion 6 | Binder solution-4 | 5 | +0.17 | A | 14 | Present |
| | (3.7) | (acrylic type) | | | | | invention |

As is apparent from Table 2, it has been found, even when silver iodide was used as a photosensitive silver halide, 50% or more of the projected area of the photosensitive silver halide contains grains each having an aspect ratio of from 2 to 100 and also that, when the binder of the image forming layer contains an aqueous dispersion of a hydrophobic polymer, the photothermographic material excellent in sensitivity, adhesion property and pressure resistance was obtained.

### Example 3

(Preparation of PET Support)

In the preparation of the PET support in Example 1, the coating solution of prescription (1) for undercoat was applied on one side of the support and the coating solutions of prescriptions (2) and (3) for undercoat were applied on the other face thereof, but, in Example 3, the coating solution of prescription (1) for undercoat was applied on both faces in a wet coated amount of 6.6 ml/m² (per face) and, then, dried at 180° C. for 5 minutes, to thereby prepare an undercoated support.

(Back Layer)

In Example 2, the back layer was provided, but, in Example 3, the back layer was not provided.

(Image Forming Layer, Intermediate Layer and Surface Protective Layer)

1) Preparation of Material for Coating

<<Photosensitive Silver Halide Emulsion>>

The mixed emulsion for coating solution prepared in Example 2 was used as the photosensitive silver halide emulsion.

<<Other Additives>>

Further, other additives in the image forming layer, the intermediate layer and the surface protective layer were prepared in the same manner as in Example 1.

2) Preparation of Coating Solution

The coating solutions-201 to 212 for the image forming layer, the coating solution-2 for the intermediate layer, the coating solution-2 for the first layer of the surface protective layer and the coating solution-2 for the second layer of the surface protective layer in Example 2 were used.

(Preparation of Photothermographic Material)

1) Preparation of Photothermographic Material-301

The coating solution-201 for the image forming layer, the coating solution-2 for the intermediate layer, the coating solution-2 of the first layer of the protective layer and the coating solution-2 for the second layer of the protective layer were applied in a simultaneous superposition coating in the stated order from an undercoat face using a slide bead application method, to thereby prepare a sample of a photothermographic material. On this occasion, coating temperatures of the coating solutions for the image forming layer and the intermediate layer were adjusted to be 31° C., while the coating temperatures of the coating solutions for the first and second layers of the protective layer were adjusted to be 36° C. and 37° C., respectively. An amount of silver thus applied in the image forming layer was, as a total amount of silver in the silver salt of the fatty acid and the silver halide, 0.821 g/m² per face. Such amount of silver was applied to both sides of the support.

A coated amount (g/m²) of each compound in the image forming layer is shown below.

| | |
|---|---|
| Fatty acid silver salt | 2.80 |
| Polyhalogen compound-1 | 0.028 |
| Polyhalogen compound-2 | 0.094 |
| Silver iodide complex forming agent | 0.46 |
| Gelatin | 4.68 |
| Reducing agent-1 | 0.33 |
| Reducing agent-2 | 0.13 |
| Hydrogen bonding compound-1 | 0.15 |
| Development accelerator-1 | 0.005 |
| Development accelerator-2 | 0.035 |
| Color tone adjusting agent-1 | 0.002 |
| Mercapto compound-1 | 0.001 |
| Mercapto compound-2 | 0.003 |
| Silver halide (in terms of silver) | 0.146 |

2) Photothermographic Materials-302 to 312

Photothermographic materials-302 to 312 were prepared in the same manner as in the preparation of photothermographic material-301 except for using any one of coating solutions-202 to 212 for the image forming layer in place of the coating solution-201 for the image forming layer.

(Evaluation of Photographic Performance)

Each of the thus-obtained samples was cut into pieces each in a size of 14×17 in., packaged with a packaging material described below at 25° C. 50% RH, stored for 2 weeks at room temperature and, then, subjected to evaluations as described below.

(Packaging Material)

The packaging material used was 50 μm thick polyethylene film comprising 10 μm PE/12 μm PE/9 μm aluminum foil/15 μm Ny/3% by mass carbon.

Oxygen transmittance was 0.02 ml/atm·m²·25° C.·day; and moisture transmittance was 0.10 g/atm·m²·25° C.·day.

Thus-prepared photosensitive material in which both faces were coated was evaluated as described below.

A sample thereof was sandwiched between two sheets of X-ray regular screen HI-SCREEN B3 (trade name; manufactured by Fuji Photo Film Co., Ltd.) (CaWO₄ having a luminescent peak wavelength of 425 nm being used as a phosphor) to construct an assembly for image-forming. The assembly was subjected to an X-ray exposure for 0.05 second to perform an X-ray sensitometry. An X-ray apparatus DRX-3724HD (trade name; manufactured by Toshiba Corporation), as well as a tungsten target, was used. An X ray which was emitted by applying an electric potential of 80 kVp to the apparatus by means of a three-phase pulse generator and, then, allowed to pass through a filter of water in 7 cm thick which has absorption approximately equivalent to that of a human body was employed as a light source. An exposure was conducted in a stepwise manner at a width of logE=0.15 by changing exposure quantities of the X ray by means of a distance method. After the exposure, a thermal treatment was performed on the thus-exposed sample under thermal development conditions as described below to obtain an image. The thus-obtained image was evaluated by using a densitometer.

A thermal development portion of the Fuji medical dry laser imager FM-DP L was modified such that heating can be performed from both sides to fabricate a thermal developing machine. Further, another modification was performed such that a transportation roller of the thermal development portion was replaced by a heat drum so as to allow a film sheet to be transported. Temperatures of 4 panels of a panel heater were set at 112° C., 118° C., 120° C. and 120° C., respectively while a temperature of the heat drum was set at 120° C. Further, a transportation speed was increased and set at 14 seconds in total.

On the other hand, a regular photosensitive material RX-U (trade name; manufactured by Fuji Photo Film Co., Ltd.) of a wet-type developing system was exposed under same conditions as described above and, then, treated with a developing solution CE-D1 (trade name; manufactured by Fuji Photo Film Co., Ltd.) by using an automatic developing machine CEPROS-M2 (trade name; manufactured by Fuji Photo Film Co., Ltd.) for 45 seconds.

The method for evaluating the photographic performance was same as in Example 1. The results are shown in Table 3.

TABLE 3

| | Silver halide | Binder | | | | | |
|---|---|---|---|---|---|---|---|
| Photothermographic | (aspect | | Tg | | Adhesion | Pressure | |
| material | ratio) | Type | (° C.) | Sensitivity | property | resistance | Remarks |
| 301 | Emulsion 4 | Binder | 70 | 0 | D | 100 | Comparative |
| | (16.3) | solution-1 | | | | | |
| | | (gelatin) | | | | | |
| 302 | Emulsion 4 | Binder | 17 | +0.19 | A | 27 | Present |
| | (16.3) | solution-2 | | | | | invention |
| | | (SBR) | | | | | |
| 303 | Emulsion 4 | Binder | 45 | +0.18 | A | 25 | Present |
| | (16.3) | solution-3 | | | | | invention |
| | | (SBR) | | | | | |
| 304 | Emulsion 4 | Binder | 5 | +0.17 | B | 26 | Present |
| | (16.3) | solution-4 | | | | | invention |
| | | (acrylic | | | | | |
| | | type) | | | | | |
| 305 | Emulsion 5 | Binder | 70 | −0.01 | D | 99 | Comparative |
| | (11.1) | solution-1 | | | | | |
| | | (gelatin) | | | | | |
| 306 | Emulsion 5 | Binder | 17 | +0.22 | A | 26 | Present |
| | (11.1) | solution-2 | | | | | invention |
| | | (SBR) | | | | | |
| 307 | Emulsion 5 | Binder | 45 | +0.21 | A | 25 | Present |
| | (11.1) | solution-3 | | | | | invention |
| | | (SBR) | | | | | |
| 308 | Emulsion 5 | Binder | 5 | +0.21 | A | 23 | Present |
| | (11.1) | solution-4 | | | | | invention |
| | | (acrylic | | | | | |
| | | type) | | | | | |
| 309 | Emulsion 6 | Binder | 70 | −0.03 | D | 91 | Comparative |
| | (3.7) | solution-1 | | | | | |
| | | (gelatin) | | | | | |
| 310 | Emulsion 6 | Binder | 17 | +0.20 | A | 22 | Present |
| | (3.7) | solution-2 | | | | | invention |
| | | (SBR) | | | | | |
| 311 | Emulsion 6 | Binder | 45 | +0.19 | A | 23 | Present |
| | (3.7) | solution-3 | | | | | invention |
| | | (SBR) | | | | | |
| 312 | Emulsion 6 | Binder | 5 | +0.18 | A | 22 | Present |
| | (3.7) | solution-4 | | | | | invention |
| | | (acrylic | | | | | |
| | | type) | | | | | |

As is apparent from Table 3, it has been found, in each of a case in which the photosensitive material in which both sides of the support were each provided with the image forming layer was used and a case in which the image was formed by using the X ray, 50% or more of the projected area of the photosensitive silver halide contains grains each having an aspect ratio of from 2 to 100 and also that, when the binder of the image forming layer contains an aqueous dispersion of a hydrophobic polymer, the photothermographic material excellent in sensitivity, adhesion property and pressure resistance was obtained.

### Example 4

Photothermographic materials 401 to 404 as shown in Table 4 were prepared by using an SBR latex (any one of binder solutions-5 to 8 being used) in which the Tg of the SBR latex binder in the photothermographic material 2 prepared in Example 1 was changed by appropriately changing the styrene/butadiene ratio.

TABLE 4

| | | Binder | | | | | | |
|---|---|---|---|---|---|---|---|---|
| | | | | Equilibrium | | | | |
| | | | | moisture | | | | |
| Photothermographic | Silver halide | | Tg | content | | Adhesion | Pressure | |
| material | (aspect ratio) | Type | (° C.) | (%) | Sensitivity | property | resistance | Remarks |
| 2 | Emulsion 1 | Binder | 17 | 0.6 | +0.12 | A | 21 | Present |
| | (8.1) | solution-2 | | | | | | invention |
| | | (SBR) | | | | | | |
| 3 | Emulsion 1 | Binder | 45 | 0.7 | +0.11 | A | 22 | Present |
| | (8.1) | solution-3 | | | | | | invention |
| | | (SBR) | | | | | | |
| 401 | Emulsion 1 | Binder | −22 | 0.5 | +0.08 | B | 22 | Present |
| | (8.1) | solution-5 | | | | | | invention |
| | | (SBR) | | | | | | |
| 402 | Emulsion 1 | Binder | −5 | 0.5 | +0.11 | A | 22 | Present |
| | (8.1) | solution-6 | | | | | | invention |
| | | (SBR) | | | | | | |
| 403 | Emulsion 1 | Binder | 55 | 0.7 | +0.11 | A | 23 | Present |
| | (8.1) | solution-7 | | | | | | invention |
| | | (SBR) | | | | | | |
| 404 | Emulsion 1 | Binder | 61 | 0.7 | +0.09 | B | 28 | Present |
| | (8.1) | solution-8 | | | | | | invention |
| | | (SBR) | | | | | | |

As a result of the evaluation performed in the same manner as in Example 1, it has been found that the latex having the Tg in the range of −20° C. to 60° C. was excellent in sensitivity, adhesion property and pressure resistance.

1. A photothermographic material having an image forming layer provided on at least one side of support, the image forming layer comprising a photosensitive silver halide, a non-photosensitive organic silver salt, a reducing agent and a binder, wherein:
50% or more of grains of the photosensitive silver halide in a projected area have an aspect ratio of from 2 to 100; and
the binder comprises an aqueous dispersion of a hydrophobic polymer.

2. The photothermographic material according to claim 1, wherein 50% or more of grains of the photosensitive silver halide in a project area have an aspect ratio of from 8 to 50.

3. The photothermographic material according to claim 1, wherein the non-photosensitive organic silver salt is a silver salt of a fatty acid.

4. The photothermographic material according to claim 1, wherein a glass transition temperature of the hydrophobic polymer is in the range of −20° C. to 60° C.

5. The photothermographic material according to claim 1, wherein an equilibrium moisture content of the hydrophobic polymer at 25° C. and 60% RH is in the range of 0.01% by mass to 1.5% by mass.

6. The photothermographic material according to claim 1, wherein the hydrophobic polymer is a polymer produced by copolymerizing a monomer represented by the follwing formula (M):
CH₂═CR⁰¹—CR⁰²═CH₂ Formula (M),
wherein R⁰¹ and R⁰² each independently represent a member selected from the group consisting of: a hydrogen atom, an alkyl group having from 1 to 6 carbon atoms, a halogen atom and a cyano group.

7. The photothermographic material according to claim 1, wherein the hydrophobic polymer comprises a styrene-butadiene copolymer.

8. The photothermographic material according to claim 1, wherein 50% or more of grains of the photosensitive silver halide in a projected area have a thickness of 0.3 μm or less.

9. The photothermographic material according to claim 1, wherein an average sphere-equivalent diameter of the photosensitive silver halide is in the range of 0.3 μm to 5 μm.

10. The photothermographic material according to claim 1, wherein an average sphere-equivalent diameter of the photosensitive silver halide is in the range of 0.4 μm to 3 μm.

11. The photothermographic material according to claim 1, wherein the photosensitive silver halide comprises silver iodide in the range of 40% by mol to 100% by mol.

12. The photothermographic material as set forth in claim 1, wherein the photosensitive silver halide comprises silver iodide in the range of 80% by mol to 100% by mol.

13. The photothermographic material according to claim 1, wherein the image forming layer is provided on both sides of the support.

14. The photothermographic material according to claim 1, wherein a coated amount of the binder in the image forming layer is in the range of 0.2 g/m² to 30 g/m².

15. An image forming method for a photothermographic material having an exposing and a thermal-developing, the method comprising
(1) obtaining an assembly for image forming by placing the photothermographic material according to claim 1 between a pair of X-ray sensitizing screens,
(2) setting a subject between the assembly for image forming and an X-ray source,
(3) irradiating the subject with X rays having an energy level in the range of 25 kVp to 125 kVp,
(4) removing the photothermographic material from the assembly; and
(5) heating the removed photothermographic material at a temperature in the range of 90° C. to 180° C.
